(19) United States
(12) Patent Application Publication
(10) Pub. No.: US 2025/0333959 A1
(43) Pub. Date: Oct. 30, 2025

(54) COMPOSITE DECK PLATE

(71) Applicant: MITSUBISHI ESTATE CO., LTD., Tokyo (JP)

(72) Inventor: Wataru EBISAWA, Tokyo (JP)

(21) Appl. No.: 18/578,349

(22) PCT Filed: Jun. 27, 2022
(86) PCT No.: PCT/JP2022/025583

§ 371 Date: Dec. 3, 2024

(30) Foreign Application Priority Data
Jul. 14, 2021 (JP) 2021-116680
Jun. 24, 2022 (JP) 2022-101747

(51) Int. Cl. E04B 5/40

(52) U.S. Cl. CPC E04B 5/40

(57) ABSTRACT

Provided is a composite deck plate capable of forming an attractive ceiling surface by incorporating an appealing design of a wood-based plate (natural material) into the ceiling surface.

A composite deck plate 10A includes a reinforced deck plate 15 and a wood-based plate 16 having a predetermined area and disposed under the reinforced deck plate 15. The reinforced deck plate 15 includes: a metal base 17 having a predetermined area and having a first end edge portion 20 and a second end edge portion 21 that face each other while being spaced apart from each other in a length direction and extend in a width direction, and a central portion 22 positioned between the first end edge portion 20 and the second end edge portion 21; and a reinforcing bar truss unit 19 (reinforcing structure) disposed and fixed on and to an upper surface 18 of the metal base 17 and extends in the length direction between the first end edge portion 20 and the second end edge portion 21 of the metal base 17. The wood-based plate is fixed to a lower surface 25 of the metal base 17 by a plurality of staples 42 arranged at equal intervals in the length direction.

### TECHNICAL FIELD

The present invention relates to a composite deck plate having a predetermined area and having both side edge portions and both end edge portions.

### BACKGROUND ART

A deck plate is disclosed which includes an iron plate (metal base) having a predetermined area and having both side edge portions extending in a length direction and both end edge portions extending in a width direction, a plurality of reinforcing bar truss structures installed on an upper surface of the iron plate and extending in the length direction, and a plurality of transverse ribs positioned on the upper surface of the iron plate, extending in the width direction, and arranged at predetermined intervals in the length direction (see Patent Literature 1). The iron plate has a plurality of ridges protruding upward from the upper surface thereof and extending in the length direction. The reinforcing bar truss includes an upper end beam that is positioned between a pair of ridges arranged in the width direction, is positioned above the upper surface of the iron plate, and extends in the length direction; a pair of lower end beams that is positioned between the pair of ridges, is positioned between the iron plate and the upper end beam, and extends in the length direction; and a pair of lattice beams that is positioned between the pair of ridges, is positioned between the iron plate and the upper end beam, and extends in the length direction while being repeatedly bent in a wave shape in a vertical direction.

Each of the lattice beams includes an upper end protrusion that is in contact with the upper end beam and is bent in a convex shape, and a lower end recess that is in contact with the upper surface of the metal base and is bent in a concave shape, and is widened outward in the width direction from the upper end protrusion toward the lower end recess. In the deck plate, the upper end protrusions of the lattice beams are spot-welded to the upper end beam, middle portions of the lattice beams are spot-welded to the lower end beams, the transverse ribs are arranged on the lower end recesses of the lattice beams and spot-welded to the ridges formed on the iron plate, and the lower end recesses of the lattice beams are sandwiched between the upper surface of the iron plate and the transverse ribs.

### CITATION LIST

### Patent Literature

Patent Literature 1: JP 2013-163914 A

### SUMMARY OF INVENTION

### Technical Problem

In the deck plate disclosed in Patent Literature 1, since a lower surface of the iron plate (metal base) is exposed downward, in a case of constructing a ceiling slab of a reinforced steel structure building, a reinforced concrete structure building, or a reinforced steel-concrete structure building by using the deck plate, the lower surface of the iron plate (metal base) cannot be used as a ceiling surface as it is, a plurality of hanging bolts need to be installed on the deck plate, and a ceiling finishing material such as decorative plywood, a gypsum board, or an aluminum panel needs to be attached to the hanging bolt, as a result of which ceiling finishing work is separately required, which takes time and cost.

Further, in a case of the deck plate disclosed in Patent Literature 1, an appealing design of a wood-based plate (wood, plywood, wood-based siding material, or cross laminated timber (CLT)) cannot be incorporated into the ceiling surface, and thus, it is not possible to form a ceiling surface that provides a viewer with aesthetic appeal, comfort, warmth, and tranquility offered by the wood-based plate. The wood and plywood among the wood-based plates exhibit natural designs such as different wood grains, colors, textures, and the like created by variations in cutting directions and wood parts, and have an effect of calming the feeling of a person who has seen the designs, and can thus be used to form a comfortable ceiling surface. The wood-based siding material among the wood-based plates exhibits high design aesthetics, can provide a viewer with a warm feeling of wood, and can variously change a finish's appearance with colors. Similarly to the wood and plywood, the CLT among the wood-based plates can form a comfortable ceiling surface having design aesthetics such as wood grains, colors, and textures. In addition, the CLT has a high strength, excellent thermal insulation, earthquake resistance, soundproofing, and fire resistance.

An object of the present invention is to provide a composite deck plate capable of forming an attractive ceiling surface by incorporating an appealing design of a wood-based plate (natural material) into the ceiling surface, and forming a ceiling surface that provides a viewer with aesthetic appeal, comfort, warmth, and tranquility offered by the wood-based plate. Another object of the present invention is to provide a composite deck plate capable of constructing a ceiling slab without attaching a ceiling finishing material such as decorative plywood, a gypsum board, or an aluminum panel by using a hanging bolt, thereby eliminating ceiling finishing work. Another object of the present invention is to provide a composite deck plate capable of constructing a ceiling slab that can prevent occurrence of a ceiling fall accident without risk of falling even when shaking (vibration) occurs due to an earthquake or the like.

### Solution to Problem

A premise of the present invention for solving the above problems is a composite deck plate having a predetermined area and having both side edge portions extending in a length direction and both end edge portions extending in a width direction intersecting the length direction.

A characteristic of the present invention under the above premise is that the composite deck plate includes: a reinforced deck plate; and at least one wood-based plate disposed under the reinforced deck plate and having a predetermined area, in which the reinforced deck plate includes a metal base having a predetermined area and having a first end edge portion, a second end edge portion, and a central portion, the first end edge portion and the second end edge portion facing each other while being spaced apart from each other in the length direction and extending in the width direction, and the central portion being positioned between the first end edge portion and the second end edge portion, and at least one reinforcing structure disposed and fixed on and to an upper surface of the metal base and extending in the length direction between the first end edge portion and the second end edge portion of the metal base, and the wood-based plate is fixed to a lower surface of the metal base by predetermined fixing means.

As an example of the present invention, the wood-based plate is any one of first to n-th wood-based plates extending in the length direction parallel to the reinforcing structure and arranged in the width direction intersecting the reinforcing structure, and first to n-th wood-based plates extending in the width direction intersecting the reinforcing structure and arranged in the length direction parallel to the reinforcing structure, and the wood-based plates are fixed to the lower surface of the metal base by the predetermined fixing means.

As another example of the present invention, the metal base of the reinforced deck plate has a first side edge portion extending in the length direction and a second side edge portion positioned opposite to the first side edge portion and extending in the length direction, and the wood-based plate has a first side area extending outward in the width direction from the first side edge portion of the metal base and exposed outward in the width direction from the first side edge portion, a second side area positioned opposite to the first side area, extending outward in the width direction from the second side edge portion of the metal base, and exposed outward in the width direction from the second side edge portion, and a center area positioned between the first and second side areas and fixed to the lower surface of the metal base.

As another example of the present invention, the metal base of the reinforced deck plate has a first side edge portion extending in the length direction and a second side edge portion positioned opposite to the first side edge portion and extending in the length direction, and the wood-based plate has a first side area positioned on a lower surface of the first side edge portion of the metal base and fixed to the first side edge portion, a second side area positioned opposite to the first side area, positioned on a lower surface of the second side edge portion of the metal base, and fixed to the second side edge portion, and a center area positioned between the first and second side areas and fixed to the lower surface of the metal base.

As another example of the present invention, the wood-based plate is fixed to the lower surface of the metal base by a plurality of fixing means intermittently arranged in the length direction of the metal base.

As another example of the present invention, the fixing means is a staple including a shoulder portion having a predetermined shoulder width and a pair of leg portions having a predetermined leg length, the staples are intermittently arranged at predetermined intervals in the length direction of the metal base in a state where the shoulder portions extend in the width direction, and the leg portions are applied into the wood-based plate while penetrating through the metal base.

As another example of the present invention, the fixing means is a staple including a shoulder portion having a predetermined shoulder width and a pair of leg portions having a predetermined leg length, the staples are intermittently arranged at predetermined intervals in the length direction of the metal base in a state where the shoulder portions extend in the length direction, and the leg portions are applied into the wood-based plate while penetrating through the metal base.

As another example of the present invention, the plurality of staples are intermittently arranged at predetermined intervals in the width direction of the metal base, and the leg portions are applied into the wood-based plate while penetrating through the metal base.

As another example of the present invention, the number of applied staples in a periphery of a center of the central portion of the metal base is larger than the number of applied staples in a remaining portion of the central portion excluding the periphery of the center of the metal base, a separation dimension between the staples in the length direction in the periphery of the center of the central portion of the metal base is smaller than a separation dimension between the staples in the length direction in the remaining portion of the central portion, and the staples are applied into the wood-based plate in a state of being densely arranged.

As another example of the present invention, the number of applied staples in peripheries of end edges of the first and second end edge portions of the metal base is larger than the number of applied staples in remaining portions of the first and second end edge portions excluding the peripheries of the end edges of the metal base, a separation dimension between the staples in the length direction in the peripheries of the end edges of the first and second end edge portions of the metal base is smaller than a separation dimension between the staples in the length direction in the remaining portions of the first and second end edge portions, and the staples are applied into the wood-based plate in a state of being densely arranged.

As another example of the present invention, an adhesive is applied to the staples.

As another example of the present invention, the fixing means is a plurality of fixing bolts or fixing screws each having a head portion and a screw portion having a predetermined length, the fixing bolts or fixing screws are intermittently arranged at predetermined intervals in the length direction of the metal base, and the screw portion is screwed into the wood-based plate while penetrating through the metal base.

As another example of the present invention, the plurality of fixing bolts or fixing screws are intermittently arranged at predetermined intervals in the width direction of the metal base, and the screw portion is screwed into the wood-based plate while penetrating through the metal base.

As another example of the present invention, the number of fixing bolts or fixing screws screwed in a periphery of a center of a central portion of the metal base is larger than the number of fixing bolts or fixing screws screwed in a remaining portion of the central portion excluding the periphery of the center of the metal base, a separation dimension between the fixing bolts or fixing screws in the length direction in the periphery of the center of the central portion of the metal base is smaller than a separation dimension between the fixing bolts or fixing screws in the length direction in the remaining portion of the central portion, and the fixing bolts or fixing screws are screwed into the wood-based plate in a state of being densely arranged.

As another example of the present invention, the number of fixing bolts or fixing screws screwed in peripheries of end edges of the first and second end edge portions of the metal base is larger than the number of fixing bolts or fixing screws screwed in remaining portions of the first and second end edge portions excluding the peripheries of the end edges of the metal base, a separation dimension between the fixing bolts or fixing screws in the length direction in the peripheries of the end edges of the first and second end edge portions of the metal base is smaller than a separation dimension between the fixing bolts or fixing screws in the length direction in the remaining portions of the first and second end edge portions, and the fixing bolts or fixing screws are screwed into the wood-based plate in a state of being densely arranged.

As another example of the present invention, the wood-based plate has a first end positioned at one end edge portion of the composite deck plate and a second end positioned at the other end edge portion of the composite deck plate, the first end edge portion of the metal base extends outward in the length direction from the first end of the wood-based plate by a predetermined dimension, and the second end edge portion of the metal base extends outward in the length direction from the second end of the wood-based plate by a predetermined dimension.

As another example of the present invention, a first point where the first end of the wood-based plate and a lower surface of the first end edge portion of the metal base are in contact with each other is waterproofed with a waterproofing material, and a second point where the second end of the wood-based plate and a lower surface of the second end edge portion of the metal base are in contact with each other is waterproofed with the waterproofing material.

As another example of the present invention, the metal base is an iron plate, and the wood-based plate is formed using any one of wood having a predetermined area, plywood having a predetermined area, a wood-based siding material having a predetermined area, a cross laminated timber (CLT) having a predetermined area, an oriented strand board (OSB plywood) having a predetermined area, a wood cement board having a predetermined area, a particle board having a predetermined area, and a medium density fiber (MDF) board having a predetermined area.

### Advantageous Effects of Invention

According to the composite deck plate of the present invention, the wood-based plate is fixed to the lower surface of the metal base of the reinforced deck plate by the predetermined fixing means, and the wood-based plate forms a ceiling surface of a building. Therefore, an attractive ceiling surface can be formed by incorporating an appealing design of the wood-based plate into the ceiling surface, and a ceiling surface that provides a viewer with aesthetic appeal, comfort, warmth, and tranquility offered by the wood-based plate which is a natural material can be formed. In the composite deck plate, the wood-based plate is fixed to the lower surface of the metal base of the reinforced deck plate to form the ceiling surface. Therefore, it is possible to construct a ceiling slab without attaching a ceiling finishing material such as decorative plywood, a gypsum board, or an aluminum panel by using a hanging bolt, and it is possible to eliminate ceiling finishing work for separately installing the ceiling finishing material, and it is possible to save labor and cost for the ceiling finishing work. With the composite deck plate, it is not necessary to attach a ceiling finishing material such as decorative plywood, a gypsum board, or an aluminum panel by using a hanging bolt. Therefore, unlike a suspended ceiling structure in which a ceiling finishing material is attached using a hanging bolt, ceiling finishing work can be eliminated, a ceiling slab can be efficiently constructed, there is no risk of falling even when shaking (vibration) occurs due to an earthquake or the like, and a ceiling slab capable of preventing occurrence of a ceiling fall accident can be constructed. For the composite deck plate, the wood-based plate, which is a sustainable circulation-type resource, is used, forest resources can be effectively used, so that the environmental load can be reduced by contributing to reduction of CO².

In the composite deck plate in which the wood-based plate is one of the first to n-th wood-based plates extending in the length direction parallel to the reinforcing structure and arranged in the width direction intersecting the reinforcing structure and the first to n-th wood-based plates extending in the width direction intersecting the reinforcing structure and arranged in the length direction parallel to the reinforcing structure, and the wood-based plates are fixed to the lower surface of the metal base by predetermined fixing means, the first to n-th wood-based plates extending in the length direction or the width direction are fixed to the lower surface of the metal base, so that an attractive of the wood-based plates extending in the length direction or the width direction can be incorporated into a ceiling surface, and a ceiling surface that provides a viewer with aesthetic appeal, comfort, warmth, and tranquility offered by the wood-based plates which are natural materials can be formed. With the composite deck plate, in a case where the wood-based plate is the first to n-th wood-based plates extending in the width direction intersecting the reinforcing structure and arranged in the length direction parallel to the reinforcing structure, it is possible to use end materials generated in the production of wood, and it is possible to save waste of wood. For the composite deck plate, the first to n-th wood-based plates, which are sustainable circulation-type resources, are used, so that forest resources can be effectively utilized, and the environmental load can be reduced by contributing to reduction of CO².

In the composite deck plate in which the metal base of the reinforced deck plate has the first side edge portion extending in the length direction and the second side edge portion positioned opposite to the first side edge portion and extending in the length direction, and the wood-based plate has the first side area extending outward in the width direction from the first side edge portion of the metal base and exposed outward in the width direction from the first side edge portion, the second side area positioned opposite to the first side area, extending outward in the width direction from the second side edge portion of the metal base, and exposed outward in the width direction from the second side edge portion, and the center area positioned between the first and second side areas and fixed to the lower surface of the metal base, since the metal base forming the reinforced deck plate is not disposed on the entire wood-based plate, the use amount of the metal base can be reduced by reducing the area of the metal base in the composite deck plate. Since the use amount of the metal base is reduced, a ceiling slab can be constructed inexpensively, and the weight of the composite deck plate can be reduced, thereby reducing the weight of the ceiling slab. In the composite deck plate, the center area and the first and second side areas of the wood-based plate conceal the metal base, the metal base is not exposed on the lower side of the composite deck plate, and the center area and the first and second side areas of the wood-based plate are exposed on the lower side of the composite deck plate to form a ceiling surface. Therefore, an appealing design of the wood-based plate can be incorporated into the ceiling surface, and a ceiling surface that provides a viewer with aesthetic appeal, comfort, warmth, and tranquility offered by the wood-based plate which is a natural material can be formed.

In the composite deck plate in which the metal base of the reinforced deck plate has the first side edge portion extending in the length direction and the second side edge portion positioned opposite to the first side edge portion and extending in the length direction, and the wood-based plate has the first side area positioned on the lower surface of the first side edge portion of the metal base and fixed to the first side edge portion, the second side area positioned opposite to the first side area, positioned on the lower surface of the second side edge portion of the metal base, and fixed to the second side edge portion, and the center area positioned between the first and second side areas and fixed to the lower surface of the metal base, the first and second side areas of the wood-based plate are positioned on the lower surfaces of the first and second side edge portions of the metal base, the center area and the first and second side areas of the wood-based plate conceal the metal base, the metal base is not exposed on the lower side of the composite deck plate, and the center area and the first and second side areas of the wood-based plate are exposed on the lower side of the composite deck plate to form a ceiling surface. Therefore, an appealing design of the wood-based plate can be introduced into the ceiling surface, and a ceiling surface that provides a viewer with aesthetic appeal, comfort, warmth, and tranquility offered by the wood-based plate which is a natural material can be formed.

In the composite deck plate in which the wood-based plate is fixed to the lower surface of the metal base by the plurality of fixing means intermittently arranged in the length direction of the metal base, since the wood-based plate is fixed to the lower surface of the metal base by the plurality of fixing means intermittently arranged in the length direction of the metal base, the wood-based plate can be reliably fixed to the lower surface of the metal base, and even when shaking (vibration) occurs due to an earthquake or the like, there is no risk of falling, and a ceiling slab capable of preventing occurrence of a ceiling fall accident can be constructed. With the composite deck plate, an attractive ceiling surface can be formed using the wood-based plate fixed to the lower surface of the metal base by the plurality of fixing means intermittently arranged in the length direction, and a ceiling surface that provides a viewer with aesthetic appeal, comfort, warmth, and tranquility offered by the wood-based plate which is a natural material can be formed.

In the composite deck plate in which the fixing means is the staple including the shoulder portion having a predetermined shoulder width and the pair of leg portions having a predetermined leg length, the staples are intermittently arranged at predetermined intervals in the length direction of the metal base in a state where the shoulder portions extend in the width direction, and the leg portions are applied into the wood-based plate while penetrating through the metal base, the wood-based plate is fixed to the lower surface of the metal base by the staples intermittently arranged at the predetermined intervals in the length direction of the metal base in a state where the shoulder portions extend in the width direction, so that the wood-based plate can be reliably fixed to the lower surface of the metal base, and there is no risk of falling of the wood-based plate even when shaking (vibration) due to an earthquake or the like occurs, and a ceiling slab capable of preventing occurrence of a ceiling fall accident can be constructed. With the composite deck plate, an attractive ceiling surface having an appealing design can be formed by using the wood-based plate fixed to the lower surface of the metal base by the staples that are intermittently arranged at the predetermined intervals in the length direction in a state where the shoulder portions extend in the width direction, and a ceiling surface that provides a viewer with aesthetic appeal, comfort, warmth, and tranquility offered by the wood-based plate which is a natural material can be formed.

In the composite deck plate in which the fixing means is the staple including the shoulder portion having a predetermined shoulder width and the pair of leg portions having a predetermined leg length, the staples are intermittently arranged at predetermined intervals in the length direction of the metal base in a state where the shoulder portions extend in the length direction, and the leg portions are applied into the wood-based plate while penetrating through the metal base, the wood-based plate is fixed to the lower surface of the metal base by the staples intermittently arranged at the predetermined intervals in the length direction of the metal base in a state where the shoulder portions extend in the length direction, so that the wood-based plate can be reliably fixed to the lower surface of the metal base, and there is no risk of falling of the wood-based plate even when shaking (vibration) due to an earthquake or the like occurs, and a ceiling slab capable of preventing occurrence of a ceiling fall accident can be constructed. With the composite deck plate, an attractive ceiling surface having an appealing design can be formed by using the wood-based plate fixed to the lower surface of the metal base by the staples that are intermittently arranged at the predetermined intervals in the length direction in a state where the shoulder portions extend in the length direction, and a ceiling surface that provides a viewer with aesthetic appeal, comfort, warmth, and tranquility offered by the wood-based plate which is a natural material can be formed.

In the composite deck plate in which the plurality of staples are intermittently arranged at the predetermined intervals in the width direction of the metal base and are applied into the wood-based plate while the leg portions penetrate through the metal base, the wood-based plate is fixed to the lower surface of the metal base by the plurality of staples that are intermittently arranged at the predetermined intervals in the length direction in a state where the shoulder portions extend in the width direction or the length direction and are arranged at the predetermined intervals in the width direction. Therefore, the wood-based plate can be firmly connected to the lower surface of the metal base, and even when concrete is cast on the upper surface of the composite deck plate after the composite deck plate is bridged over beams of a building, the fixation between the metal base and the wood-based plate is not carelessly released, so that it is possible to form a sturdy reinforced concrete ceiling slab formed using the reinforced deck plate and the wood-based plate, and to form a sturdy ceiling surface that provides a viewer with aesthetic appeal, comfort, warmth, and tranquility offered by the wood-based plate which is a natural material.

In the composite deck plate in which the number of applied staples in the periphery of the center of the central portion of the metal base is larger than the number of applied staples in the remaining portion of the central portion excluding the periphery of the center of the metal base, the separation dimension between the staples in the length direction in the periphery of the center of the central portion of the metal base is smaller than the separation dimension between the staples in the length direction in the remaining portion of the central portion, and the staples are applied into the wood-based plate in a state of being densely arranged, the wood-based plate is fixed to the lower surface of the metal base by using a large number of staples whose shoulder portions extend in the width direction or the length direction in the periphery of the center of the central portion of the metal base. Therefore, the wood-based plate can be firmly connected to the lower surface of the periphery of the center of the central portion of the metal base, and even when concrete is cast on the upper surface of the composite deck plate after the composite deck plate is bridged over beams of a building, and a load of the concrete acts in such a way that the periphery of the center of the central portion of the metal base is curved downward, the fixation between the periphery of the center of the central portion of the metal base and the wood-based plate is not carelessly released, so that it is possible to form a sturdy reinforced concrete ceiling slab formed using the reinforced deck plate and the wood-based plate, and to form a sturdy ceiling surface that provides a viewer with aesthetic appeal, comfort, warmth, and tranquility offered by the wood-based plate which is a natural material.

In the composite deck plate in which the number of applied staples in the peripheries of the end edges of the first and second end edge portions of the metal base is larger than the number of applied staples in the remaining portions of the first and second end edge portions excluding the peripheries of the end edges of the metal base, the separation dimension between the staples in the length direction in the peripheries of the end edges of the first and second end edge portions of the metal base is smaller than the separation dimension between the staples in the length direction in the remaining portions of the first and second end edge portions, and the staples are applied into the wood-based plate in a state of being densely arranged, the wood-based plate is fixed to the lower surface of the metal base by using a large number of staples whose shoulder portions extend in the width direction or the length direction in the peripheries of the end edges of the first and second end edge portions of the metal base. Therefore, the wood-based plate can be firmly connected to the lower surfaces of the peripheries of the end edges of the first and second end edge portions of the metal base, and even when concrete is cast on the upper surface of the composite deck plate after the composite deck plate is bridged over beams of a building, and a load of the concrete acts in such a way that the peripheries of the end edges of the first and second end edge portions of the metal base are warped upward, the fixation between the peripheries of the end edges of the first and second end edge portions of the metal base and the wood-based plate is not carelessly released, so that it is possible to form a sturdy reinforced concrete ceiling slab formed using the reinforced deck plate and the wood-based plate, and to form a sturdy ceiling surface that provides a viewer with by the wood-based plate which is a natural material.

In the composite deck plate in which the adhesive is applied to the staples, since the wood-based plate is fixed to the lower surface of the metal base by the plurality of staples to which the adhesive is applied, the wood-based plate can be reliably fixed to the lower surface of the metal base using the adhesive, even when shaking (vibration) due to an earthquake or the like occurs, there is no risk of falling of the wood-based plate, and a ceiling slab capable of preventing occurrence of a ceiling fall accident can be constructed. Further, an attractive ceiling surface having an appealing design can be formed by using the wood-based plate fixed to the lower surface of the metal base by the plurality of staples to which the adhesive is applied, and a ceiling surface that provides a viewer with aesthetic appeal, comfort, warmth, and tranquility offered by the wood-based plate which is a natural material can be formed.

In the composite deck plate in which the fixing means is the plurality of fixing bolts or fixing screws each including the head portion and the screw portion having a predetermined length, the fixing bolts or fixing screws are intermittently arranged at predetermined intervals in the length direction of the metal base, and the screw portions penetrate through the metal base and are screwed into the wood-based plate, the wood-based plate is fixed to the lower surface of the metal base by the fixing bolts or fixing screws intermittently arranged at predetermined intervals in the length direction of the metal base. Therefore, the wood-based plate can be reliably fixed to the lower surface of the metal base, and even when shaking (vibration) occurs due to an earthquake or the like, there is no risk of falling of the wood-based plate, and a ceiling slab capable of preventing occurrence of a ceiling fall accident can be constructed. With the composite deck plate, an attractive ceiling surface having an appealing design can be formed by using the wood-based plate fixed to the lower surface of the metal base by the fixing bolts or fixing screws that are intermittently arranged at the predetermined intervals in the length direction, and a ceiling surface that provides a viewer with aesthetic appeal, comfort, warmth, and tranquility offered by the wood-based plate which is a natural material can be formed.

In the composite deck plate in which the plurality of fixing bolts or fixing screws are intermittently arranged at the predetermined intervals in the width direction of the metal base and the screw portions are screwed into the wood-based plate while penetrating through the metal base, the wood-based plate is fixed to the lower surface of the metal base by the plurality of fixing bolts or fixing screws arranged at the predetermined intervals in the length direction and intermittently arranged at the predetermined intervals in the width direction. Therefore, the wood-based plate can be firmly connected to the lower surface of the metal base, and even when concrete is cast on the upper surface of the composite deck plate after the composite deck plate is bridged over beams of a building, the fixation between the metal base and the wood-based plate is not carelessly released, so that it is possible to form a sturdy reinforced concrete ceiling slab formed using the reinforced deck plate and the wood-based plate, and to form a sturdy ceiling surface that provides a viewer with aesthetic appeal, comfort, warmth, and tranquility offered by the wood-based plate which is a natural material.

In the composite deck plate in which the number of fixing bolts or fixing screws screwed in the periphery of the center of the central portion of the metal base is larger than the number of fixing bolts or fixing screws screwed in the remaining portion of the central portion excluding the periphery of the center of the metal base, the separation dimension between the fixing bolts or fixing screws in the length direction in the periphery of the center of the central portion of the metal base is smaller than the separation dimension between the fixing bolts or fixing screws in the length direction in the remaining portion of the central portion, and the fixing bolts or fixing screws are screwed into the wood-based plate in a state of being densely arranged, the wood-based plate is fixed to the lower surface of the metal base by using a large number of fixing bolts or a large number of fixing screws in the periphery of the center of the central portion of the metal base. Therefore, the wood-based plate can be firmly connected to the lower surface of the periphery of the center of the central portion of the metal base, and even when concrete is cast on the upper surface of the composite deck plate after the composite deck plate is bridged over beams of a building, and a load of the concrete acts in such a way that the periphery of the center of the central portion of the metal base is curved downward, the fixation between the periphery of the center of the central portion of the metal base and the wood-based plate is not carelessly released, so that it is possible to form a sturdy reinforced concrete ceiling slab formed using the reinforced deck plate and the wood-based plate, and to form a sturdy ceiling surface that provides a viewer with by the wood-based plate which is a natural material.

In the composite deck plate in which the number of fixing bolts or fixing screws screwed in the peripheries of the end edges of the first and second end edge portions of the metal base is larger than the number of fixing bolts or fixing screws screwed in the remaining portions of the first and second end edge portions excluding the peripheries of the end edges of the metal base, the separation dimension between the fixing bolts or fixing screws in the length direction in the peripheries of the end edges of the first and second end edge portions of the metal base is smaller than the separation dimension between the fixing bolts or fixing screws in the length direction in the remaining portions of the first and second end edge portions, and the fixing bolts or fixing screws are screwed into the wood-based plate in a state of being densely arranged, the wood-based plate is fixed to the lower surface of the metal base by using a large number of fixing bolts or a large number of fixing screws in the peripheries of the end edges of the first and second end edge portions of the metal base. Therefore, the wood-based plate can be firmly connected to the lower surfaces of the peripheries of the end edges of the first and second end edge portions of the metal base, and even when concrete is cast on the upper surface of the composite deck plate after the composite deck plate is bridged over beams of a building, and a load of the concrete acts in such a way that the peripheries of the end edges of the first and second end edge portions of the metal base are warped upward, the fixation between the peripheries of the end edges of the first and second end edge portions of the metal base and the wood-based plate is not carelessly released, so that it is possible to form a sturdy reinforced concrete ceiling slab formed using the reinforced deck plate and the wood-based plate, and to form a sturdy ceiling surface that provides a viewer with aesthetic appeal, comfort, warmth, and tranquility offered by the wood-based plate which is a natural material.

With the composite deck plate in which the wood-based plate has the first end positioned at one end edge portion of the composite deck plate and the second end positioned at the other end edge portion of the composite deck plate, the first end edge portion of the metal base extends outward in the length direction from the first end of the wood-based plate by a predetermined dimension, and the second end edge portion of the metal base extends outward in the length direction from the second end of the wood-based plate by a predetermined dimension, the first end edge portion of the composite deck plate can be connected to one beam (a flange of an H beam) in a state where the first end edge portion of the metal base extending outward in the length direction from the first end of the wood-based plate is placed on the one beam (the flange of the H beam), and the second end edge portion of the composite deck plate can be connected to the other beam (a flange of an H beam) in a state where the second end edge portion of the metal base extending outward in the length direction from the second end of the wood-based plate is placed on the other beam (the flange of the H beam), so that connection work for the first end edge portion of the composite deck plate and the one beam (the flange of the H beam) and connection work for the second end edge portion of the composite deck plate and the other beam (the flange of the H beam) can be easily performed.

With the composite deck plate in which the first point where the first end of the wood-based plate and the lower surface of the first end edge portion of the metal base are in contact with each other is waterproofed by the waterproofing material, and the second point where the second end of the wood-based plate and the lower surface of the second end edge portion of the metal base are in contact with each other is waterproofed by the waterproofing material, when concrete is cast on the upper surface of the metal base, it is possible to prevent concrete slurry from intruding between the lower surface of the metal base and the upper surface of the wood-based plate from the first point where the first end of the wood-based plate and the lower surface of the first end edge portion of the metal base are in contact with each other and to prevent concrete slurry from intruding between the lower surface of the metal base and the upper surface of the wood-based plate from the second point where the second end of the wood-based plate and the lower surface of the second end edge portion of the metal base are in contact with each other, so that it is possible to prevent corrosion (rust) of the metal base due to the concrete slurry.

The composite deck plate in which the metal base is an iron plate, and the wood-based plate is any one of wood having a predetermined area, plywood having a predetermined area, a wood-based siding material having a predetermined area, a CLT having a predetermined area, an oriented strand board (OSB plywood) having a predetermined area, a wood cement board having a predetermined area, a particle board having a predetermined area, and a MDF board having a predetermined area can form an attractive ceiling surface with an appealing design of the wood, plywood, wood-based siding material, CLT, oriented strand board (OSB plywood), wood cement board, particle board, or MDF board, and can form a ceiling surface that provides a viewer with aesthetic appeal, comfort, warmth, and tranquility offered by the wood-based plate which is a natural material. In a case where the wood-based plate is the wood, plywood, oriented strand board (OSB plywood), wood cement board, particle board, or MDF board, natural designs such as different wood grains, colors, textures, and the like created by variations in cutting directions and wood parts are exhibited, and an effect of calming the feeling of a person who has seen the designs is obtained, and thus, a comfortable ceiling surface can be formed. In a case where the wood-based plate is a wood-based siding material, it is possible to form a ceiling surface that exhibits high design aesthetics, can provide a viewer with a warm feeling of wood, and can variously change a finish's appearance with colors. In a case where the wood-based plate is the CLT, similarly to the wood and plywood, it is possible to form a comfortable ceiling surface having design aesthetics such as wood grains, colors, and textures, and to form a ceiling surface having a high strength, excellent thermal insulation, earthquake resistance, soundproofing, and fire resistance.

### BRIEF DESCRIPTION OF DRAWINGS

FIG. 1 is a perspective view of a composite deck plate illustrated as an example.

FIG. 2 is a top view of the composite deck plate of FIG. 1.

FIG. 3 is a front view of the composite deck plate of FIG. 1.

FIG. 4 is a side view of the composite deck plate of FIG. 1.

FIG. 5 is a perspective view illustrating another example of arrangement of staples.

FIG. 6 is a perspective view illustrating another example of the arrangement of the staples.

FIG. 7 is a perspective view illustrating another example of the arrangement of the staples.

FIG. 8 is a perspective view of a composite deck plate as another example.

FIG. 9 is a top view of the composite deck plate of FIG. 8.

FIG. 10 is a front view of the composite deck plate of FIG. 8.

FIG. 11 is a perspective view of a composite deck plate illustrated as another example.

FIG. 12 is a top view of the composite deck plate of FIG. 11.

FIG. 13 is a side view of the composite deck plate of FIG. 11.

FIG. 14 is a perspective view of a composite deck plate illustrated as another example.

FIG. 15 is a top view of the composite deck plate of FIG. 14.

FIG. 16 is a front view of the composite deck plate of FIG. 14.

FIG. 17 is a perspective view of a composite deck plate illustrated as another example.

FIG. 18 is a top view of the composite deck plate of FIG. 17.

FIG. 19 is a front view of the composite deck plate of FIG. 17.

FIG. 20 is a perspective view of a composite deck plate illustrated as another example.

FIG. 21 is a top view of the composite deck plate of FIG. 20.

FIG. 22 is a front view of the composite deck plate of FIG. 20.

FIG. 23 is a perspective view of a composite deck plate illustrated as another example.

FIG. 24 is a top view of the composite deck plate of FIG. 23.

FIG. 25 is a front view of the composite deck plate of FIG. 23.

FIG. 26 is a perspective view of a composite deck plate illustrated as another example.

FIG. 27 is a top view of the composite deck plate of FIG. 26.

FIG. 28 is a perspective view of a composite deck plate illustrated as another example.

FIG. 29 is a top view of the composite deck plate of FIG. 28.

FIG. 30 is a perspective view of a composite deck plate illustrated as an example.

FIG. 31 is a top view of the composite deck plate of FIG. 30.

FIG. 32 is a front view of the composite deck plate of FIG. 30.

FIG. 33 is a side view of the composite deck plate of FIG. 30.

FIG. 34 is a perspective view of a composite deck plate illustrated as an example.

FIG. 35 is a top view of the composite deck plate of FIG. 34.

FIG. 36 is a front view of the composite deck plate of

FIG. 34.

FIG. 37 is a side view of the composite deck plate of FIG. 34.

FIG. 38 is a perspective view of a composite deck plate illustrated as an example.

FIG. 39 is a top view of the composite deck plate of FIG. 38.

FIG. 40 is a front view of the composite deck plate of FIG. 38.

FIG. 41 is a side view of the composite deck plate of FIG. 38.

FIG. 42 is a perspective view of a composite deck plate illustrated as an example.

FIG. 43 is a top view of the composite deck plate of FIG. 42.

FIG. 44 is a front view of the composite deck plate of FIG. 42.

FIG. 45 is a side view of the composite deck plate of FIG. 42.

### DESCRIPTION OF EMBODIMENTS

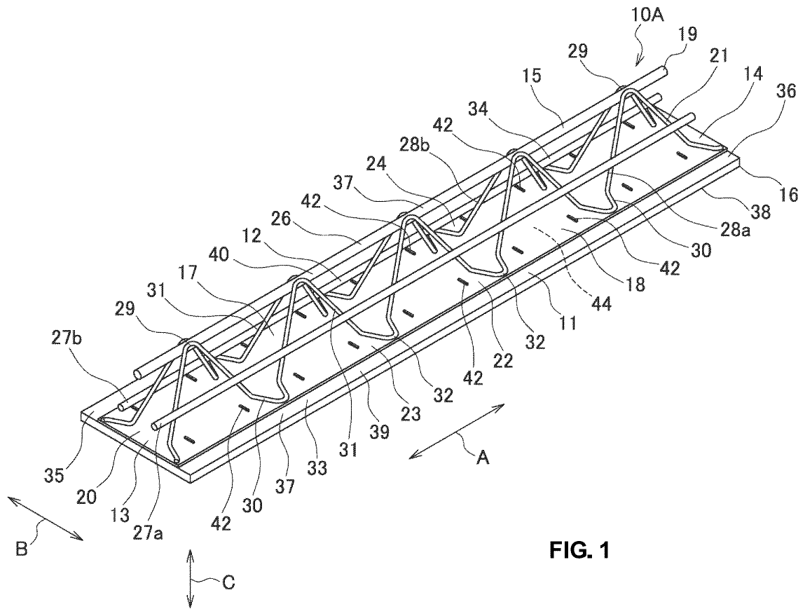

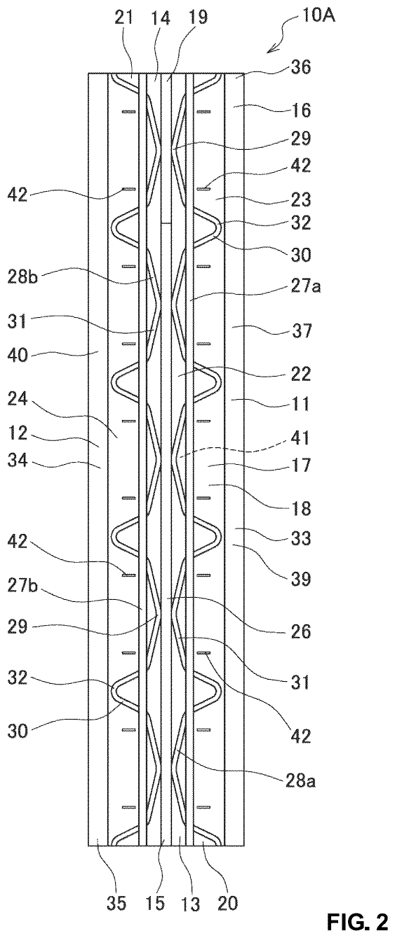

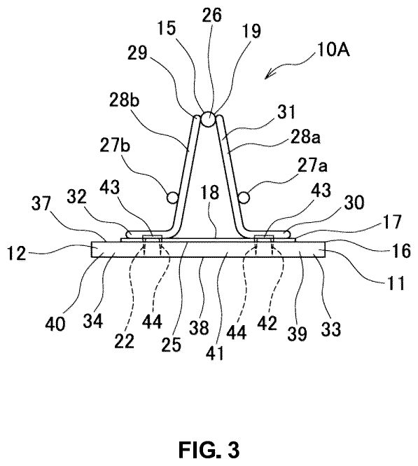

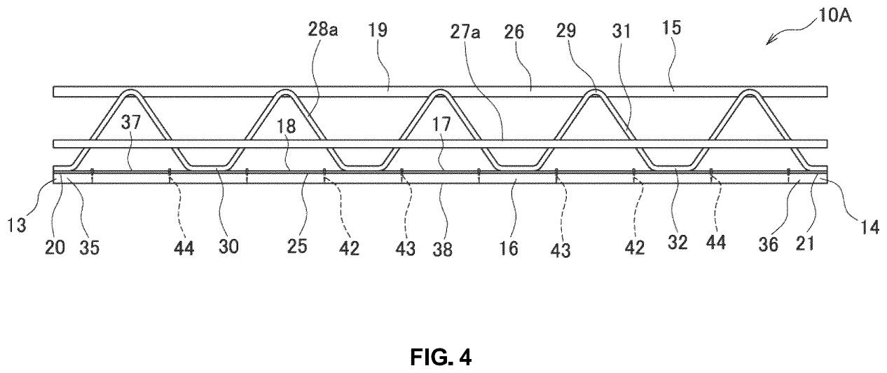

Details of a composite deck plate according to the present invention will be described below with reference to the accompanying drawings such as FIG. 1 which is a perspective view of a composite deck plate 10A illustrated as an example. FIG. 2 is a top view of the composite deck plate 10A of FIG. 1, and FIG. 3 is a front view of the composite deck plate 10A of FIG. 1. FIG. 4 is a side view of the composite deck plate 10A of FIG. 1. In FIG. 1, a length direction (front-back direction) is indicated by an arrow A, a width direction is indicated by an arrow B, and a vertical direction (thickness direction) is indicated by an arrow C.

A plurality of composite deck plates 10A (including composite deck plates 10B to 10M) are connected in a state of being arranged in the width direction, and are used for constructing a ceiling slab of a reinforced steel structure building, a reinforced concrete structure building, or a reinforced steel-concrete structure building. The composite deck plate 10A has a first side edge portion 11 and a second side edge portion 11 (both side edge portions) that face each other while being spaced apart from each other in the width direction and extend in the length direction, and a first end edge portion 13 and a second end edge portion 14 (both end edge portions) that face each other while being spaced apart from each other in the length direction and extend in the width direction. The composite deck plate 10A includes a reinforced deck plate 15 having a predetermined area (a deck plate with a reinforcing bar truss) and a wood-based plate 16 having a predetermined area.

In addition to those illustrated in FIGS. 1, 14, 34, and 38, various types of reinforced deck plates (deck plates with reinforcing bar trusses) currently used can be used as deck plates with reinforcement (deck plates with reinforcing bar trusses) for forming the composite deck plate 10A (including the composite deck plates 10B to 10M) according to the present invention, and any type of reinforced deck plate (deck plates with reinforcing bar trusses) developed in the future can be used.

The reinforced deck plate 15 includes a metal base 17 having a large predetermined area in the length direction and disposed on the wood-based plate 16, and a reinforcing bar truss unit 19 (reinforcing structure) disposed and fixed (installed) on and to an upper surface 18 of the metal base 17. The metal base 17 is made of an iron plate having a thickness of 2 to 4 mm. The metal base 17 may be made of another metal such as a galvanized steel plate, an aluminum plate, a stainless steel plate, or a titanium plate.

The metal base 17 has a first end edge portion 20 and a second end edge portion 21 that face each other while being spaced apart from each other in the length direction and extend in the width direction, a central portion 22 positioned between the first end edge portion 20 and the second end edge portion 21, a first side edge portion 23 extending in the length direction, and a second side edge portion 24 positioned opposite to the first side edge portion 23 and extending in the length direction, and has the substantially flat upper surface 18 and a substantially flat lower surface 25. The upper and lower surfaces 18 and 25 of the metal base 17 are plated. The area of the metal base 17 is not particularly limited, and the area can be freely determined according to a size of a ceiling slab to be constructed, a strength required for the ceiling slab, an amount of reinforcing bars required for the ceiling slab, and the like.

The reinforcing bar truss unit 19 (reinforcing structure) is disposed between the first and second side edge portions 23 and 24 of the metal base 17 and extends in the length direction from the first end edge portion 20 toward the second end edge portion 21. The reinforcing bar truss unit 19 includes (is assembled with) one upper end beam 26, two (a pair of) first and second lower end beams 27a and 27b, and two (a pair of) first and second lattice beams 28a and 28b.

The upper end beam 26 of the composite deck plate 10A is made of an iron bar obtained by extending iron. A deformed iron bar (deformed reinforcing bar) having a plurality of ribs on a peripheral surface thereof is used as the upper end beam 26. The upper end beam 26 is positioned between the first and second side edge portions 23 and 24 of the metal base 17 and at the center of the metal base 17 in the width direction, and linearly extends in the length direction while being spaced upward from the upper surface 18 of the metal base 17.

The first and second lower end beams 27a and 27b of the composite deck plate 10A are made of iron bars obtained by extending iron. Deformed metal bars (deformed reinforcing bars) having a plurality of ribs on peripheral surfaces thereof are used as the lower end beams 27a and 27b. The lower end beams 27a and 27b are positioned between the first and second side edge portions 23 and 24 of the metal base 17, and are positioned below the upper end beam 26 and on both sides of the upper end beam 26 in the width direction. The first lower end beam 27a is positioned on an outer side of the first lattice beam 28a in the width direction, and the second lower end beam 27b is positioned on an outer side of the second lattice beam 28b in the width direction. The first and second lower end beams 27a and 27b are spaced upward at a predetermined interval from the upper surface 18 of the metal base 17 and linearly extend in the length direction.

The first and second lattice beams 28a and 28b of the composite deck plate 10A are made of iron bars obtained by extending iron. The lattice beams 28a and 28b are positioned between the first and second side edge portions 23 and 24 of the metal base 17 and between the upper surface 18 of the metal base 17 and the upper end beam 26. The first and second lattice beams 28a and 28b extend in the length direction while being repeatedly bent (undulating) in a wave shape in the vertical direction between the upper surface 18 of the metal base 17 and the upper end beam 26. The lattice beams 28a and 28b each include an upper end protrusion 29 positioned adjacent to the upper end beam 26 and forming an arc in such a way as to protrude upward, a lower end recess 30 positioned adjacent to the upper surface 18 of the metal base 17, and a middle portion 31 extending obliquely in the length direction between the upper end protrusion 29 and the lower end recess 30.

As illustrated in FIGS. 1 and 3, the first and second lattice beams 28a and 28b are not perpendicular to the upper surface 18 of the metal base 17, but are inclined at a predetermined angle with respect to the upper surface 18 of the metal base 17, and are widened outward in the width direction from the upper end protrusion 29 toward the lower end recess 30. Inclination angles of the lattice beams 28a and 28b with respect to the metal base 17 are not particularly limited and can be freely changed.

Angles at which the first and second lattice beams 28a and 28b are repeatedly bent in a wave shape in the vertical direction are constant, and the numbers of times that the lattice beams 28a and 28b are repeatedly bent per unit length (for example, 1 m) are the same. The angles at which the lattice beams 28a and 28b are repeatedly bent in a wave shape in the vertical direction (the numbers of times that the lattice beams 28a and 28b are repeatedly bent in a wave shape in the vertical direction per unit length) can be freely changed, and a vertical separation dimension between the upper end protrusions 29 of the lattice beams 28a and 28b can be adjusted, and a vertical separation dimension between the lower end recesses 30 of the lattice beams 28a and 28b can be adjusted by adjusting the angles (adjusting the numbers of times that the lattice beams 28a and 28b are repeatedly bent in a wave shape in the vertical direction per unit length).

The first and second lattice beams 28a and 28b are arranged symmetrically in the width direction in relation to the upper end beam 26. Therefore, positions of the upper end protrusions 29 of the lattice beams 28a and 28b arranged in the width direction coincide with each other, positions of the middle portions 31 coincide with each other, and positions of the lower end recesses 30 coincide with each other. In the first and second lattice beams 28a and 28b, the separation dimensions between the upper end protrusions 29 adjacent in the length direction are equal, the upper end protrusions 29 are arranged at equal intervals in the length direction, the separation dimensions between the lower end recesses 30 adjacent in the length direction are equal, and the lower end recesses 30 are arranged at equal intervals in the length direction.

In a state where the upper end protrusions 29 of the first and second lattice beams 28a and 28b are in contact with both sides (circumferential surface) of the upper end beam 26 in the width direction, a portion (intersecting portion) of the upper end protrusion 29 that intersects the upper end beam 26 is welded (fixed) to the upper end beam 26 by spot welding. The middle portions 31 of the lattice beams 28a and 28b are positioned on inner sides of the lower end beams 27a and 27b, respectively, and portions (intersecting portions) of the middle portions 31 that intersect the lower end beams 27a and 27b are welded (fixed) to the lower end beams 27a and 27b, respectively, by spot welding.

The lower end recesses 30 of the first and second lattice beams 28a and 28b are bent outward in the width direction in such a way as to be parallel to the upper surface 18 of the metal base 17, and form an arc in such a way as to protrude outward in the width direction. A bent portion 32 extending outward in the width direction is formed in the lower end recess 30. The bent portion 32 of the lower end recess 30 is positioned on the upper surface 18 of the metal base 17 and is in contact with the upper surface 18, and a part (for example, a distal end portion (one point) of the bent portion 32 or both side portions (two points) of the bent portion 32) of the bent portion 32 is welded (fixed) to the metal base 17 by spot welding. The lower end recesses 30 of the first and second lattice beams 28a and 28b do not have to be bent outward in the width direction, and the bent portion 32 does not have to be formed in the lower end recess 30. In this case, the lower end recesses 30 of the lattice beams 28a and 28b are in contact with the upper surface 18 of the metal base 17, and intersecting points (intersecting portions) of the lower end recesses 30 that are in contact with the upper surface 18 of the metal base 17 are welded (fixed) to the metal base 17 by spot welding.

Thicknesses of the upper end beam 26, the first and second lower end beams 27a and 27b, and the first and second lattice beams 28a and 28b are not particularly limited, and the thicknesses of the upper end beam 26, the lower end beams 27a and 27b, and the lattice beams 28a and 28b can be freely changed according to the size of the ceiling slab to be constructed, the strength required for the ceiling slab, the amount of the reinforcing bars required for the ceiling slab, and the like. The upper end beam 26, the first and second lower end beams 27a and 27b, and the first and second lattice beams 28a and 28b are made of iron, but can also be made of metal other than iron. In addition, in a case where the upper end beam 26, the lower end beams 27a and 27b, and the lattice beams 28a and 28b are made of iron, rust prevention treatment such as plating may be performed on the upper end beam 26, the lower end beams 27a and 27b, and the lattice beams 28a and 28b.

The metal base 17 (including metal bases 17 of the composite deck plates 10B to 10M) may have a plurality of protrusions (projections) protruding upward from the upper surface 18. The protrusions (projections) are positioned between the first and second end edge portions 20 and 21 of the metal base 17, are arranged at equal intervals (at predetermined intervals) in the width direction, and extend in the length direction from one end edge portion 20 toward the other end edge portion 21. The protrusions can be formed by bending a part of the metal base 17 inward in the width direction and folding a part of the metal base 17 upward from the upper surface 18 of the metal base 17 in such a way as to form a mountain fold. The protrusions have a height dimension of 3 to 10 mm in the vertical direction, and a front shape of the protrusion is an arc shape (inverted U shape). The front shape of the protrusion may be a plate shape linearly extending in the vertical direction, or may be an inverted V shape.

In a case where the plurality of protrusions (projections) are formed on the metal base 17, the bent portion 32 of the lower end recess 30 of each of the first and second lattice beams 28a and 28b is positioned on the protrusion of the metal base 17, and a part of the bent portion 32 intersects the protrusion at two points (two portions) while protruding outward in the width direction from the protrusion. The portions (intersecting portions (two points)) of the bent portion 32 that intersect the protrusion are welded (fixed) to the protrusion by spot welding. In a case where the lower end recess 30 of each of the lattice beams 28a and 28b is not bent outward in the width direction and the bent portion 32 is not formed in the lower end recess 30, the lower end recess 30 of each of the lattice beams 28a and 28b intersects and is in contact with one point of the protrusion of the metal base 17, and the intersecting point (intersecting portion (one point)) of the lower end recess 30 that intersects one point of the protrusion is welded (fixed) to the protrusion by spot welding.

The wood-based plate 16 is a single plate having a first side edge portion 33 and a second side edge portion 34 (both side edge portions) (first and second side areas 39 and 40) that face each other while being spaced apart from each other in the width direction and extend in the length direction, and a first end edge portion 35 and a second end edge portion 36 (both end edge portions) that face each other while being spaced apart from each other in the length direction and extend in the width direction, and has a substantially flat upper surface 37 and a substantially flat lower surface 38. As the wood-based plate 16, any one of wood having a predetermined area and extending substantially flat in the length direction and the width direction, plywood having a predetermined area and extending substantially flat in the length direction and the width direction, a wood-based siding material having a predetermined area and extending substantially flat in the length direction and the width direction, a cross laminated timber (CLT) having a predetermined area and extending substantially flat in the length direction and the width direction, an oriented strand board (OSB plywood) having a predetermined area and extending substantially flat in the length direction and the width direction, a wood cement board having a predetermined area and extending substantially flat in the length direction and the width direction, a particle board having a predetermined area and extending substantially flat in the length direction and the width direction, and a medium density fiber (MDF) board having a predetermined area and extending substantially flat in the length direction and the width direction is used.

As the wood, any of various softwoods having different forms such as different wood grains (decorative surface) and thickness dimensions, and various hardwoods having different forms such as different wood grains (decorative surface) and thickness dimensions are used. The wood has a thickness dimension in a range of 10 mm to 300 mm. As the wood, Japanese hackberry, etimoé, ebiara, elm, Japanese pagoda tree, okoumé, ovangkol, olive tree, curly maple, Kaizuka Ibuki (Juniperus chinensis “Kaizuka”), maple tree, Japanese persimmon tree, sword-leaf actinodaphne, katsura, canarium, birch, kapur, Chinese nutmeg yew, larch, calantas, Japanese quince, garo garo, calophyllum, chisocheton, hinoki cypress, Chinese cork tree, Japanese cedar, empress tree, quilted maple, camphor tree, Chinese sargent spruce, claro walnut, chestnut, walnut tree, Yezo spruce, Japanese black persimmon tree, Japanese black pine, mulberry, and Japanese zelkova can be used.

Alternatively, kempas, Japanese raisin tree, coffee nut tree, Chinese fir, ebony, Kokuren, koshiabura, kosipo, cottonwood, Japanese oak, kobushi magnolia, Japanese white pine, Japanese honey locust, sassafras, sazan cypress, sapelli, Japanese wingnut, heartleaf hornbeam, Sawara cypress, pasania, Japanese bird cherry, Jelutong, Chinese red ash, sycamore, schizomeria, rosewood, hornbeam, Japanese linden, macassar ebony, jongkong, Chinese evergreen oak, Japanese white birch, Jindai zelkova, Jindai ash, and Jindai oak can be used.

Alternatively, Japanese ash, Japanese red oak, agathis, Japanese red pine, Akita cedar, asada (Japanese hop hornbeam), assamela, Korean mountain ash, hiba arborvitae, aspen, anigre, apa, apitong, African mahogany, amoora, ayous, alder, yellow birch, yellow hardwood, yellow pine, yellow poplar, Isu tree, yellow-paint maple, Japanese yew, red-bark oak, ginkgo, ipe, iroko, willow, wenge, water gum, walnut, Japanese apricot tree, ulin, lacquer tree, and Ekop can be used.

Alternatively, Fuzhou cedar, Japanese beech, bubinga, black ash, plane tree, planchonella, western red cedar, hemlock, port orford cedar, yellow cedar, Douglas fir, Taiwan cypress, Korean pine, beli, pericopsis, perupok, pencil cedar, magnolia, bocote, bosse, podocarpus, poplar, hopea, black oak, white ash, white wenge, Norway spruce, white oak, white spruce, white lauan, white pine, white limba, Honduras mahogany, ponderosa pine, monarch birch, yew plum pine, makore, marupa, mango, mansonia, wedding cake tree, Japanese cherry birch, muku tree, Indian soapberry, mutenye, Mejiro-kaba (monarch birch with large proportion of heartwood), metasequoia, melapi, merkusii pine, mersawa, merbau, mengkulang, mempisang, moabi, movingui, fir, Japanese maple, monky pod, Yakusugi (Japanese cedar), willow, Yanagisugi (Japanese cedar), Yanasesugi (Japanese cedar), Japanese cherry, Japanese pear, Japanese aspen, and tulip tree can be used.

Further, Jindai elm, cedar, spruce, cedro, zebrano, selangan batu, castor aralia, Japanese bead tree, sono keling, soft maple, terminalia, Taiwan cypress, taukkyan, taun, bombay black wood, Japanese bay tree, ash, Japanese angelica tree, teak, cherry, silky ash, Tibetan cypress, champaka, southern Japanese hemlock, camellia, tea tree, doussie, red horse-chestnut, todo fir, Japanese ash (Fraxinus japonica Blume), durian, Chinese cassia, nyatoh, New Guinea walnut, New guinea basswood, Japanese elm, Japanese thuja, Persian silk tree, noble fir, burckella, birdseye maple, hard maple, purpleheart, pao rosa, basswood, wax tree, butternut, hackberry, goat willow, Padoauk, Masson's pine, black locust, balsam tree, Japanese alder, PC maple, beech, bigleaf maple, hickory, Japanese cypress, hiba, five-needle pine, bilinga, pyinkado, and falcata can be used.

Further, European ash, European oak, European cherry, European fir, European maple, Yoshino cedar (Japanese cedar), yon, Laotian fir, Laotian cypress, radiata pine, rubber wood, dibetou, lauan, lignum vitae, Faber's fir, lacewood, redwood, red oak, red gum, red lauan, red pine, red meranti, and rose wood can be used.

As the plywood, any one of a natural wood decorative plate, a low-pressure melamine decorative plate, a veneer decorative plate, an olefin decorative plate, a polyester decorative plate, a printed decorative plate, and a DAP decorative plate having different forms such as different decorative surface patterns, designs, colors (tones), textures, gloss, and thickness dimensions is used. The plywood includes various types of plywood currently used, as well as any type (aspect) to be developed in the future. The plywood has a thickness dimension in a range of 10 mm to 200 mm.

As the wood-based siding material, various wood-based siding materials having different forms such as different decorative surface patterns, designs, colors (tones), textures, gloss, and thickness dimensions are used. The wood-based siding includes any type (aspect) of wood-based siding to be developed in the future in addition to those currently used. The wood-based siding material has a thickness dimension in a range of 15 mm to 30 mm. The CLT (cross laminated timber) includes various types currently used, as well as any type (aspect) of CLT to be developed in the future. The CLT has a thickness dimension in a range of 30 mm to 350 mm. The oriented strand board (OSB plywood) includes various oriented strand boards currently used, as well as any type (aspect) of oriented strand board to be developed in the future. The oriented strand board has a thickness dimension in a range of 10 mm to 50 mm.

As the wood cement board, either a wood wool cement board or a wood piece cement board is used. The wood cement board include various types currently used, as well as any type (aspect) of wood cement board to be developed in the future. The wood cement board has a thickness dimension in a range of 10 mm to 150 mm. As the particle board, any one of a base particle board, a single-plate particle board, and a decorative particle board is used. The particle board include various types (aspects) currently used, as well as any type to developed in the future. The particle board has a thickness dimension in a range of 5 mm to 50 mm. As the MDF board, any one of a base MDF board, a decorative MDF board, and a structural MDF board is used. The MDF board includes various types of plywood currently used, as well as any type (aspect) to be developed in the future. The MDF board has a thickness dimension in a range of 5 mm to 50 mm.

At the first side edge portion 11 (one side edge portion) of the composite deck plate 10A, the first side edge portion 33 (first side area 39) of the wood-based plate 16 extends outward in the width direction from the first side edge portion 23 of the metal base 17 of the reinforced deck plate 15, and the upper surface 37 of the first side edge portion 33 (first side area 42) of the wood-based plate 16 (the wood, plywood, wood-based siding, CLT, oriented strand board (OSB plywood), wood cement board, particle board, or MDF board) is exposed.

At the second side edge portion 12 (the other side edge portion) of the composite deck plate 10A, the second side edge portion 34 (second side area 40) of the wood-based plate 16 extends outward in the width direction from the second side edge portion 21 of the metal base 17 of the reinforced deck plate 15, and the upper surface 37 of the second side edge portion 34 (second side area 43) of the wood-based plate 16 (the wood, plywood, wood-based siding, CLT, oriented strand board (OSB plywood), wood cement board, particle board, or MDF board) is exposed. A center area 41 positioned between the first and second side edge portions 33 and 34 (the first and second side areas 42 and 43) of the wood-based plate 16 is positioned on the lower surface 25 of the metal base 17.

In the composite deck plate 10A, the substantially flat lower surface 25 (facing surface) of the metal base 17 of the reinforced deck plate 15 and the substantially flat upper surface 37 (facing surface) of the wood-based plate 16 (the wood, plywood, wood-based siding, CLT, oriented strand board (OSB plywood), wood cement board, particle board, or MDF board) overlap (are in contact with) each other, and as illustrated in FIGS. 1 to 4, the metal base 17 and the center area 44 of the wood-based plate 16 are connected and fixed by a plurality of staples 42 (industrial staples) (fixing means) arranged at equal intervals in the length direction. The staples 42 may be spaced apart from each other at different intervals in the length direction.

The staple 42 includes a shoulder portion 43 having a predetermined shoulder width (outer width) and a pair of leg portions 44 having a predetermined leg length (foot length). The staple 42 has a shoulder width (outer width) of the shoulder portion 43 in a range of 4 mm to 50 mm, and a leg length (foot length) of the leg portion 44 in a range of 5 mm to 200 mm. The shoulder width (outer width) and leg length (foot length) of the staple 42 are appropriately selected according to the sizes and thickness dimensions of the metal base 17 and the wood-based plate 16, a bonding strength required for connecting the metal base 17 and the wood-based plate 16, and the like. Staples with an adhesive are used as the staples 42. The adhesive (not illustrated) is applied to the entire shoulder portion 43 and the entire leg portions 44 of the staple 42, the entire leg portions 44 of the staple 42, or the lower half of the leg portions 44 of the staple 42.

The staples 42 are positioned at the first side edge portion 23 and the second side edge portion 24 of the metal base 17, and are intermittently arranged at predetermined intervals (at equal intervals) in the length direction at the first side edge portion 23 and the second side edge portion 24 of the metal base 17 in a state where the shoulder portions 43 extend in the width direction. The staples 42 are applied from the upper surface 37 of the wood-based plate 16 into the wood-based plate 16 while the leg portions 44 penetrate through the metal base 17.

The staples 42 are applied in the thickness direction of the wood-based plate 16 from the upper surface 18 of the metal base 17 by a gun tacker. When the staple 42 is applied into the wood-based plate 16, the leg portions 44 of the staple 42 connect the metal base 17 and the wood-based plate 16, and the adhesive applied to the entire shoulder portion 43 and the entire leg portions 44 of the staple 42, the entire leg portions 44 of the staple 42, or the lower half of the leg portions 44 of the staple 42 firmly adheres the staple 42 and the wood-based plate 16. An application depth of the leg portions 44 of the staple 42 from the upper surface 37 of the wood-based plate 16 into the wood-based plate 16 is a depth of at least 50% or more and less than 98% of the thickness dimension of the wood-based plate 16.

As means for fixing the composite deck plate 10A (including the composite deck plates 10B to 10M), an adhesive can be used together with the staples 42 with an adhesive, or at least one of an adhesive, a nail, a bolt, or a rivet can be used in addition to the staples 42 with an adhesive. In a case of using an adhesive as the fixing means, the adhesive is applied to the entire lower surface 25 of the metal base 17 of the reinforced deck plate 15. The lower surface 25 of the metal base 17 of the reinforced deck plate 15 and the upper surface 37 of the wood-based plate 16 are firmly bonded by the adhesive (and the staples 42 with an adhesive). The metal base 17 and the wood-based plate 16 may be fixed (bonded) only by an adhesive, the metal base 17 and the wood-based plate 16 may be fixed (connected) only by a nail, a bolt, or a rivet, or the metal base 17 and the wood-based plate 16 may be fixed (connected) by an adhesive, a nail, an adhesive, a bolt, an adhesive, or a rivet.

As an example of constructing a ceiling slab of a reinforced steel structure building, a reinforced concrete structure building, or a reinforced steel-concrete structure building by using the composite deck plate 10A (including the composite deck plates 10B to 10M), a plurality of composite deck plates 10A are arranged in the width direction, and the first side edge portions 11 and the second side edge portions 12 of the deck plates 10A are connected by predetermined connecting means to form an assembly (ceiling surface) of the deck plates 10A. Next, a first end edge portion of the assembly of the connected composite deck plates 10A is coupled to one beam (a flange of an H beam) by using predetermined connecting means, a second end edge portion of the assembly of the connected composite deck plates 10A is coupled to the other beam (a flange of an H beam) by using predetermined connecting means, so that the assembly of the composite deck plates 10A is arranged and fixed between width beams (not illustrated) of the reinforced steel structure building, the reinforced concrete structure building, or the reinforced steel-concrete structure building. The first side edge portions 11 and the second side edge portions 12 of the deck plates 10A may be connected by predetermined connecting means while sequentially arranging and fixing the plurality of composite deck plates 10A between the width beams, so that the plurality of composite deck plates 10A may be arranged and fixed between the width beams.

After the assembly of the composite deck plates 10A (the assemblies of the composite deck plates 10B to 10M) is fixed between the width beams of the building, a formwork (not illustrated) is assembled around the assembly of the deck plates 10A, concrete (not illustrated) is cast in the formwork from above the reinforcing bar truss unit 19 (reinforcing structure) toward the upper surface 18 of the metal base 17 with a predetermined covering dimension, and the concrete is cured for a predetermined period. When the concrete is cast on the composite deck plate 10A (the reinforced deck plate 15), the metal base 17 and the reinforcing bar truss unit 19 (the reinforcing structure) are buried in the concrete. After the concrete curing period has elapsed, the ceiling slab is completed by removing the formwork.

In the composite deck plate 10A (ceiling slab), while the wood-based plate 16 conceals the entire lower surface 25 of the metal base 17, the lower surface 38 (decorative surface) of the wood-based plate 16 (the wood, plywood, wood-based siding, CLT, oriented strand board (OSB plywood), wood cement board, particle board, or MDF board) is exposed downward from the ceiling of the building (inside the building) to form the ceiling surface.

In the composite deck plate 10A, the wood-based plate 16 is fixed to the lower surface 25 of the metal base 17 of the reinforced deck plate 15 by the plurality of staples 42 (predetermined fixing means), and the wood-based plate 16 (the wood, plywood, wood-based siding, CLT, oriented strand board (OSB plywood), wood cement board, particle board, or MDF board) is exposed on a lower side of the composite deck plate 10A to form the ceiling surface of the building. Therefore, an appealing design of the wood-based plate 16 can be incorporated into the ceiling surface, so that an attractive ceiling surface can be formed, and a ceiling surface that provides a viewer with aesthetic appeal, comfort, warmth, and tranquility offered by the wood-based plate 16 which is a natural material can be formed.

In the composite deck plate 10A, the wood-based plate 16 is fixed to the lower surface 25 of the metal base 17 of the reinforced deck plate 15 to form the ceiling surface. Therefore, it is possible to construct a ceiling slab without attaching a ceiling finishing material such as decorative plywood, a gypsum board, or an aluminum panel by using a hanging bolt, and it is possible to eliminate ceiling finishing work for separately installing the ceiling finishing material, and it is possible to save labor and cost for the ceiling finishing work. With the composite deck plate 10A, it is not necessary to attach a ceiling finishing material such as decorative plywood, a gypsum board, or an aluminum panel by using a hanging bolt. Therefore, unlike a suspended ceiling structure in which a ceiling finishing material is attached using a hanging bolt, ceiling finishing work can be eliminated, a ceiling slab can be efficiently constructed, there is no risk of falling even when shaking (vibration) occurs due to an earthquake or the like, and a ceiling slab capable of preventing occurrence of a ceiling fall accident can be constructed.

For the composite deck plate 10A, the wood-based plate 16, which is a sustainable circulation-type resource, is used, forest resources can be effectively used, so that the environmental load can be reduced by contributing to reduction of CO². An essential oil component of the wood or CLT as the wood-based plate 16 has an effect of suppressing mold Infestation and propagation of pathogenic bacteria, and the mold Infestation and the propagation of pathogenic bacteria on the ceiling can be suppressed by using the wood or CLT as the wood-based plate 16 for the ceiling surface. In addition, the wood or CLT as the wood-based plate 16 has a humidity control action of absorbing moisture when the humidity in the air is high and releasing moisture when the humidity is low, and the humidity is controlled on the ceiling by using the wood or CLT as the wood-based plate 16 for the ceiling surface, so that the humidity in the room is controlled. Further, the wood or CLT as the wood-based plate 16 has an effect of appropriately absorbing high, medium, and low sounds in a well-balanced manner and making sound quality moderate, and thus, it is possible to soften indoor sound by using the wood or CLT as the wood-based plate 16 for the ceiling surface.

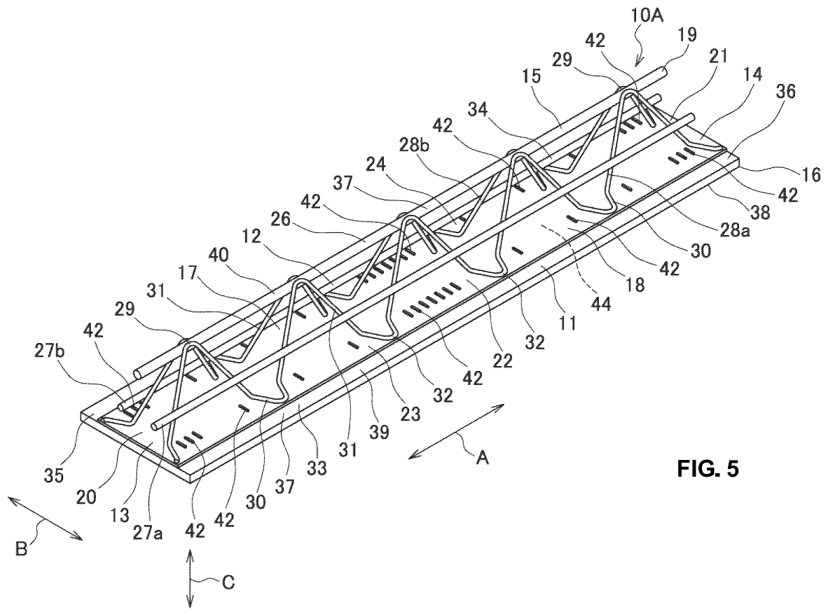

FIG. 5 is a perspective view illustrating another example of the arrangement of the staples 42. In the arrangement of the staples 42 (fixing means) illustrated in the perspective view of FIG. 5, the staples 42 are intermittently arranged at predetermined intervals in the length direction at the first side edge portion 23 and the second side edge portion 24 of the metal base 17 in a state where the shoulder portions 43 of the staples 42 extend in the width direction, the number of applied staples 42 in the periphery of the center of the central portion 22 of the metal base 17 is larger than the number of applied staples 42 in the remaining portion of the central portion 22 excluding the periphery of the center of the metal base 17, and the number of applied staples 42 in the peripheries of end edges of the first and second end edge portions 20 and 21 of the metal base 17 is larger than the number of applied staples 42 in the remaining portions of the first and second end edge portions 20 and 21 excluding the peripheries of the end edges of the metal base 17.

A separation dimension between the staples 42 in the length direction in the periphery of the center of the central portion 22 of the metal base 17 is smaller than a separation dimension between the staples 42 in the length direction in the remaining portion of the central portion 22, and the leg portions 44 are applied from the upper surface 37 of the wood-based plate 16 into the wood-based plate 16 while penetrating through the metal base 17 in a state where the staples 42 having the shoulder portions 43 extending in the width direction are densely arranged.

A separation dimension between the staples 42 in the length direction in the peripheries of the end edges of the first and second end edge portions 20 and 21 of the metal base 17 is smaller than a separation dimension between the staples 42 in the length direction in the remaining portions of the first and second end edge portions 20 and 21, and the leg portions 44 are applied from the upper surface 37 of the wood-based plate 16 into the wood-based plate 16 while penetrating through the metal base 17 in a state where the staples 42 having the shoulder portions 43 extending in the width direction are densely arranged.

In the composite deck plate 10A (including the deck plates 10B to 10J in a case where the staples 42 (fixing means) are applied according to the arrangement illustrated in FIG. 5) in which the metal base 17 and the center area 41 of the wood-based plate 16 are connected and fixed by the staples 42 arranged as illustrated in FIG. 5, the metal base 17 and the wood-based plate 16 are fixed using a large number of staples 42 in which the shoulder portions 43 extend in the width direction in the periphery of the center of the central portion 22 of the metal base 17, and the metal base 17 and the wood-based plate 16 are fixed using a large number of staples 42 in which the shoulder portions 43 extend in the width direction in the peripheries of the end edges of the first and second end edge portions 20 and 21 of the metal base 17, whereby the wood-based plate 16 can be firmly connected to the lower surface 25 in the periphery of the center of the central portion 22 of the metal base 17, and the wood-based plate 16 can be firmly connected to the lower surface 25 in the peripheries of the end edges of the first and second end edge portions 20 and 21 of the metal base 17.

In the composite deck plate 10A (including the deck plates 10B to 10J in a case where the staples 42 (fixing means) are applied according to the arrangement illustrated in FIG. 5) in which the metal base 17 and the center area 41 of the wood-based plate 16 are fixed by the staples 42 (fixing means) arranged as illustrated in FIG. 5, when concrete is cast on an upper surface of the composite deck plate 10A after the composite deck plate 10A is bridged over the beams of the building, even if a load of the concrete acts in such a way that the periphery of the center of the central portion 22 of the metal base 17 is curved downward and the load of the concrete acts in such a way that the peripheries of the end edges of the first and second end edge portions 20 and 21 of the metal base 17 are warped upward, the fixation between the periphery of the center of the central portion 22 of the metal base 17 and the wood-based plate 16 and the fixation between the peripheries of the end edges of the first and second end edge portions 20 and 21 of the metal base 17 and the wood-based plate 16 are not carelessly released, so that it is possible to form a sturdy reinforced concrete ceiling slab formed using the reinforced deck plate 15 and the wood-based plate 16, and to form a sturdy ceiling surface that provides a viewer with aesthetic appeal, comfort, warmth, and tranquility offered by the wood-based plate 16 which is a natural material.

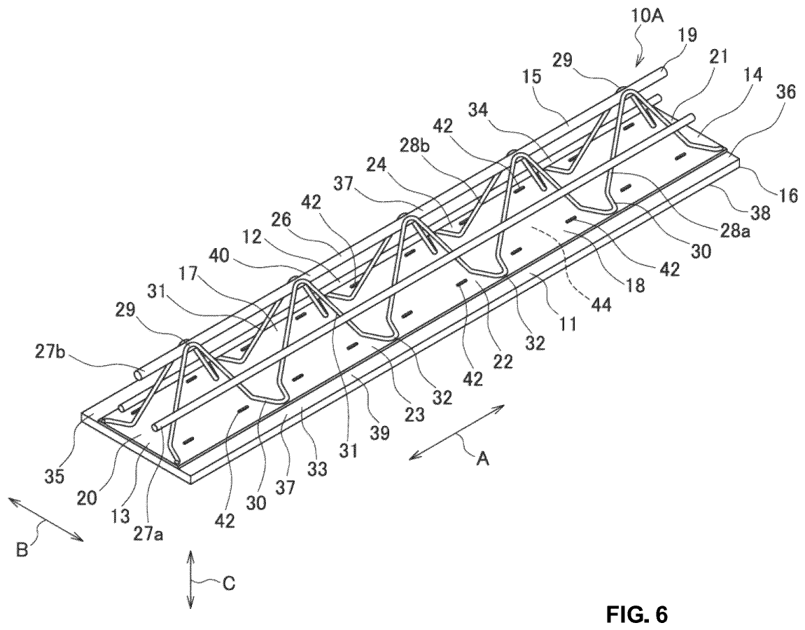

FIG. 6 is a perspective view illustrating another example of the arrangement of the staples 42. In the arrangement of the staples 42 (fixing means) illustrated in the perspective view of FIG. 6, the staples 42 are positioned at the first side edge portion 23 and the second side edge portion 24 of the metal base 17, and are intermittently arranged at predetermined intervals in the length direction at the first side edge portion 23 and the second side edge portion 24 of the metal base 17 in a state where the shoulder portions 43 extend in the length direction. The staples 42 having the shoulder portions 43 extending in the length direction are applied from the upper surface 37 of the wood-based plate 16 into the wood-based plate 16 while the leg portions 44 penetrate through the metal base 17. When the staple 42 is applied into the wood-based plate 16, the leg portions 41 of the staple 42 connect the metal base 17 and the wood-based plate 16, and the adhesive applied to the entire shoulder portion 43 and the entire leg portions 44 of the staple 42, the entire leg portions 44 of the staple 42, or the lower half of the leg portions 44 of the staple 42 firmly adheres the staple 39 and the wood-based plate 16.

In the composite deck plate 10A (including the deck plates 10B to 10M in a case where the staples 42 (fixing means) are applied according to the arrangement illustrated in FIG. 6) in which the metal base 17 and the center area 41 of the wood-based plate 16 are connected and fixed by the staples 42 (fixing means) arranged as illustrated in FIG. 6, the wood-based plate 16 is fixed to the lower surface 25 of the first and second side edge portions 23 and 24 of the metal base 17 by the staples 42 intermittently arranged at predetermined intervals in the length direction at the first side edge portion 23 and the second side edge portion 24 of the metal base 17 in a state where the shoulder portions 43 extend in the length direction, so that the wood-based plate 16 can be reliably fixed to the lower surface 25 of the metal base 17, and it is possible to form an attractive ceiling surface with an appealing design by using the wood-based plate 16 fixed to the lower surface 25 of the metal base 17 by the staples 42 and to form a ceiling surface that provides a viewer with aesthetic appeal, comfort, warmth, and tranquility offered by the wood-based plate 16 which is a natural material.

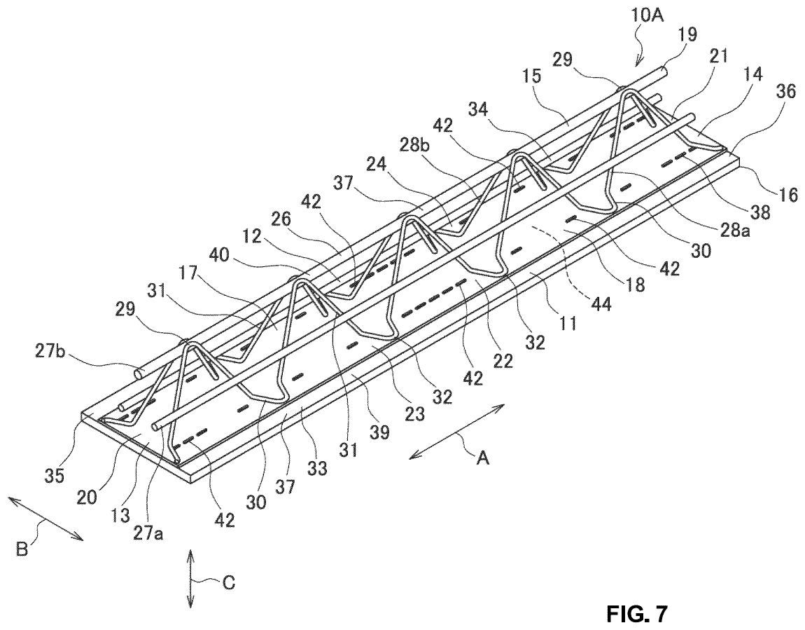

FIG. 7 is a perspective view illustrating another example of the arrangement of the staples 39. In the arrangement of the staples 42 (fixing means) illustrated in the perspective view of FIG. 7, the staples 42 are intermittently arranged at predetermined intervals in the length direction at the first side edge portion 23 and the second side edge portion 24 of the metal base 17 in a state where the shoulder portions 43 of the staples 42 extend in the length direction, the number of applied staples 42 in the periphery of the center of the central portion 22 of the metal base 17 is larger than the number of applied staples 42 in the remaining portion of the central portion 22 excluding the periphery of the center of the metal base 17, and the number of applied staples 42 in the peripheries of end edges of the first and second end edge portions 20 and 21 of the metal base 17 is larger than the number of applied staples 42 in the remaining portions of the first and second end edge portions 20 and 21 excluding the peripheries of the end edges of the metal base 17.

A separation dimension between the staples 42 in the length direction in the periphery of the center of the central portion 22 of the metal base 17 is smaller than a separation dimension between the staples 42 in the length direction in the remaining portion of the central portion 22, and the leg portions 44 are applied from the upper surface 37 of the wood-based plate 16 into the wood-based plate 16 while penetrating through the metal base 17 in a state where the staples 42 having the shoulder portions 43 extending in the length direction are densely arranged.

A separation dimension between the staples 42 in the length direction in the peripheries of the end edges of the first and second end edge portions 20 and 21 of the metal base 17 is smaller than a separation dimension between the staples 42 in the length direction in the remaining portions of the first and second end edge portions 20 and 21, and the leg portions 44 are applied from the upper surface 37 of the wood-based plate 16 into the wood-based plate 16 while penetrating through the metal base 17 in a state where the staples 42 having the shoulder portions 43 extending in the length direction are densely arranged.

In the composite deck plate 10A (including the deck plates 10B to 10J in a case where the staples 42 (fixing means) are applied according to the arrangement illustrated in FIG. 7) in which the metal base 17 and the wood-based plate 16 are connected and fixed by the staples 42 arranged as illustrated in FIG. 7, the metal base 17 and the wood-based plate 16 are fixed using a large number of staples 42 in which the shoulder portions 43 extend in the length direction in the periphery of the center of the central portion 22 of the metal base 17, and the metal base 17 and the wood-based plate 16 are fixed using a large number of staples 42 in which the shoulder portions 43 extend in the length direction in the peripheries of the end edges of the first and second end edge portions 20 and 21 of the metal base 17, whereby the wood-based plate 16 can be firmly connected to the lower surface 25 in the periphery of the center of the central portion 22 of the metal base 17, and the wood-based plate 16 can be firmly connected to the lower surface 25 in the peripheries of the end edges of the first and second end edge portions 20 and 21 of the metal base 17.

In the composite deck plate 10A (including the deck plates 10B to 10M in a case where the staples 42 (fixing means) are applied according to the arrangement illustrated in FIG. 7) in which the metal base 17 and the center area 41 of the wood-based plate 16 are fixed by the staples 42 (fixing means) arranged as illustrated in FIG. 7, when concrete is cast on an upper surface of the composite deck plate 10A after the composite deck plate 10A is bridged over the beams of the building, even if a load of the concrete acts in such a way that the periphery of the center of the central portion 22 of the metal base 17 is curved downward and the load of the concrete acts in such a way that the peripheries of the end edges of the first and second end edge portions 20 and 21 of the metal base 17 are warped upward, the fixation between the periphery of the center of the central portion 22 of the metal base 17 and the wood-based plate 16 and the fixation between the peripheries of the end edges of the first and second end edge portions 20 and 21 of the metal base 17 and the wood-based plate 16 are not carelessly released, so that it is possible to form a sturdy reinforced concrete ceiling slab formed using the reinforced deck plate 15 and the wood-based plate 16, and to form a sturdy ceiling surface that provides a viewer with aesthetic appeal, comfort, warmth, and tranquility offered by the wood-based plate 16 which is a natural material.

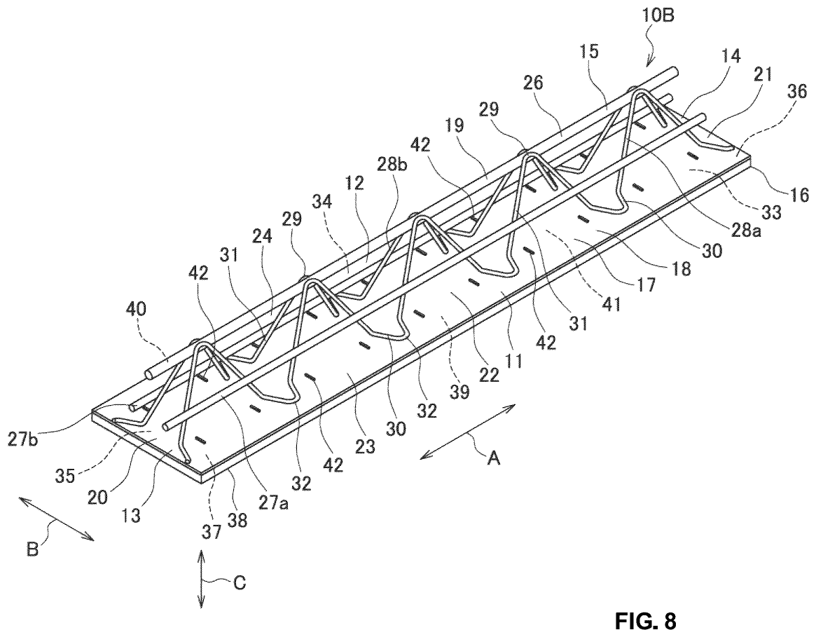

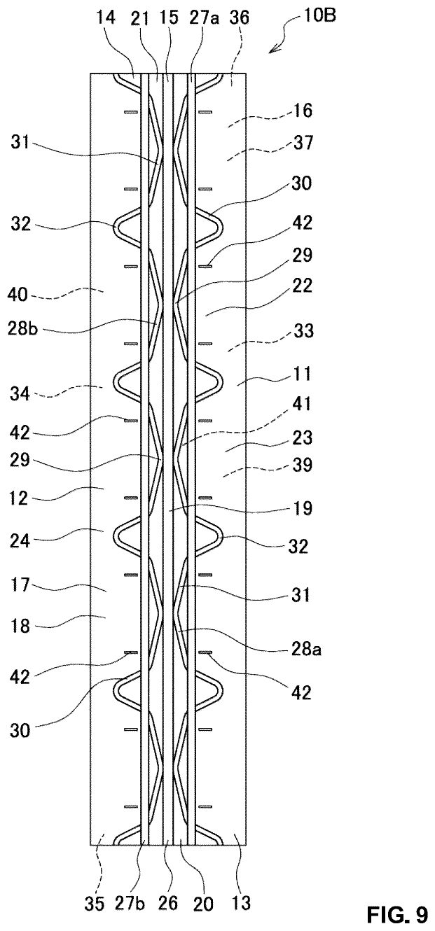

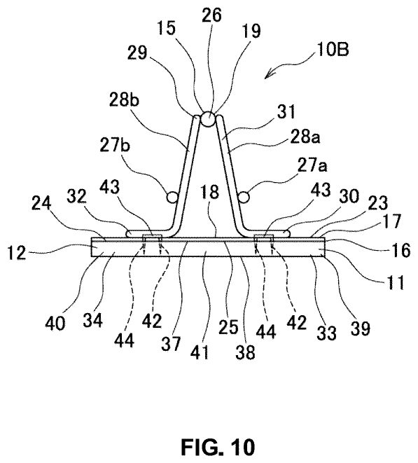

FIG. 8 is a perspective view of the composite deck plate 10B illustrated as another example, and FIG. 9 is a top view of the composite deck plate 10B of FIG. 8. FIG. 10 is a front view of the composite deck plate 10B of FIG. 8. In FIG. 8, a length direction is indicated by an arrow A, a width direction is indicated by an arrow B, and a vertical direction (thickness direction) is indicated by an arrow C.

The composite deck plate 10B illustrated in FIGS. 8 to 10 is different from that illustrated in FIGS. 1 to 4 in that a first side edge portion 33 (first side area 39) of a wood-based plate 16 is positioned on a lower surface of a first side edge portion 23 of a metal base 17 of a reinforced deck plate 15, a first side edge portion 23 of the metal base 17 and the first side edge portion 33 (first side area 39) of the wood-based plate 16 overlap each other, a second side edge portion 34 (second side area 40) of the wood-based plate 16 is positioned on a lower surface of a second side edge portion 24 of the metal base 17 of the reinforced deck plate 15, and a second side edge portion 24 of the metal base 17 and the second side edge portion 34 (second side area 40) of the wood-based plate 16 overlap each other. Since other configurations of the composite deck plate 10B are the same as those of the composite deck plate 10A of FIGS. 1 to 4, a description of the composite deck plate 10A of FIGS. 1 to 4 is cited, and the same reference signs as those in FIGS. 1 to 4 are given. Therefore, a detailed description of the composite deck plate 10B will be omitted.

The composite deck plate 10B has first and second side edge portions 11 and 12 (both side edge portions) that face each other while being separated from each other in the width direction and extend in the length direction, and first and second end edge portions 13 and 14 (both end edge portions) that face each other while being separated from each other in the length direction and extend in the width direction. The composite deck plate 10B includes the reinforced deck plate 15 having a predetermined area and extending in the length direction, and the wood-based plate 16 having a predetermined area and extending in the length direction. The wood-based plate 16 is the same as that of the composite deck plate 10A, and any one of wood having a predetermined area, plywood having a predetermined area, a wood-based siding material having a predetermined area, a cross laminated timber (CLT) having a predetermined area, an oriented strand board (OSB plywood) having a predetermined area, a wood cement board having a predetermined area, a particle board having a predetermined area, or a medium density fiber (MDF) board having a predetermined area is used in the description of the composite deck plate 10A.

In the composite deck plate 10B, the first side edge portion 23 of the metal base 17 of the reinforced deck plate 15 and the first side edge portion 33 (first side area 39) of the wood-based plate 16 overlap each other in the thickness direction in a state where a side edge of the first side edge portion 23 of the metal base 17 of the reinforced deck plate 15 and a side edge of the first side edge portion 33 (first side area 39) of the wood-based plate 16 coincide with each other. Further, the second side edge portion 24 of the metal base 17 of the reinforced deck plate 15 and the second side edge portion 34 (second side area 40) of the wood-based plate 16 overlap each other in the thickness direction in a state where a side edge of the second side edge portion 24 of the metal base 17 of the reinforced deck plate 15 and a side edge of the second side edge portion 34 (second side area 40) of the wood-based plate 16 coincide with each other.

In the composite deck plate 10B, a substantially flat lower surface 25 (facing surface) of the metal base 17 of the reinforced deck plate 15 and a substantially flat upper surface 37 (facing surface) of the wood-based plate 16 overlap (are in contact with) each other, and the wood-based plate 16 is connected and fixed to the lower surface 25 of the first side edge portion 23 and the second side edge portion 24 of the metal base 17 of the reinforced deck plate 15 by a plurality of staples 42 arranged at equal intervals in the length direction in a state where shoulder portions 43 extend in the width direction. When the staple 42 is applied into the wood-based plate 16, the leg portions 44 of the staple 42 connect the metal base 17 and the wood-based plate 16, and the adhesive applied to the entire shoulder portion 43 and the entire leg portions 44 of the staple 42, the entire leg portions 44 of the staple 42, or the lower half of the leg portions 44 of the staple 42 firmly adheres the staple 42 and the wood-based plate 16.

The composite deck plate 10B has the same effect as that of the composite deck plate 10A illustrated in FIGS. 1 to 4. In the composite deck plate 10B (including the composite deck plate 10C), the metal base 17 and the wood-based plate 16 may be connected and fixed by the staples 42 (fixing means) arranged as illustrated in FIG. 5, the metal base 17 and the wood-based plate 16 may be connected and fixed by the staples 42 (fixing means) arranged as illustrated in FIG. 6, or the metal base 17 and the wood-based plate 16 may be connected and fixed by the staples 42 (fixing means) arranged as illustrated in FIG. 7.

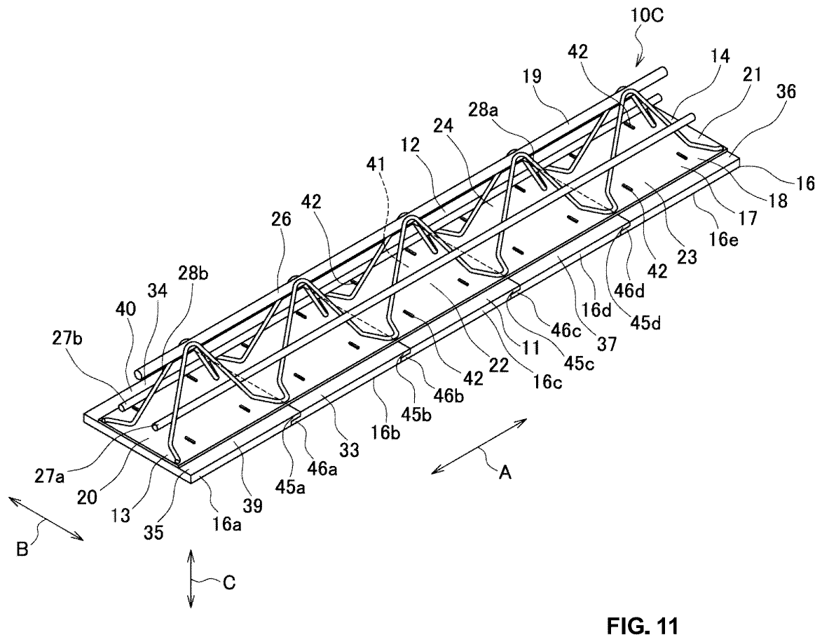

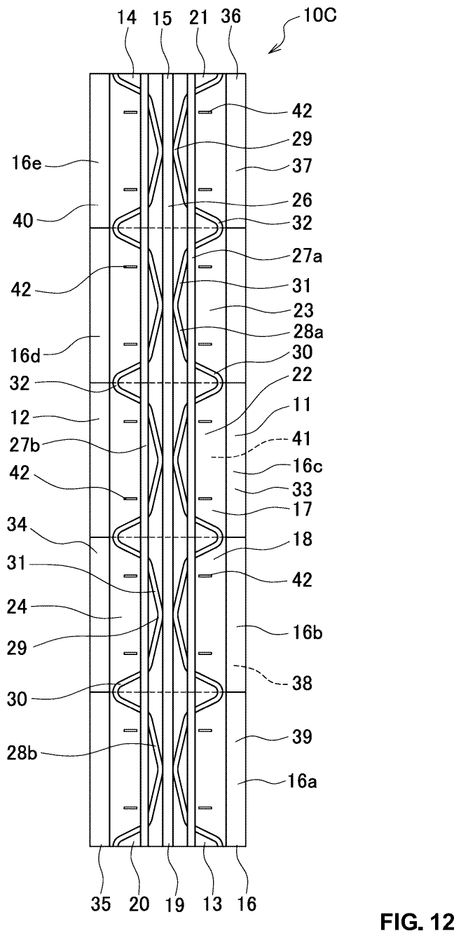

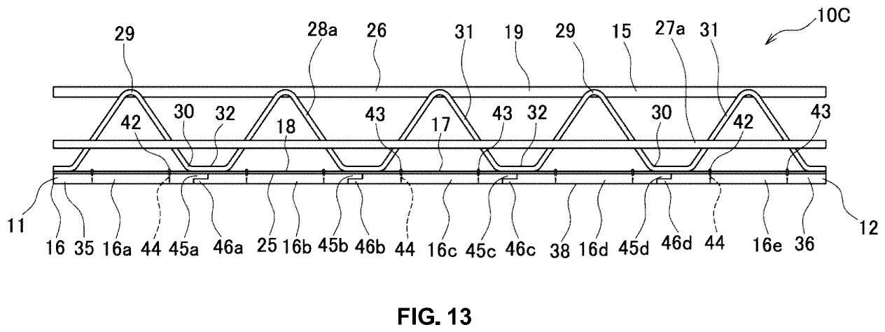

FIG. 11 is a perspective view of the composite deck plate 10C illustrated as another example, and FIG. 12 is a top view of the composite deck plate 10C of FIG. 11. FIG. 13 is a side view of the composite deck plate 10C of FIG. 11. In FIG. 11, a length direction is indicated by an arrow A, a width direction is indicated by an arrow B, and a vertical direction (thickness direction) is indicated by an arrow C.

The composite deck plate 10C illustrated in FIGS. 11 to 13 is different from the composite deck plate illustrated in FIGS. 1 to 4 in that a wood-based plate 16 includes first to fifth wood-based plates 16a to 16e. Since other configurations of the composite deck plate 10C are the same as those of the composite deck plate 10A of FIGS. 1 to 4, the description of the composite deck plate 10A in FIGS. 1 to 4 is cited, and the same reference signs as those in FIGS. 1 to 4 are given. Therefore, a detailed description of the composite deck plate 10B will be omitted.

The composite deck plate 10C has first and second side edge portions 11 and 12 (both side edge portions) that face each other while being separated from each other in the width direction and extend in the length direction, and first and second end edge portions 13 and 14 (both end edge portions) that face each other while being separated from each other in the length direction and extend in the width direction. The composite deck plate 10C includes a reinforced deck plate 15 having a predetermined area and extending in the length direction, and the first to fifth wood-based plates 16a to 16e having a predetermined area and extending in the width direction.

The number of wood-based plates 16 is not limited, and two wood-based plates 16 including the first and second wood-based plates 16a and 16b, three wood-based plates 16 including the first to third wood-based plates 16a to 16c, or four wood-based plates 16 including the first to fourth wood-based plates 16a to 16d extending in the width direction may be used to form the composite deck plate 10C, or six or more wood-based plates 16 including first to n-th wood-based plates 16a to 16n extending in the width direction may be used to form the composite deck plate 10C.

The first to fifth wood-based plates 16a to 16e have first and second side edge portions 33 and 34 (both side edge portions) that face each other while being spaced apart from each other in the length direction and extend in the width direction, and first and second end edge portions 35 and 36 (both end edge portions) that face each other while being spaced apart from each other in the width direction and extend in the length direction, and have substantially flat upper surfaces 37 and substantially flat lower surfaces 38. The first to fifth wood-based plates 16a to 16e are formed into rectangles extending in the width direction, have the same size and the same shape of which a dimension in the length direction and a dimension in the width direction are the same, and are arranged in the length direction in parallel with each other.

As the first to fifth wood-based plates 16a to 16e, any one of wood having a predetermined area, plywood having a predetermined area, a wood-based siding material having a predetermined area, a cross laminated timber (CLT) having a predetermined area, an oriented strand board (OSB plywood) having a predetermined area, a wood cement board having a predetermined area, a particle board having a predetermined area, or a medium density fiber (MDF) board having a predetermined area described above in the description of the composite deck plate 10A is used.

A first upper joint 45a extending in the width direction is formed at the second side edge portion 34 of the first wood-based plate 16a. The first upper joint 45a is formed by cutting off (on-site processing or pre-cutting) a part (approximately half) of second side edge portion 34 of the plate 16a from the lower surface 38 toward the upper surface 37 of the first wood-based plate 16a. A first lower joint 46a extending in the width direction is formed at the first side edge portion 33 of the second wood-based plate 16b. The first lower joint 46a is formed by cutting off (on-site processing or pre-cutting) a part (substantially half) of the first side edge portion 33 of the plate 16b from the upper surface 37 toward the lower surface 38 of the second wood-based plate 16b.

A second upper joint 45b extending in the width direction is formed at the second side edge portion 34 of the second wood-based plate 16b. The second upper joint 45b is formed by cutting off (on-site processing or pre-cutting) a part (substantially half) of the second side edge portion 34 of the plate 16b from the lower surface 38 toward the upper surface 37 of the second wood-based plate 16b. A second lower joint 46b extending in the width direction is formed at the first side edge portion 33 of the third wood-based plate 16c. The second lower joint 46b is formed by cutting off (on-site processing or pre-cutting) a part (substantially half) of the first side edge portion 33 of the plate 16c from the upper surface 37 toward the lower surface 38 of the third wood-based plate 16c.

A third upper joint 45c extending in the width direction is formed at the second side edge portion 34 of the third wood-based plate 16c. The third upper joint 45c is formed by cutting off (on-site processing or pre-cutting) a part (approximately half) of second side edge portion 34 of plate 16c from the lower surface 38 toward the upper surface 37 of the third wood-based plate 16c. A third lower joint 46c extending in the width direction is formed at the first side edge portion 33 of the fourth wood-based plate 16d. The third lower joint 46c is formed by cutting off (on-site processing or pre-cutting) a part (substantially half) of the first side edge portion 33 of the plate 16d from the upper surface 37 toward the lower surface 38 of the fourth wood-based plate 16d.

A fourth upper joint 45d extending in the width direction is formed at the second side edge portion 34 of the fourth wood-based plate 16d. The fourth upper joint 45d is formed by cutting off (on-site processing or pre-cutting) a part (approximately half) of the second side edge portion 34 of the plate 16d from the lower surface 38 toward the upper surface 37 of the fourth wood-based plate 16d. A fourth lower joint 46d extending in the width direction is formed at the first side edge portion 33 of the fifth wood-based plate 16e. The fourth lower joint 46d is formed by cutting off (on-site processing or pre-cutting) a part (approximately half) of the first side edge portion 33 of the plate 16e from the upper surface 37 toward the lower surface 38 of the fifth wood-based plate 16e.

The second wood-based plate 16b is positioned on a rear side of the first wood-based plate 16a in the length direction, the third wood-based plate 16c is positioned on a rear side of the second wood-based plate 16b in the length direction, the fourth wood-based plate 16d is positioned on a rear side of the third wood-based plate 16c in the length direction, and the fifth wood-based plate 16e is positioned on a rear side of the fourth wood-based plate 16d in the length direction. In the first to fifth wood-based plates 16a to 16e, the first lower joint 46a of the second wood-based plate 16b is positioned immediately under the first upper joint 45a of the first wood-based plate 16a, and the joints 45a and 46a are bonded and connected to each other by an adhesive (predetermined fixing means) in a state where the first upper joint 45a of the first wood-based plate 16a and the first lower joint 46a of the second wood-based plate 16b overlap each other in the vertical direction. The second lower joint 46b of the third wood-based plate 16c is positioned immediately under the second upper joint 45b of the second wood-based plate 16b, and the joints 45b and 46b are bonded and connected to each other by an adhesive (predetermined fixing means) in a state where the second upper joint 45b of the second wood-based plate 16b and the second lower joint 46b of the third wood-based plate 16c overlap each other in the vertical direction.

The third lower joint 46c of the fourth wood-based plate 16d is positioned immediately under the third upper joint 45c of the third wood-based plate 16c, and the joints 45c and 46c are bonded and connected to each other by an adhesive (predetermined fixing means) in a state where the third upper joint 45c of the third wood-based plate 16c and the third lower joint 46c of the fourth wood-based plate 16d overlap each other in the vertical direction. The fourth lower joint 46d of the fifth wood-based plate 16e is positioned immediately below the fourth upper joint 45d of the fourth wood-based plate 16d, and the joints 45d and 46d are bonded and connected to each other by an adhesive (predetermined fixing means) in a state where the fourth upper joint 45d of the fourth wood-based plate 16d and the fourth lower joint 46d of the fifth wood-based plate 16e overlap each other in the vertical direction. The joints 45a to 45d and 46a to 46d may be connected and fixed to each other by staples 39, nails, clamps, fixing bolts, or rivets (fixing means).

In the composite deck plate 10C, the reinforced deck plate 15 extending in the length direction is disposed on the first to fifth wood-based plates 16a to 16e extending in the width direction. At the first side edge portion 11 (one side edge portion) of the composite deck plate 10C, the first end edge portions 35 (first side areas 39) of the first to fifth wood-based plates 16a to 16e extend outward in the width direction from a first side edge portion 23 of a metal base 17 of the reinforced deck plate 15, and the upper surfaces 37 of the first end edge portions 35 (first side areas 39) of the first to fifth wood-based plates 16a to 16e are exposed. At the second side edge portion 12 (the other side edge portion) of the composite deck plate 10C, the second end edge portions 36 (second side areas 40) of the first to fifth wood-based plates 16a to 16e extend outward in the width direction from a second side edge portion 24 of the metal base 17 of the reinforced deck plate 15, and the upper surfaces 37 of the second end edge portions 36 (second side areas 40) of the first to fifth wood-based plates 16a to 16e are exposed.

In the composite deck plate 10C, the first side edge portion 23 of the metal base 17 of the reinforced deck plate 15 and the first end edge portions 35 (first side areas 39) of the first to fifth wood-based plates 16a to 16e may overlap each other in the thickness direction in a state where a side edge of the first side edge portion 23 of the metal base 17 of the reinforced deck plate 15 and side edges of the first end edge portions 35 (first side areas 39) of the first to fifth wood-based plates 16a to 16e coincide with each other, and the second side edge portion 24 of the metal base 17 of the reinforced deck plate 15 and the second end edge portions 36 (second side areas 40) of the first to fifth wood-based plates 16a to 16e may overlap each other in the thickness direction in a state where a side edge of the second side edge portion 24 of the metal base 17 of the reinforced deck plate 15 and end edges of the second side edge portions 36 (second side areas 40) of the first to fifth wood-based plates 16a to 16e coincide with each other.

In the composite deck plate 10C, a substantially flat lower surface 25 (facing surface) of the metal base 17 of the reinforced deck plate 15 and the substantially flat upper surfaces 37 (facing surface) of the first to fifth wood-based plates 16a to 16e overlap (are in contact with) each other, and the metal base 17 and the first to fifth wood-based plates 16a to 16e are connected and fixed by a plurality of staples 42 (fixing means) arranged at equal intervals in the length direction as illustrated in FIGS. 11 to 13. The staples 42 may be spaced apart from each other at different intervals in the length direction.

The staples 42 are positioned at the first side edge portion 23 and the second side edge portion 24 of the metal base 17 of the reinforced deck plate 15, and are intermittently arranged at predetermined intervals in the length direction at the first side edge portion 23 and the second side edge portion 24 of the metal base 17 in a state where shoulder portions 43 extend in the width direction. The staples 42 are applied from the upper surfaces 37 of the first to fifth wood-based plates 16a to 16e into the first to fifth wood-based plates 16a to 16e while leg portions 44 penetrate through the metal base 17. When the staples 42 are applied into the first to fifth wood-based plates 16a to 16e, the leg portions 44 of the staples 42 connect the metal base 17 and the first to fifth wood-based plates 16a to 16e, and an adhesive applied to the entire shoulder portions 43 and the entire leg portions 44 of the staples 42, the entire leg portions 44 of the staples 42, or the lower half of the leg portions 44 of the staples 42 firmly adheres the staples 42 and the first to fifth wood-based plates 16a to 16e.

In the composite deck plate 10C, the metal base 17 and the first to fifth wood-based plates 16a to 16e may be connected and fixed by the staples 42 (fixing means) arranged as illustrated in FIG. 5, the metal base 17 and the first to fifth wood-based plates 16a to 16e may be connected and fixed by the staples 42 (fixing means) arranged as illustrated in FIG. 6, or the metal base 17 and the first to fifth wood-based plates 16a to 16e may be connected and fixed by the staples 42 (fixing means) arranged as illustrated in FIG. 7.

The composite deck plate 10C has the following effects in addition to the effects of the composite deck plate 10A. In the composite deck plate 10C, the first to fifth wood-based plates 16a to 16e (first to n-th wood-based plates) extending in the width direction are fixed to the lower surface 25 of the metal base 17 of the reinforced deck plate 15 by the plurality of staples 42 (predetermined fixing means), and the first to fifth wood-based plates 16a to 16e are exposed on the lower side of the composite deck plate 10C to form the ceiling surface of the building. Therefore, an appealing design of the first to fifth wood-based plates 16a to 16e extending in the width direction can be incorporated into the ceiling surface, so that a ceiling surface that provides a viewer with aesthetic appeal, comfort, warmth, and tranquility offered by the first to fifth wood-based plates 16a to 16e which are natural materials can be formed. For the composite deck plate 10C, the first to fifth wood-based plates 16a to 16e (first to n-th wood-based plates), which are sustainable circulation-type resources, are used, so that forest resources can be effectively utilized, and the environmental load can be reduced by contributing to reduction of CO².

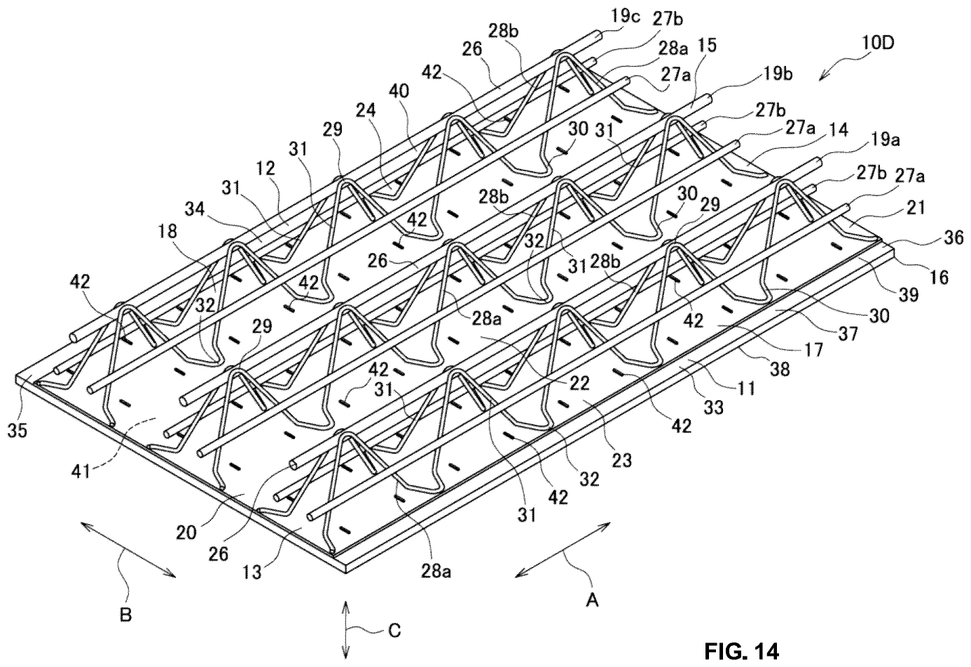

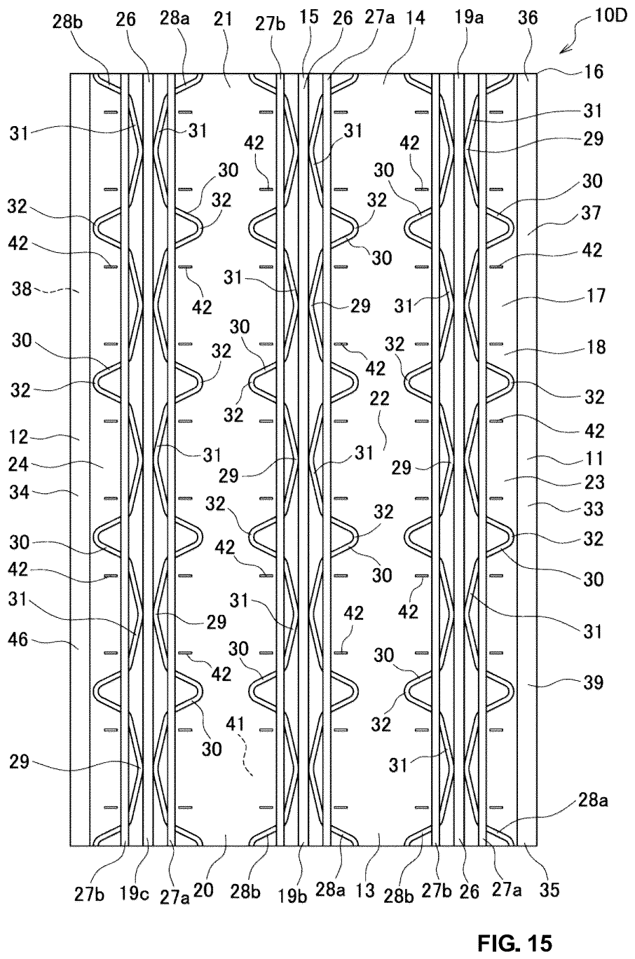

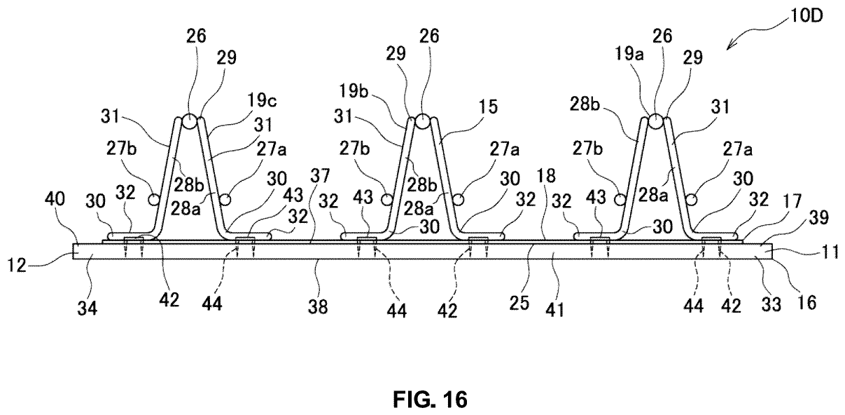

FIG. 14 is a perspective view of the composite deck plate 10D illustrated as another example, and FIG. 15 is a top view of the composite deck plate 10D of FIG. 14. FIG. 16 is a front view of the composite deck plate 10D of FIG. 14. In FIG. 14, a length direction is indicated by an arrow A, a width direction is indicated by an arrow B, and a vertical direction (thickness direction) is indicated by an arrow C.

The composite deck plate 10D has first and second side edge portions 11 and 12 (both side edge portions) that face each other while being spaced apart from each other in the width direction and extend in the length direction, and first and second end edge portions 13 and 14 (both end edge portions) that face each other while being spaced apart from each other in the length direction and extend in the width direction. The composite deck plate 10D includes a reinforced deck plate 15 (a deck plate with a reinforcing bar truss) having a predetermined area and a wood-based plate 16 having a predetermined area.

The reinforced deck plate 15 includes a metal base 17 having a large predetermined area in the length direction and disposed on the wood-based plate 16, and first to third reinforcing bar truss units 19a to 19c (first to n-th reinforcing structures) disposed and fixed (installed) on and to an upper surface 18 of the metal base 17. The number of reinforcing bar truss units 19 (reinforcing structures) is not limited, and the number of reinforcing bar truss units 19 to be installed on the upper surface 18 of the metal base 17 can be freely determined according to a size of a ceiling slab to be constructed, a strength required for the ceiling slab, an amount of reinforcing bars required for the ceiling slab, and the like. Two reinforcing bar truss units including the first and second reinforcing bar truss units 19a and 19b (first and second reinforcing structures) may be disposed and fixed (installed) on and to the upper surface 18 of the metal base 17, or four or more reinforcing bar truss units including the first to n-th reinforcing bar truss units 19a to 19n (first to n-th reinforcing structures) may be disposed and fixed (installed) on and to the upper surface 18 of the metal base 17.

The metal base 17 has the same configuration as the metal base 17 of the composite deck plate 10A except that an area (size) of the metal base 17 is larger than that of the metal base 17 of the composite deck plate 10A illustrated in FIGS. 1 to 4. The first to third reinforcing bar truss units 19a to 19c (first to third reinforcing structures) are disposed between first and second side edge portions 23 and 24 of the metal base 17, and extend in the length direction from a first end edge portion 20 toward a second end edge portion 21. The reinforcing bar truss units 19a to 19c each include (are assembled with) one upper end beam 26, two (a pair of) first and second lower end beams 27a and 27b, and two (a pair of) first and second lattice beams 28a and 28b. The upper end beam 26, the first and second lower end beams 27a and 27b, and the first and second lattice beams 28a and 28b are the same as those of the reinforcing bar truss unit 19 of the composite deck plate 10A illustrated in FIGS. 1 to 4.

Dimensions of the upper end beams 26 of the first to third reinforcing bar truss units 19a to 19c in the length direction are substantially the same, and the upper end beams 26 of the reinforcing bar truss units 19a to 19c are arranged in parallel in the width direction. Dimensions of the first lower end beams 27a and the second lower end beams 27b of the first to third reinforcing bar truss units 19a to 19c in the length direction are substantially the same, and the lower end beams 27a and 27b of the reinforcing bar truss units 19a to 19c are arranged in parallel in the width direction. Dimensions the first lattice beams 28a and the second lattice beams 28b of the first to third reinforcing bar truss units 19a to 19c in the length direction are substantially the same, and the first and second lattice beams 28a and 28b of the reinforcing bar truss units 19a to 19c are arranged in parallel in the width direction.

The wood-based plate 16 has the same configuration as the wood-based plate 16 of the deck plate 10A except that the area (size) of the wood-based plate 16 is larger than that of the wood-based plate 16 of the composite deck plate 10A illustrated in FIGS. 1 to 4. As the wood-based plate 16, any one of wood having a predetermined area, plywood having a predetermined area, a wood-based siding material having a predetermined area, a cross laminated timber (CLT) having a predetermined area, an oriented strand board (OSB plywood) having a predetermined area, a wood cement board having a predetermined area, a particle board having a predetermined area, or a medium density fiber (MDF) board having a predetermined area described above in the description of the composite deck plate 10A is used.

At the first side edge portion 11 (one side edge portion) of the composite deck plate 10D, a first side edge portion 33 (first side area 39) of the wood-based plate 16 extends outward in the width direction from the first side edge portion 23 of the metal base 17 of the reinforced deck plate 15, and an upper surface 37 of the first side edge portion 33 (first side area 39) of the wood-based plate 16 (the wood, plywood, wood-based siding, CLT, oriented strand board (OSB plywood), wood cement board, particle board, or MDF board) is exposed.

At the second side edge portion 12 (the other side edge portion) of the composite deck plate 10D, a second side edge portion 34 (second side area 40) of the wood-based plate 16 extends outward in the width direction from the second side edge portion 21 of the metal base 17 of the reinforced deck plate 15, and the upper surface 37 of the second side edge portion 34 (second side area 40) of the wood-based plate 16 (the wood, plywood, wood-based siding, CLT, oriented strand board (OSB plywood), wood cement board, particle board, or MDF board) is exposed. A center area 41 positioned between the first and second side edge portions 33 and 34 (the first and second side areas 39 and 40) of the wood-based plate 16 is positioned on a lower surface 25 of the metal base 17 to conceal the metal base 17.

In the composite deck plate 10D, the substantially flat lower surface 25 (facing surface) of the metal base 17 of the reinforced deck plate 15 and the substantially flat upper surface 37 (facing surface) of the wood-based plate 16 (the wood, plywood, wood-based siding, CLT, oriented strand board (OSB plywood), wood cement board, particle board, or MDF board) overlap (are in contact with) each other, and as illustrated in FIGS. 14 to 16, the metal base 17 and the wood-based plate 16 are connected and fixed by a plurality of staples 42 (fixing means).

The wood-based plate 16 is connected and fixed to the lower surface 25 of the metal base 17 by the plurality of staples 42 positioned at the first and second side edge portions 23 and 24 of the metal base 17 of a first reinforced deck plate 15a and arranged at equal intervals in the length direction, and is connected and fixed to the lower surface 25 of the metal base 17 by the plurality of staples 42 (fixing means) positioned at a central portion 22 of the metal base 17, arranged at equal intervals in the length direction, and arranged at predetermined intervals in the width direction. The staples 42 may be spaced apart from each other at different intervals in the length direction.

The staples 42 are applied from the upper surface 37 of the wood-based plate 16 into the wood-based plate 16 while leg portions 44 penetrate through the metal base 17 in a state where shoulder portions 43 extend in the width direction. The staples 42 are applied in the thickness direction of the wood-based plate 16 from the upper surface 18 of the metal base 17 by a gun tacker. When the staple 42 is applied into the wood-based plate 16, the leg portions 44 of the staple 42 connect the metal base 17 and the wood-based plate 16, and the adhesive applied to the entire shoulder portion 43 and the entire leg portions 44 of the staple 42, the entire leg portions 44 of the staple 42, or the lower half of the leg portions 44 of the staple 42 firmly adheres the staple 42 and the wood-based plate 16.

In the composite deck plate 10D, the wood-based plate 16 may be connected and fixed to lower surfaces of the first and second side edge portions 23 and 24 and the central portion 22 of the metal base 17 by the staples 42 (fixing means) arranged as illustrated in FIG. 5, or the wood-based plate 16 may be connected and fixed to the lower surfaces of the first and second side edge portions 23 and 24 and the central portion 22 of the metal base 17 by the staples 42 (fixing means) arranged as illustrated in FIG. 6. Alternatively, the wood-based plate 16 may be connected and fixed to the lower surfaces of the first and second side edge portions 23 and 24 and the central portion 22 of the metal base 17 by the staples 42 (fixing means) arranged as illustrated in FIG. 7.

In the composite deck plate 10D (ceiling slab), while the wood-based plate 16 conceals the entire lower surface 25 of the metal base 17, the lower surface 38 (decorative surface) of the wood-based plate 16 (the wood, plywood, wood-based siding, CLT, oriented strand board (OSB plywood), wood cement board, particle board, or MDF board) is exposed downward from the ceiling of the building (inside the building) to form the ceiling surface.

In the composite deck plate 10D, the wood-based plate 16 is fixed to the lower surface 25 of the metal base 17 of the reinforced deck plate 15 by the plurality of staples 42 (predetermined fixing means), and the wood-based plate 16 (the wood, plywood, wood-based siding, CLT, oriented strand board (OSB plywood), wood cement board, particle board, or MDF board) is exposed on a lower side of the composite deck plate 10D to form the ceiling surface of the building. Therefore, an appealing design of the wood-based plate 16 can be incorporated into the ceiling surface, so that an attractive ceiling surface can be formed, and a ceiling surface that provides a viewer with aesthetic appeal, comfort, warmth, and tranquility offered by the wood-based plate 16 which is a natural material can be formed.

In the composite deck plate 10D, the wood-based plate 16 is fixed to the lower surface 25 of the metal base 17 of the reinforced deck plate 15 to form the ceiling surface.

Therefore, it is possible to construct a ceiling slab without attaching a ceiling finishing material such as decorative plywood, a gypsum board, or an aluminum panel by using a hanging bolt, and it is possible to eliminate ceiling finishing work for separately installing the ceiling finishing material, and it is possible to save labor and cost for the ceiling finishing work. With the composite deck plate 10D, it is not necessary to attach a ceiling finishing material such as decorative plywood, a gypsum board, or an aluminum panel by using a hanging bolt. Therefore, unlike a suspended ceiling structure in which a ceiling finishing material is attached using a hanging bolt, ceiling finishing work can be eliminated, a ceiling slab can be efficiently constructed, there is no risk of falling even when shaking (vibration) occurs due to an earthquake or the like, and a ceiling slab capable of preventing occurrence of a ceiling fall accident can be constructed.

For the composite deck plate 10D, the wood-based plate 16, which is a sustainable circulation-type resource, is used, forest resources can be effectively used, so that the environmental load can be reduced by contributing to reduction of CO². An essential oil component of the wood or CLT as the wood-based plate 16 has an effect of suppressing mold Infestation and propagation of pathogenic bacteria, and the mold Infestation and the propagation of pathogenic bacteria on the ceiling can be suppressed by using the wood or CLT as the wood-based plate 16 for the ceiling surface. In addition, the wood or CLT as the wood-based plate 16 has a humidity control action of absorbing moisture when the humidity in the air is high and releasing moisture when the humidity is low, and the humidity is controlled on the ceiling by using the wood or CLT as the wood-based plate 16 for the ceiling surface, so that the humidity in the room is controlled. Further, the wood or CLT as the wood-based plate 16 has an effect of appropriately absorbing high, medium, and low sounds in a well-balanced manner and making sound quality moderate, and thus, it is possible to soften indoor sound by using the wood or CLT as the wood-based plate 16 for the ceiling surface.

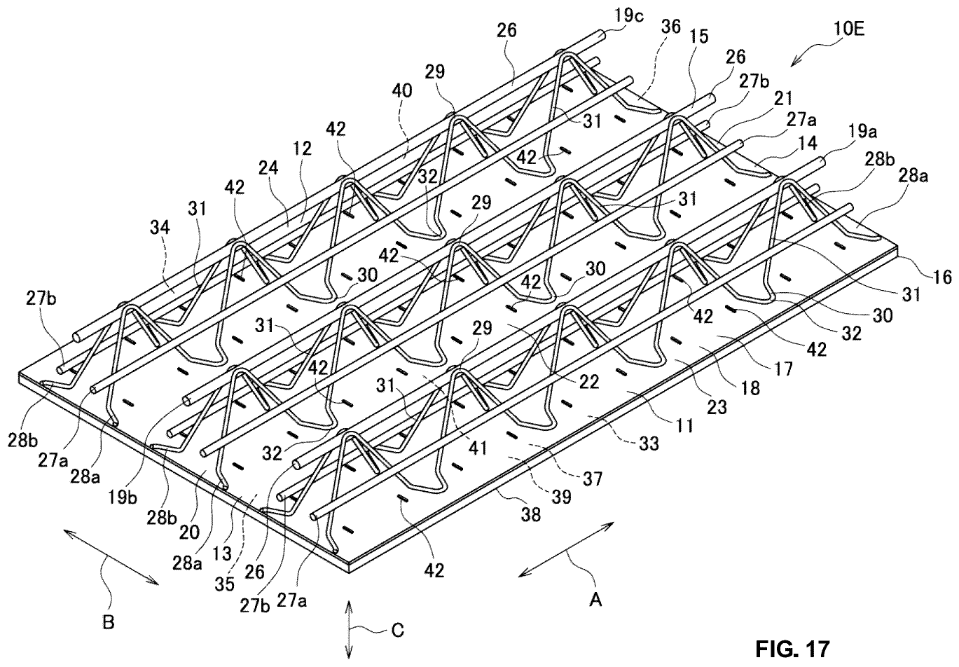

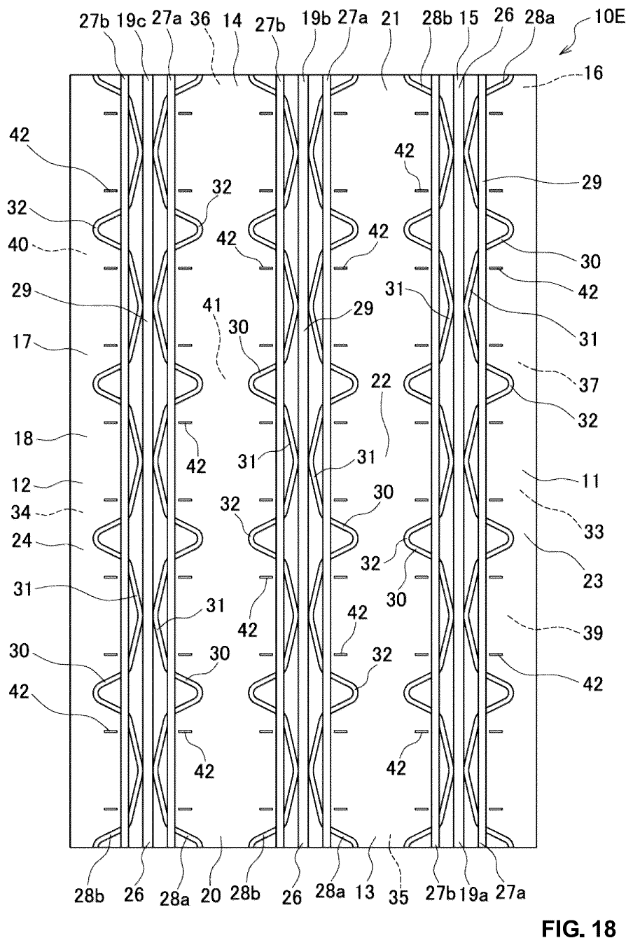

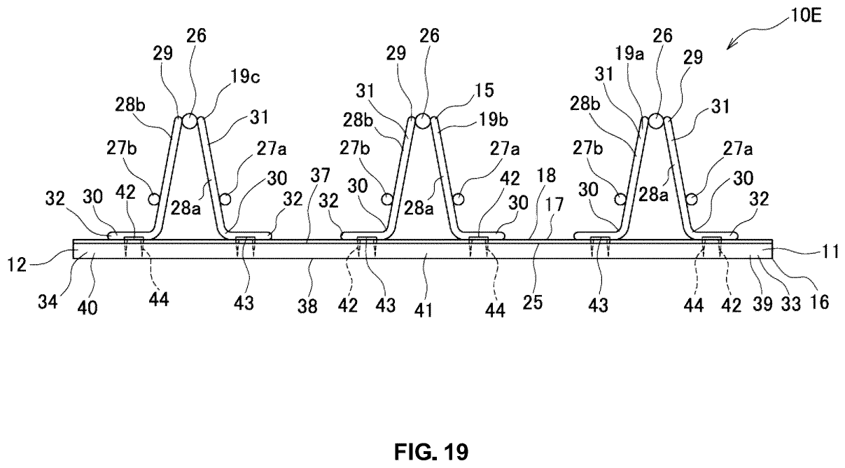

FIG. 17 is a perspective view of the composite deck plate 10E illustrated as another example, and FIG. 18 is a top view of the composite deck plate 10E of FIG. 17. FIG. 19 is a front view of the composite deck plate 10E of FIG. 17. In FIG. 17, a length direction is indicated by an arrow A, a width direction is indicated by an arrow B, and a vertical direction (thickness direction) is indicated by an arrow C.

The composite deck plate 10E illustrated in FIGS. 17 to 19 is different from the composite deck plate 10D illustrated in FIGS. 14 to 16 in that a first side edge portion 33 (first side area 39) of a wood-based plate 16 is positioned on a lower surface of a first side edge portion 23 of a metal base 17 of a reinforced deck plate 15, the first side edge portion 23 of the metal base 17 and the first side edge portion 33 (first side area 39) of the wood-based plate 16 overlap each other, a second side edge portion 34 (second side area 40) of the wood-based plate 16 is positioned on a lower surface of a second side edge portion 24 of the metal base 17 of the reinforced deck plate 15, and the second side edge portion 24 of the metal base 17 and the second side edge portion 34 (second side area 40) of the wood-based plate 16 overlap each other. Since other configurations are the same as those of the composite deck plate 10D of FIGS. 14 to 16, a description of the composite deck plate 10D of FIGS. 14 to 16 is cited, and the same reference signs as those in FIGS. 14 to 16 are given. Therefore, a detailed description of the composite deck plate 10E will be omitted.

The composite deck plate 10E has first and second side edge portions 11 and 12 (both side edge portions) that face each other while being separated from each other in the width direction and extend in the length direction, and first and second end edge portions 13 and 14 (both end edge portions) that face each other while being separated from each other in the length direction and extend in the width direction. The composite deck plate 10E includes the reinforced deck plate 15 having a predetermined area and extending in the length direction, and the wood-based plate 16 having a predetermined area and extending in the length direction. The wood-based plate 16 is the same as that of the composite deck plate 10A, and any one of wood having a predetermined area, plywood having a predetermined area, a wood-based siding material having a predetermined area, a cross laminated timber (CLT) having a predetermined area, an oriented strand board (OSB plywood) having a predetermined area, a wood cement board having a predetermined area, a particle board having a predetermined area, or a medium density fiber (MDF) board having a predetermined area is used in the description of the composite deck plate 10A.

In the composite deck plate 10E, the first side edge portion 23 of the metal base 17 of the reinforced deck plate 15 and the first side edge portion 33 (first side area 39) of the wood-based plate 16 overlap each other in the thickness direction in a state where a side edge of the first side edge portion 23 of the metal base 17 of the reinforced deck plate 15 and a side edge of the first side edge portion 33 (first side area 39) of the wood-based plate 16 coincide with each other. Further, the second side edge portion 24 of the metal base 17 of the reinforced deck plate 15 and the second side edge portion 34 (second side area 40) of the wood-based plate 16 overlap each other in the thickness direction in a state where a side edge of the second side edge portion 24 of the metal base 17 of the reinforced deck plate 15 and a side edge of the second side edge portion 34 (second side area 40) of the wood-based plate 16 coincide with each other.

In the composite deck plate 10E, a substantially flat lower surface 25 (facing surface) of the metal base 17 of the reinforced deck plate 15 and a substantially flat upper surface 37 (facing surface) of the wood-based plate 16 (the wood, plywood, wood-based siding, CLT, oriented strand board (OSB plywood), wood cement board, particle board, or MDF board) overlap (are in contact with) each other, and as illustrated in FIGS. 17 to 19, the metal base 17 and the wood-based plate 16 are connected and fixed by a plurality of staples 42 (fixing means). Arrangement of the staples 42 in the metal base 17 is the same as the arrangement of the staples 42 in the metal base 17 of the composite deck plate 10D illustrated in FIGS. 14 to 16.

The composite deck plate 10E has the same effect as that of the composite deck plate 10D illustrated in FIGS. 14 to 16. In the composite deck plate 10E, the wood-based plate 16 may be connected and fixed to lower surfaces of the first and second side edge portions 23 and 24 and a central portion 22 of the metal base 17 by the staples 42 (fixing means) arranged as illustrated in FIG. 5, or the wood-based plate 16 may be connected and fixed to the lower surfaces of the first and second side edge portions 23 and 24 and the central portion 22 of the metal base 17 by the staples 42 (fixing means) arranged as illustrated in FIG. 6. Alternatively, the wood-based plate 16 may be connected and fixed to the lower surfaces of the first and second side edge portions 23 and 24 and the central portion 22 of the metal base 17 by the staples 42 (fixing means) arranged as illustrated in FIG. 7.

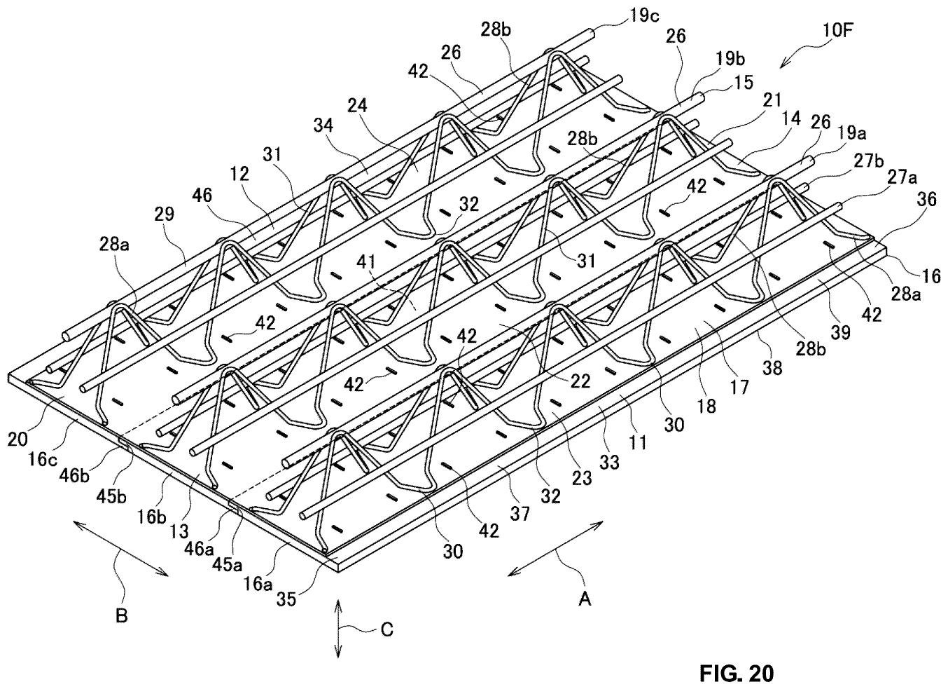

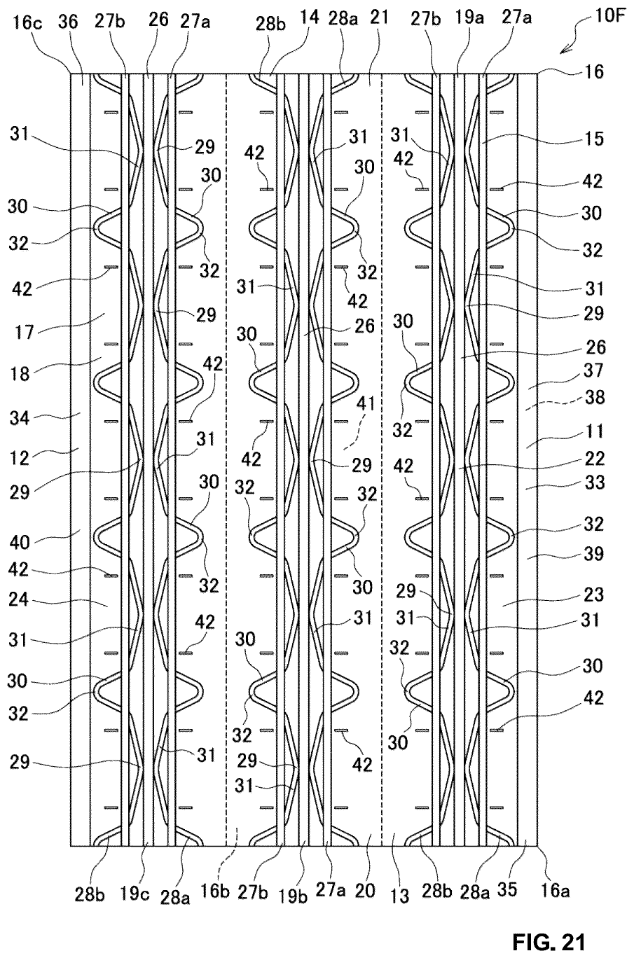

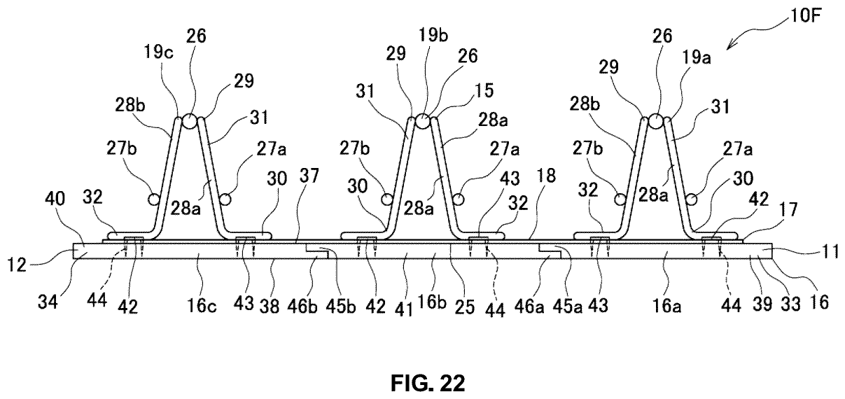

FIG. 20 is a perspective view of the composite deck plate 10F illustrated as another example, and FIG. 21 is a top view of the composite deck plate 10F of FIG. 20. FIG. 22 is a front view of the composite deck plate 10F of FIG. 20. In FIG. 20, a length direction is indicated by an arrow A, a width direction is indicated by an arrow B, and a vertical direction (thickness direction) is indicated by an arrow C.

The composite deck plate 10F has first and second side edge portions 11 and 12 (both side edge portions) that face each other while being separated from each other in the width direction and extend in the length direction, and first and second end edge portions 13 and 14 (both end edge portions) that face each other while being separated from each other in the length direction and extend in the width direction. The composite deck plate 10F includes a reinforced deck plate 15 having a predetermined area and extending in the length direction, and first to third wood-based plates 16a to 16c having a predetermined area and extending in the length direction. The number of wood-based plates 16 is not limited, and two wood-based plates 16 including the first and second wood-based plates 16a and 16b may be used to form the composite deck plate 10F (including the composite deck plate 10G), or four or more wood-based plates 16 including first to n-th wood-based plates 16a to 16n may be used to form the composite deck plate 10F (including the composite deck plate 10G).

The reinforced deck plate 15 is disposed on the first to third wood-based plates 16a to 16c. The reinforced deck plate 15 includes a metal base 17 having a large predetermined area in the length direction, and first to third reinforcing bar truss units 19a to 19c (first to third reinforcing structures) disposed and fixed (installed) on and to an upper surface 18 of the metal base 17. The metal base 17 and the first to third reinforcing bar truss units 19a to 19c are the same as those of the composite deck plate 10D illustrated in FIGS. 14 to 16.

The first to third wood-based plates 16a to 16c have first and second side edge portions 33 and 34 (both side edge portions) that face each other while being spaced apart from each other in the width direction and extend in the length direction, and first and second end edge portions 35 and 36 (both end edge portions) that face each other while being spaced apart from each other in the length direction and extend in the width direction, and have substantially flat upper surfaces 37 and substantially flat lower surfaces 38. The first to third wood-based plates 19a to 19c are formed into rectangles elongated in the length direction, have the same size and the same shape of which a dimension in the length direction and a dimension in the width direction are the same, and are arranged in the width direction in parallel with each other.

As the first to third wood-based plates 16a to 16c, any one of wood having a predetermined area, plywood having a predetermined area, a wood-based siding material having a predetermined area, a cross laminated timber (CLT) having a predetermined area, an oriented strand board (OSB plywood) having a predetermined area, a wood cement board having a predetermined area, a particle board having a predetermined area, or a medium density fiber (MDF) board having a predetermined area described above in the description of the composite deck plate 10A is used.

A first upper joint 45a extending in the length direction is formed at the second side edge portion 34 of the first wood-based plate 19a. The first upper joint 45a is formed by cutting off (on-site processing or pre-cutting) a part (approximately half) of second side edge portion 34 of the plate 19a from the lower surface 38 toward the upper surface 37 of the first wood-based plate 19a. A first lower joint 46a extending in the length direction is formed at the first side edge portion 33 of the second wood-based plate 19b. The first lower joint 46a is formed by cutting off (on-site processing or pre-cutting) a part (substantially half) of the first side edge portion 33 of the plate 19b from the upper surface 37 toward the lower surface 38 of the second wood-based plate 19b.

A second upper joint 45b extending in the length direction is formed at the second side edge portion 34 of the second wood-based plate 16b. The second upper joint 45b is formed by cutting off (on-site processing or pre-cutting) a part (substantially half) of the second side edge portion 34 of the plate 16b from the lower surface 38 toward the upper surface 37 of the second wood-based plate 16b. A second lower joint 46b extending in the length direction is formed at the first side edge portion 33 of the third wood-based plate 16c. The second lower joint 46b is formed by cutting off (on-site processing or pre-cutting) a part (substantially half) of the first side edge portion 33 of the plate 16c from the upper surface 37 toward the lower surface 38 of the third wood-based plate 16c.

The second wood-based plate 16b is positioned on a side of the first wood-based plate 16a in the width direction, and the third wood-based plate 16c is positioned on a side of the second wood-based plate 16b in the width direction. In the first to third wood-based plates 16a to 16c, the first lower joint 46a of the second wood-based plate 16b is positioned immediately under the first upper joint 45a of the first wood-based plate 16a, and the joints 45a and 46a are bonded and connected to each other by an adhesive (predetermined fixing means) in a state where the first upper joint 45a of the first wood-based plate 16a and the first lower joint 46a of the second wood-based plate 16b overlap each other in the vertical direction.

The second lower joint 46b of the third wood-based plate 16c is positioned immediately under the second upper joint 45b of the second wood-based plate 16b, and the joints 45b and 46b are bonded and connected to each other by an adhesive (predetermined fixing means) in a state where the second upper joint 45b of the second wood-based plate 16b and the second lower joint 46b of the third wood-based plate 16c overlap each other in the vertical direction. The joints 45a, 45b, 46a, and 46b may be connected and fixed to each other by staples 39, nails, clamps, fixing bolts, or rivets (fixing means).

In the composite deck plate 10F, the reinforced deck plate 15 extending in the length direction is disposed on the first to third wood-based plates 16a to 16c extending in the length direction. At the first side edge portion 11 (one side edge portion) of the composite deck plate 10F, the first side edge portion 33 (first side area 39) of the first wood-based plate 16a extends outward in the width direction from the first side edge portion 23 of the metal base 17 of the reinforced deck plate 15, and the upper surface 37 of the first side edge portion 33 (first side area 39) of the first wood-based plate 16a (the wood, plywood, wood-based siding, CLT, oriented strand board (OSB plywood), wood cement board, particle board, or MDF board) is exposed.

At the second side edge portion 12 (the other side edge portion) of the composite deck plate 10F, the second side edge portion 34 (second side area 40) of the third wood-based plate 16c extends outward in the width direction from the second side edge portion 21 of the metal base 17 of the reinforced deck plate 15, and the upper surface 37 of the second side edge portion 34 (second side area 40) of the third wood-based plate 16c (the wood, plywood, wood-based siding, CLT, oriented strand board (OSB plywood), wood cement board, particle board, or MDF board) is exposed. A center area 41 positioned between the first side edge portion 33 (first side area 39) of the first wood-based plate 16a and the second side edge portion 34 (second side area 40) of the third wood-based plate 16c is positioned on a lower surface 25 of the metal base 17 to conceal the metal base 17.

In the composite deck plate 10F, the substantially flat lower surface 25 (facing surface) of the metal base 17 of the reinforced deck plate 15 and the substantially flat upper surfaces 37 (facing surfaces) of the first to third wood-based plates 16a to 16c (the wood, plywood, wood-based siding, CLT, oriented strand board (OSB plywood), wood cement board, particle board, or MDF board) overlap (are in contact with) each other, and as illustrated in FIGS. 20 to 22, the metal base 17 and the first to third wood-based plates 16a to 16c are connected and fixed by a plurality of staples 42 (fixing means).

Arrangement of the staples 42 in the metal base 17 is the same as the arrangement of the staples 42 in the metal base 17 of the composite deck plate 10D illustrated in FIGS. 14 to 16. The first wood-based plate 16a is fixed to the lower surface 25 of the metal base 17 of the reinforced deck plate 15 by the plurality of staples 42 intermittently arranged at equal intervals in the length direction in a state where shoulder portions 43 extend in the width direction, the second wood-based plate 16b is fixed to the lower surface 25 of the metal base 17 of the reinforced deck plate 15 by the plurality of staples 42 intermittently arranged at equal intervals in the length direction in a state where the shoulder portions 43 extend in the width direction, and the third wood-based plate 16c is fixed to the lower surface 25 of the metal base 17 of the reinforced deck plate 15 by the plurality of staples 42 intermittently arranged at equal intervals in the length direction in a state where the shoulder portions 43 extend in the width direction.

The staples 42 are applied from the upper surfaces 37 of the first to third wood-based plates 16a to 16c into the first to third wood-based plates 16a to 16c while leg portions 41 penetrate through the metal base 17. When the staples 42 are applied into the first to third wood-based plates 16a to 16c, the leg portions 44 of the staples 42 connect the metal base 17 and the first to third wood-based plates 16a to 16c, and an adhesive applied to the entire shoulder portions 43 and the entire leg portions 44 of the staples 42, the entire leg portions 44 of the staples 42, or the lower half of the leg portions 44 of the staples 42 firmly adheres the staples 42 and the first to third wood-based plates 16a to 16c.

In the composite deck plate 10F, the first to third wood-based plates 16a to 16c may be connected and fixed to lower surfaces of the first and second side edge portions 23 and 24 and the central portion 22 of the metal base 17 by the staples 42 (fixing means) arranged as illustrated in FIG. 5, or the first to third wood-based plates 16a to 16c may be connected and fixed to the lower surfaces of the first and second side edge portions 23 and 24 and the central portion 22 of the metal base 17 by the staples 42 (fixing means) arranged as illustrated in FIG. 6.

Alternatively, the first to third wood-based plates 16a to 16c may be connected and fixed to the lower surfaces of the first and second side edge portions 23 and 24 and the central portion 22 of the metal base 17 by the staples 42 (fixing means) arranged as illustrated in FIG. 7.

The composite deck plate 10F has the following effects in addition to the effects of the composite deck plate 10D illustrated in FIGS. 14 to 16. In the composite deck plate 10F, the first to third wood-based plates 16a to 16c (first to n-th wood-based plates) extending in the length direction are fixed to the lower surface 25 of the metal base 17 of the reinforced deck plate 15 by the plurality of staples 42 (predetermined fixing means), and the first to third wood-based plates 16a to 16c are exposed on a lower side of the composite deck plate 10F to form the ceiling surface of the building. Therefore, an appealing design of the first to third wood-based plates 16a to 16c extending in the length direction can be incorporated into the ceiling surface, so that a ceiling surface that provides a viewer with aesthetic appeal, comfort, warmth, and tranquility offered by the first to third wood-based plates 16a to 16c which are natural materials can be formed. For the composite deck plate 10F, the first to third wood-based plates 16a to 16c (first to n-th wood-based plates), which are sustainable circulation-type resources, are used, so that forest resources can be effectively utilized, and the environmental load can be reduced by contributing to reduction of CO².

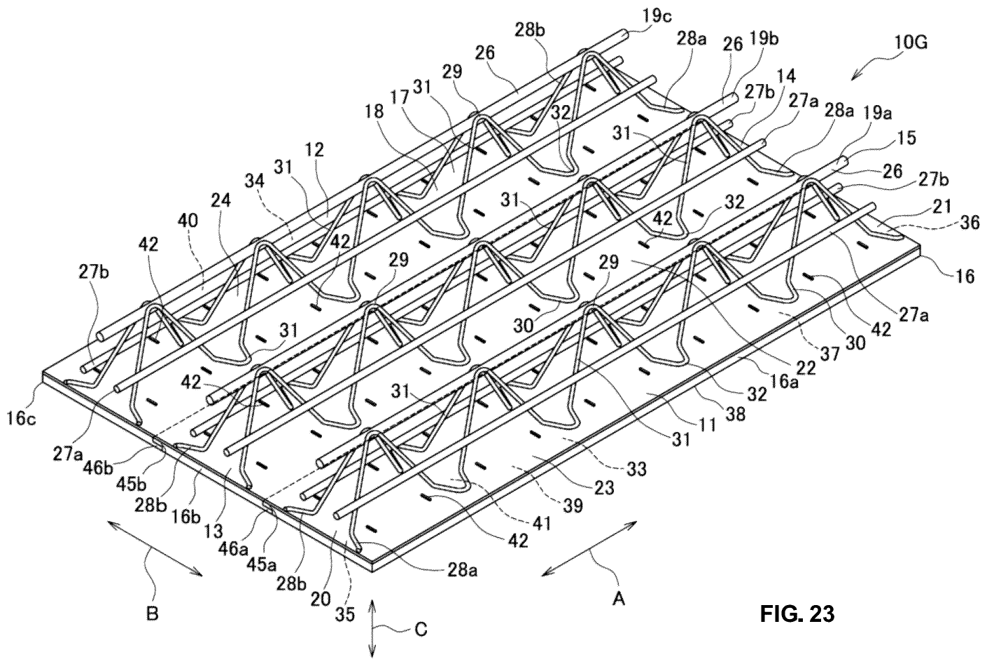

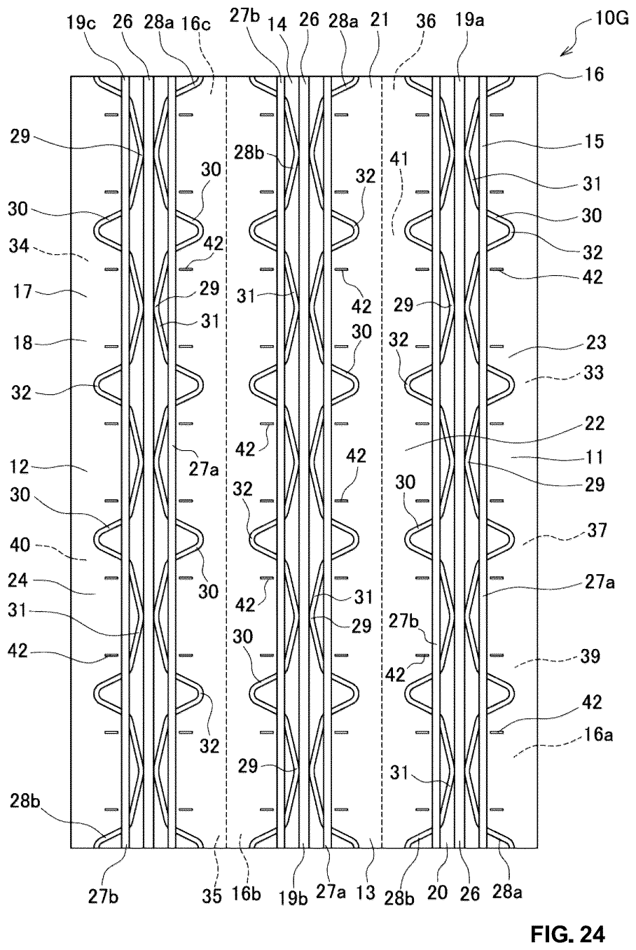

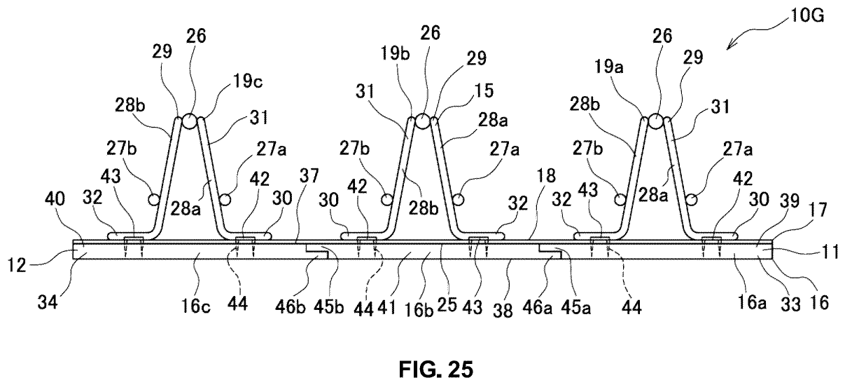

FIG. 23 is a perspective view of the composite deck plate 10G illustrated as another example, and FIG. 24 is a top view of the composite deck plate 10G of FIG. 23. FIG. 25 is a front view of the composite deck plate 10G of FIG. 23. In FIG. 23, a length direction is indicated by an arrow A, a width direction is indicated by an arrow B, and a vertical direction (thickness direction) is indicated by an arrow C.

The composite deck plate 10G illustrated in FIGS. 23 to 25 is different from that illustrated in FIGS. 20 to 22 in that a first side edge portion 33 (first side area 39) of a first wood-based plate 16a is positioned on a lower surface of a first side edge portion 23 of a metal base 17 of a reinforced deck plate 15, the first side edge portion 23 of the metal base 17 and the first side edge portion 33 (first side area 39) of the first wood-based plate 16a overlap each other, a second side edge portion 34 (second side area 40) of a third wood-based plate 16c is positioned on a lower surface of a second side edge portion 24 of the metal base 17 of the reinforced deck plate 15, and the second side edge portion 24 of the metal base 17 and the second side edge portion 34 (second side area 40) of the third wood-based plate 16c overlap each other. Since other configurations of the composite deck plate 10G are the same as those of the composite deck plate 10F of FIGS. 20 to 22, a description of the composite deck plate 10F of FIGS. 20 to 22 is cited, and the same reference signs as those in FIGS. 20 to 22 are given. Therefore, a detailed description of the composite deck plate 10G will be omitted.

The composite deck plate 10G has first and second side edge portions 11 and 12 (both side edge portions) that face each other while being separated from each other in the width direction and extend in the length direction, and first and second end edge portions 13 and 14 (both end edge portions) that face each other while being separated from each other in the length direction and extend in the width direction. The composite deck plate 10G includes the reinforced deck plate 15 having a predetermined area and extending in the length direction, and first to third wood-based plates 16a to 16c (first to n-th wood-based plates) having a predetermined area and extending in the length direction. The first to third wood-based plates 16a to 16c are the same as those of the composite deck plate 10F, and any one of wood having a predetermined area, plywood having a predetermined area, a wood-based siding material having a predetermined area, a cross laminated timber (CLT) having a predetermined area, an oriented strand board (OSB plywood) having a predetermined area, a wood cement board having a predetermined area, a particle board having a predetermined area, or a medium density fiber (MDF) board having a predetermined area described above in the description of the composite deck plate 10A is used.

In the composite deck plate 10G, the first side edge portion 23 of the metal base 17 of the reinforced deck plate 15 and the first side edge portion 33 (first side area 39) of the first wood-based plate 16a overlap each other in the thickness direction in a state where a side edge of the first side edge portion 23 of the metal base 17 of the reinforced deck plate 15 and a side edge of the first side edge portion 33 (first side area 39) of the first wood-based plate 16a coincide with each other. Further, the second side edge portion 24 of the metal base 17 of the reinforced deck plate 15 and the second side edge portion 34 (second side area 40) of the third wood-based plate 16c overlap each other in the thickness direction in a state where a side edge of the second side edge portion 24 of the metal base 17 of the reinforced deck plate 15 and a side edge of the second side edge portion 34 (second side area 40) of the third wood-based plate 16c coincide with each other.

In the composite deck plate 10G, the substantially flat lower surface 25 (facing surface) of the metal base 17 of the reinforced deck plate 15 and the substantially flat upper surfaces 37 (facing surfaces) of the first to third wood-based plates 16a to 16c (the wood, plywood, wood-based siding, CLT, oriented strand board (OSB plywood), wood cement board, particle board, or MDF board) overlap (are in contact with) each other, and as illustrated in FIGS. 23 to 25, the metal base 17 and the first to third wood-based plates 16a to 16c are connected and fixed by a plurality of staples 42 (fixing means). Arrangement of the staples 42 in the metal base 17 is the same as the arrangement of the staples 42 in the metal base 17 of the composite deck plate 10F illustrated in FIGS. 20 to 22.

The composite deck plate 10G has the same effect as that of the composite deck plate 10F illustrated in FIGS. 20 to 22. In the composite deck plate 10G, the first to third wood-based plates 16a to 16c may be connected and fixed to lower surfaces of the first and second side edge portions 23 and 24 and the central portion 22 of the metal base 17 by the staples 42 (fixing means) arranged as illustrated in FIG. 5, or the first to third wood-based plates 16a to 16c may be connected and fixed to the lower surfaces of the first and second side edge portions 23 and 24 and the central portion 22 of the metal base 17 by the staples 42 (fixing means) arranged as illustrated in FIG. 6. Alternatively, the first to third wood-based plates 16a to 16c may be connected and fixed to the lower surfaces of the first and second side edge portions 23 and 24 and the central portion 22 of the metal base 17 by the staples 42 (fixing means) arranged as illustrated in FIG. 7.

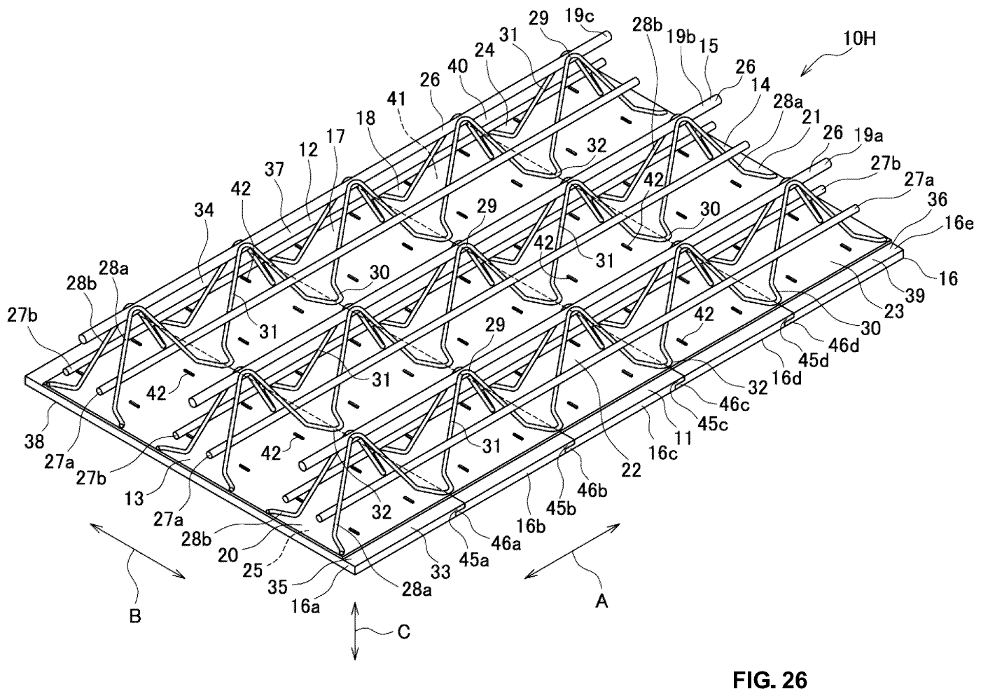

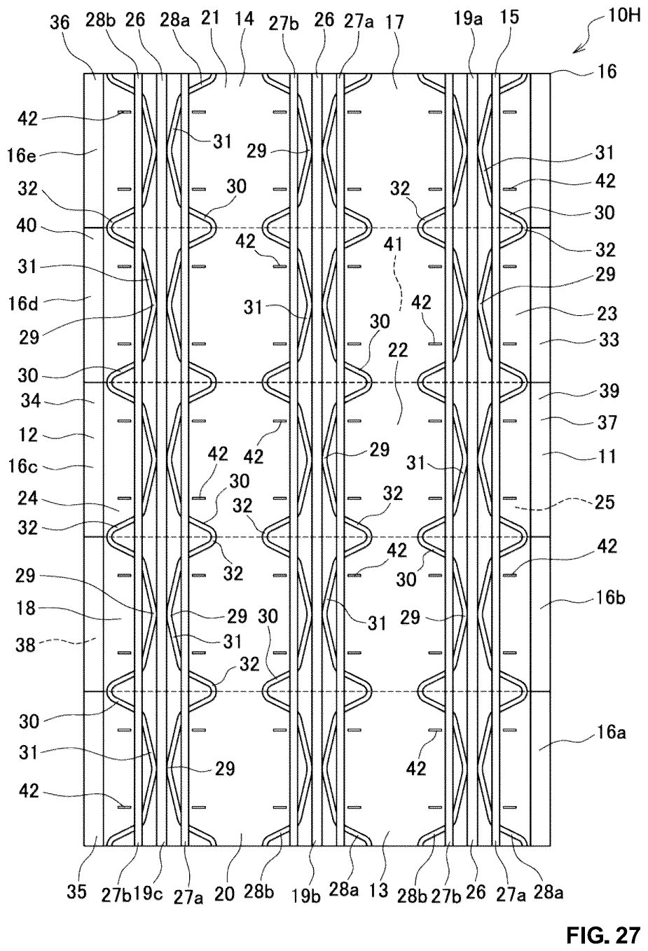

FIG. 26 is a perspective view of the composite deck plate 10H illustrated as another example, and FIG. 27 is a top view of the composite deck plate 10H of FIG. 26. In FIG. 26, a length direction is indicated by an arrow A, a width direction is indicated by an arrow B, and a vertical direction (thickness direction) is indicated by an arrow C.

The composite deck plate 10H has first and second side edge portions 11 and 12 (both side edge portions) that face each other while being separated from each other in the width direction and extend in the length direction, and first and second end edge portions 13 and 14 (both end edge portions) that face each other while being separated from each other in the length direction and extend in the width direction. The composite deck plate 10H includes a reinforced deck plate 15 having a predetermined area and extending in the length direction, and first to fifth wood-based plates 16a to 16e having a predetermined area and extending in the width direction.

The number of wood-based plates 16 is not limited, and two wood-based plates 16 including the first and second wood-based plates 16a and 16b extending in the width direction, three wood-based plates 16 including the first to third wood-based plates 16a to 16c extending in the width direction, or four wood-based plates 16 including the first to fourth wood-based plates 16a to 16d extending in the width direction may be used to form the composite deck plate 10H (including the composite deck plate 10I), or six or more wood-based plates 16 including first to n-th wood-based plates 16a to 16n extending in the width direction may be used to form the composite deck plate 10H (including the composite deck plate 10I).

The first to fifth wood-based plates 16a to 16e have first and second side edge portions 33 and 34 (both side edge portions) that face each other while being spaced apart from each other in the length direction and extend in the width direction, and first and second end edge portions 35 and 36 (both end edge portions) that face each other while being spaced apart from each other in the width direction and extend in the length direction, and have substantially flat upper surfaces 37 and substantially flat lower surfaces 38. The first to fifth wood-based plates 16a to 16e are formed into rectangles elongated in the width direction, have the same size and the same shape of which a dimension in the length direction and a dimension in the width direction are the same, and are arranged in the length direction in parallel with each other. As the first to fifth wood-based plates 16a to 16e, any one of wood having a predetermined area, plywood having a predetermined area, a wood-based siding material having a predetermined area, a cross laminated timber (CLT) having a predetermined area, an oriented strand board (OSB plywood) having a predetermined area, a wood cement board having a predetermined area, a particle board having a predetermined area, or a medium density fiber (MDF) board having a predetermined area described above in the description of the composite deck plate 10A is used.

Similarly to the first to fifth wood-based plates 16a to 16e of the composite deck plate 10C, a first upper joint 45a is formed at the second side edge portion 34 of the first wood-based plate 16a, a first lower joint 46a is formed at the first side edge portion 33 of the second wood-based plate 16b, a second upper joint 45b is formed at the second side edge portion 34 of the second wood-based plate 16b, and a second lower joint 46b is formed at the first side edge portion 33 of the third wood-based plate 16c. A third upper joint 45c is formed at the second side edge portion 34 of the third wood-based plate 16c, a third lower joint 46c is formed at the first side edge portion 33 of the fourth wood-based plate 16d, a fourth upper joint 45d is formed at the second side edge portion 34 of the fourth wood-based plate 16d, and a fourth lower joint 46d is formed at the first side edge portion 33 of the fifth wood-based plate 16e.

Similarly to the first to fifth wood-based plates 16a to 16e of the composite deck plate 10C, the first wood-based plate 16a, the second wood-based plate 16b, the third wood-based plate 16c, the fourth wood-based plate 16d, and the fifth wood-based plate 16e are arranged in this order from the front side in the length direction toward the rear side in the length direction. The joints 45a and 46a are bonded and connected to each other by an adhesive (predetermined fixing means) in a state where the first upper joint 45a of the first wood-based plate 16a and the first lower joint 46a of the second wood-based plate 16b overlap each other in the vertical direction, and the joints 45b and 46b are bonded and connected to each other by an adhesive (predetermined fixing means) in a state where the second upper joint 45b of the second wood-based plate 16b and the second lower joint 46b of the third wood-based plate 16c overlap each other in the vertical direction.

The joints 45c and 46c are bonded and connected to each other by an adhesive (predetermined fixing means) in a state where the third upper joint 45c of the third wood-based plate 16c and the third lower joint 46c of the fourth wood-based plate 16d overlap each other in the vertical direction, and the joints 45d and 46d are bonded and connected to each other by an adhesive (predetermined fixing means) in a state where the fourth upper joint 45d of the fourth wood-based plate 16d and the fourth lower joint 46d of the fifth wood-based plate 16e overlap each other in the vertical direction. The joints 45a to 45d and 46a to 46d may be connected and fixed to each other by staples 39, nails, clamps, fixing bolts, or rivets (fixing means).

In the composite deck plate 10H, the reinforced deck plate 15 extending in the length direction is disposed on the first to fifth wood-based plates 16a to 16e extending in the width direction. At the first side edge portion 11 (one side edge portion) of the composite deck plate 10H, the first end edge portions 35 (first side areas 39) of the first to fifth wood-based plates 16a to 16e extend outward in the width direction from a first side edge portion 23 of a metal base 17 of the reinforced deck plate 15, and the upper surfaces 37 of the first end edge portions 35 (first side areas 39) of the first to fifth wood-based plates 16a to 16e are exposed. At the second side edge portion 12 (the other side edge portion) of the composite deck plate 10H, the second end edge portions 36 (second side areas 40) of the first to fifth wood-based plates 16a to 16e extend outward in the width direction from a second side edge portion 24 of the metal base 17 of the reinforced deck plate 15, and the upper surfaces 37 of the second end edge portions 36 (second side areas 403) of the first to fifth wood-based plates 16a to 16e are exposed.

In the composite deck plate 10H, a substantially flat lower surface 25 (facing surface) of the metal base 17 of the reinforced deck plate 15 and the substantially flat upper surfaces 37 (facing surfaces) of the first to fifth wood-based plates 16a to 16e overlap (are in contact with) each other, and as illustrated in FIGS. 26 and 27, the metal base 17 and the first to fifth wood-based plates 16a to 16e are connected and fixed to each other by a plurality of staples 42 (fixing means) arranged at equal intervals in the length direction and arranged at predetermined intervals in the width direction.

The first to fifth wood-based plates 16a to 16e are connected and fixed to the lower surface 25 of the metal base 17 by the plurality of staples 42 positioned at the first and second side edge portions 23 and 24 of the metal base 17 of the reinforced deck plate 15 and arranged at equal intervals in the length direction, and are connected and fixed to the lower surface 25 of the metal base 17 by the plurality of staples 42 (fixing means) positioned at a central portion 22 of the metal base 17, arranged at equal intervals in the length direction, and arranged at predetermined intervals in the width direction. The staples 42 may be spaced apart from each other at different intervals in the length direction.

The staples 42 are applied into the first to fifth wood-based plates 16a to 16e from the upper surfaces 37 while leg portions 44 penetrate through the metal base 17 in a state where shoulder portions 43 extend in the width direction. When the staples 42 are applied into the first to fifth wood-based plates 16a to 16e, the leg portions 44 of the staples 42 connect the metal base 17 and the first to fifth wood-based plates 16a to 16e, and an adhesive applied to the entire shoulder portions 43 and the entire leg portions 44 of the staples 42, the entire leg portions 44 of the staples 42, or the lower half of the leg portions 44 of the staples 42 firmly adheres the staples 42 and the first to fifth wood-based plates 16a to 16e.

In the composite deck plate 10H, the first to fifth wood-based plates 16a to 16e may be connected and fixed to lower surfaces of the first and second side edge portions 23 and 24 and the central portion 22 of the metal base 17 by the staples 42 (fixing means) arranged as illustrated in FIG. 5, or the first to fifth wood-based plates 16a to 16e may be connected and fixed to the lower surfaces of the first and second side edge portions 23 and 24 and the central portion 22 of the metal base 17 by the staples 42 (fixing means) arranged as illustrated in FIG. 6.

Alternatively, the first to fifth wood-based plates 16a to 16e may be connected and fixed to the lower surfaces of the first and second side edge portions 23 and 24 and the central portion 22 of the metal base 17 by the staples 42 (fixing means) arranged as illustrated in FIG. 7.

The composite deck plate 10H has the following effects in addition to the effects of the composite deck plate 10D illustrated in FIGS. 14 to 16. In the composite deck plate 10H, the first to fifth wood-based plates 16a to 16e (first to n-th wood-based plates) extending in the width direction are fixed to the lower surface 25 of the metal base 17 of the reinforced deck plate 15 by the plurality of staples 42 (predetermined fixing means), and the first to fifth wood-based plates 16a to 16e are exposed on the lower side of the composite deck plate 10H to form the ceiling surface of the building. Therefore, an appealing design of the first to fifth wood-based plates 16a to 16e extending in the width direction can be incorporated into the ceiling surface, so that a ceiling surface that provides a viewer with aesthetic appeal, comfort, warmth, and tranquility offered by the first to fifth wood-based plates 16a to 16e which are natural materials can be formed. For the composite deck plate 10H, the first to fifth wood-based plates 16a to 16e (first to n-th wood-based plates), which are sustainable circulation-type resources, are used, so that forest resources can be effectively utilized, and the environmental load can be reduced by contributing to reduction of CO².

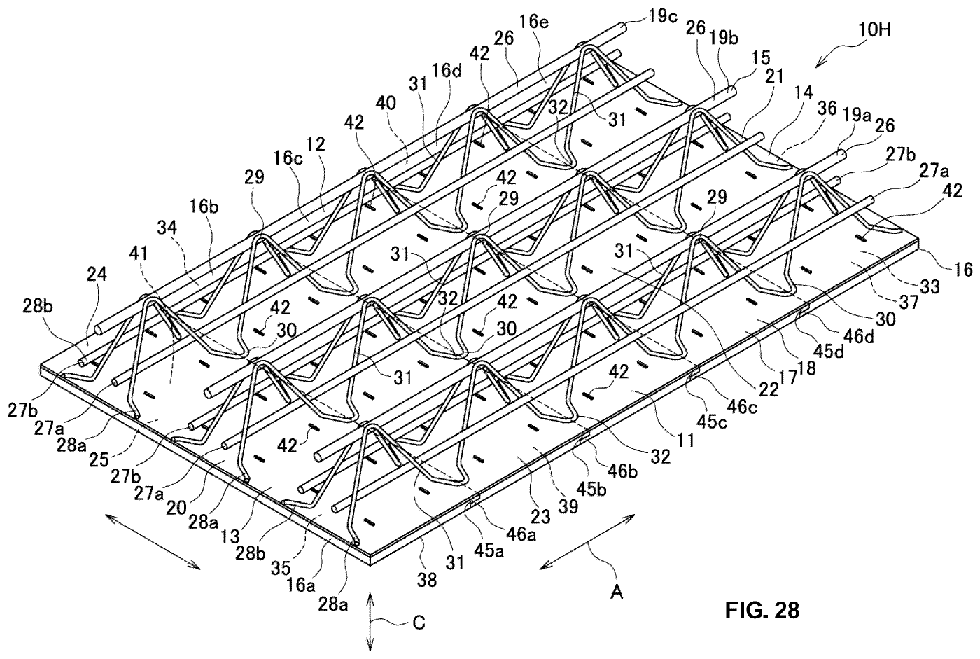

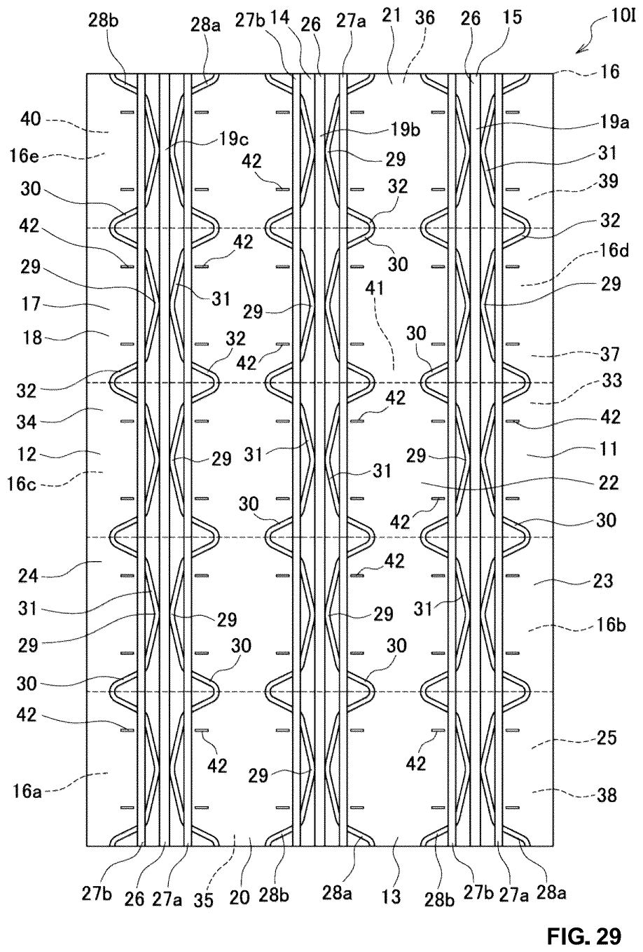

FIG. 28 is a perspective view of the composite deck plate 10I illustrated as another example, and FIG. 29 is a top view of the composite deck plate 10I of FIG. 28. In FIG. 28, a length direction is indicated by an arrow A, a width direction is indicated by an arrow B, and a vertical direction (thickness direction) is indicated by an arrow C.

The composite deck plate 10I illustrated in FIGS. 28 and 29 is different from that illustrated in FIGS. 26 and 27 in that first end edge portions 35 (first side areas 39) of first to fifth wood-based plates 16a to 16e are positioned on a lower surface of a first side edge portion 23 of a metal base 17 of a reinforced deck plate 15, the first side edge portion 23 of the metal base 17 and the first end edge portions 35 (first side areas 39) of the first to fifth wood-based plates 16a to 16e overlap each other, second end edge portions 36 (second side areas 40) of the first to fifth wood-based plates 16a to 16e are positioned on a lower surface of a second side edge portion 24 of the metal base 17 of the reinforced deck plate 15, and the second side edge portion 24 of the metal base 17 and the second end edge portions 36 (second side areas 40) of the first to fifth wood-based plates 16a to 16e overlap each other. Since other configurations of the composite deck plate 10I are the same as those of the composite deck plate 10H of FIGS. 26 and 27, a description of the composite deck plate 10H of FIGS. 26 and 27 is cited, and the same reference signs as those in FIGS. 26 and 27 are given. Therefore, a detailed description of the composite deck plate 10I will be omitted.

The composite deck plate 10I has first and second side edge portions 11 and 12 (both side edge portions) that face each other while being separated from each other in the width direction and extend in the length direction, and first and second end edge portions 13 and 14 (both end edge portions) that face each other while being separated from each other in the length direction and extend in the width direction. The composite deck plate 10I includes the reinforced deck plate 15 having a predetermined area and extending in the length direction, and first to fifth wood-based plates 16a to 16e (first to n-th wood-based plates) having a predetermined area and extending in the length direction. The first to fifth wood-based plates 16a to 16e are the same as those of the composite deck plate 10H, and any one of wood having a predetermined area, plywood having a predetermined area, a wood-based siding material having a predetermined area, a cross laminated timber (CLT) having a predetermined area, an oriented strand board (OSB plywood) having a predetermined area, a wood cement board having a predetermined area, a particle board having a predetermined area, or a medium density fiber (MDF) board having a predetermined area described above in the description of the composite deck plate 10A is used.

In the composite deck plate 10I, the first side edge portion 23 of the metal base 17 of the reinforced deck plate 15 and the first end edge portions 35 (first side areas 39) of the first to fifth wood-based plates 16a to 16e overlap each other in the thickness direction in a state where a side edge of the first side edge portion 23 of the metal base 17 of the reinforced deck plate 15 and end edges of the first end edge portions 35 (first side areas 39) of the first to fifth wood-based plates 16a to 16e coincide with each other. Further, the second side edge portion 24 of the metal base 17 of the reinforced deck plate 15 and the second end edge portions 36 (second side areas 40) of the first to fifth wood-based plates 16a to 16e overlap each other in the thickness direction in a state where a side edge of the second side edge portion 24 of the metal base 17 of the reinforced deck plate 15 and end edges of the second end edge portions 36 (second side areas 40) of the first to fifth wood-based plates 16a to 16e coincide with each other.

In the composite deck plate 10I, a substantially flat lower surface 25 (facing surface) of the metal base 17 of the reinforced deck plate 15 and substantially flat upper surfaces 37 (facing surfaces) of the first to fifth wood-based plates 16a to 16e (the wood, plywood, wood-based siding, CLT, oriented strand board (OSB plywood), wood cement board, particle board, or MDF board) overlap (are in contact with) each other, and as illustrated in FIGS. 28 and 29, the metal base 17 and the first to fifth wood-based plates 16a to 16e are connected and fixed by a plurality of staples 42 (fixing means). Arrangement of the staples 42 in the metal base 17 is the same as the arrangement of the staples 42 in the metal base 17 of the composite deck plate 10H illustrated in FIGS. 26 and 27.

The composite deck plate 10G has the same effect as that of the composite deck plate 10H illustrated in FIGS. 26 and 27. In the composite deck plate 10I, the first to fifth wood-based plates 16a to 16e may be connected and fixed to lower surfaces of the first and second side edge portions 23 and 24 and the central portion 22 of the metal base 17 by the staples 42 (fixing means) arranged as illustrated in FIG. 5, or the first to fifth wood-based plates 16a to 16e may be connected and fixed to the lower surfaces of the first and second side edge portions 23 and 24 and the central portion 22 of the metal base 17 by the staples 42 (fixing means) arranged as illustrated in FIG. 6. Alternatively, the first to fifth wood-based plates 16a to 16e may be connected and fixed to the lower surfaces of the first and second side edge portions 23 and 24 and the central portion 22 of the metal base 17 by the staples 42 (fixing means) arranged as illustrated in FIG. 7.

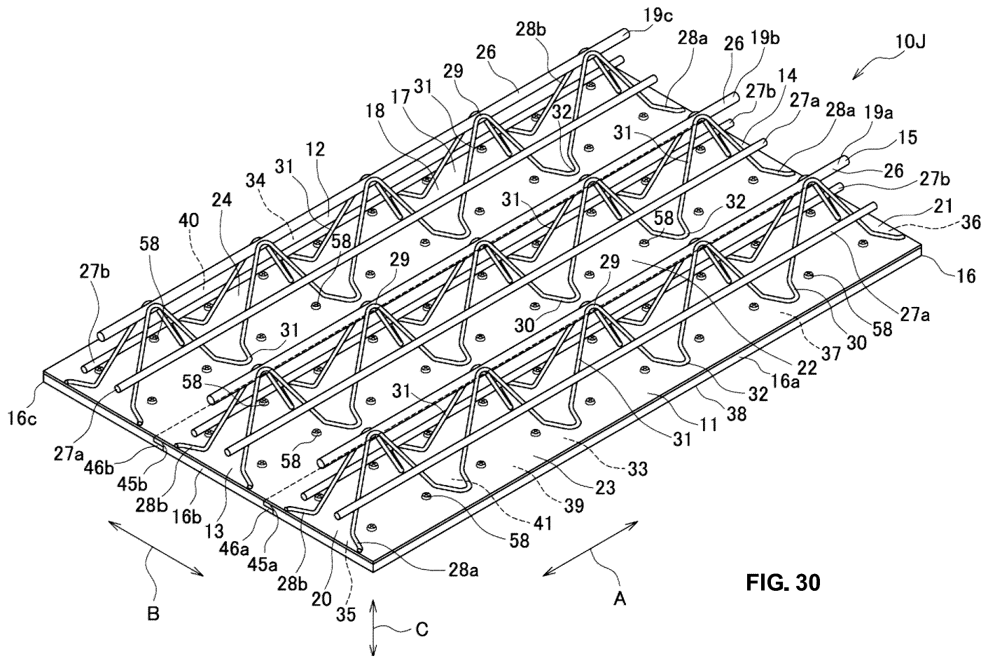

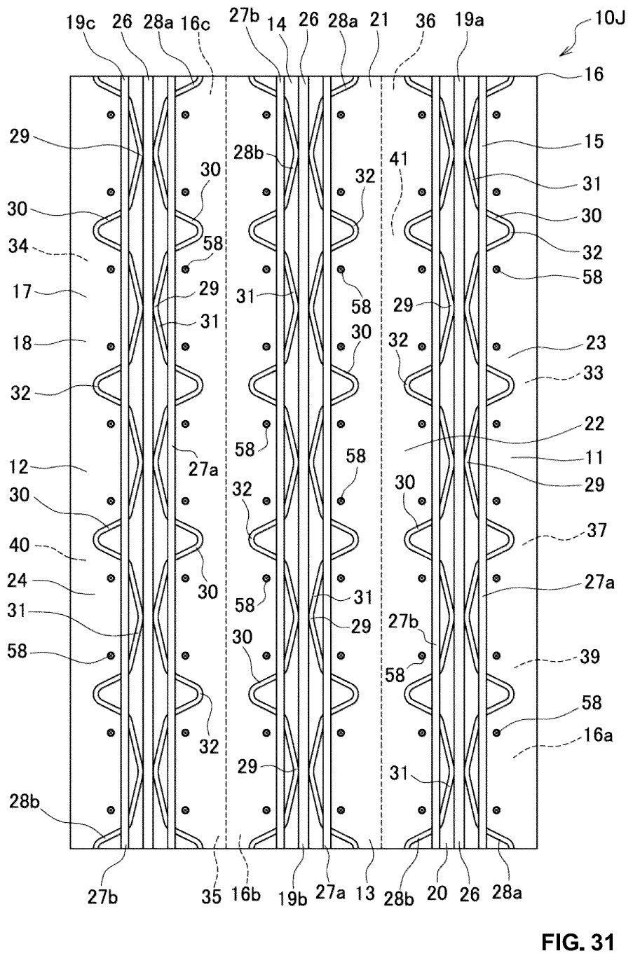

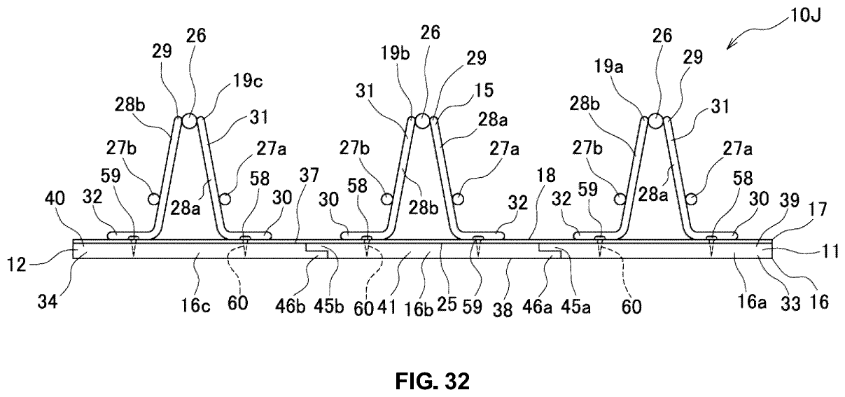

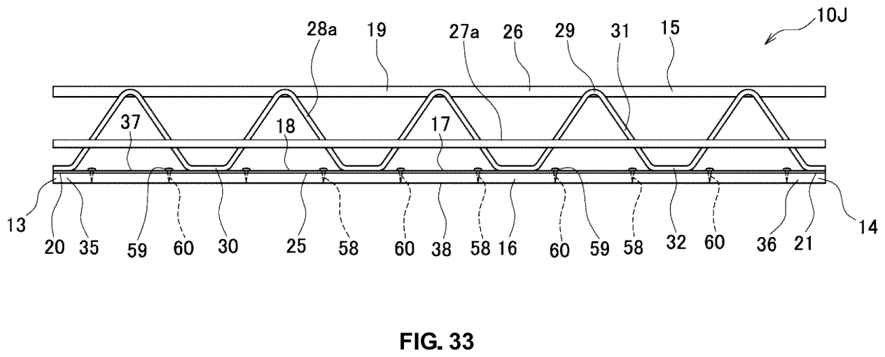

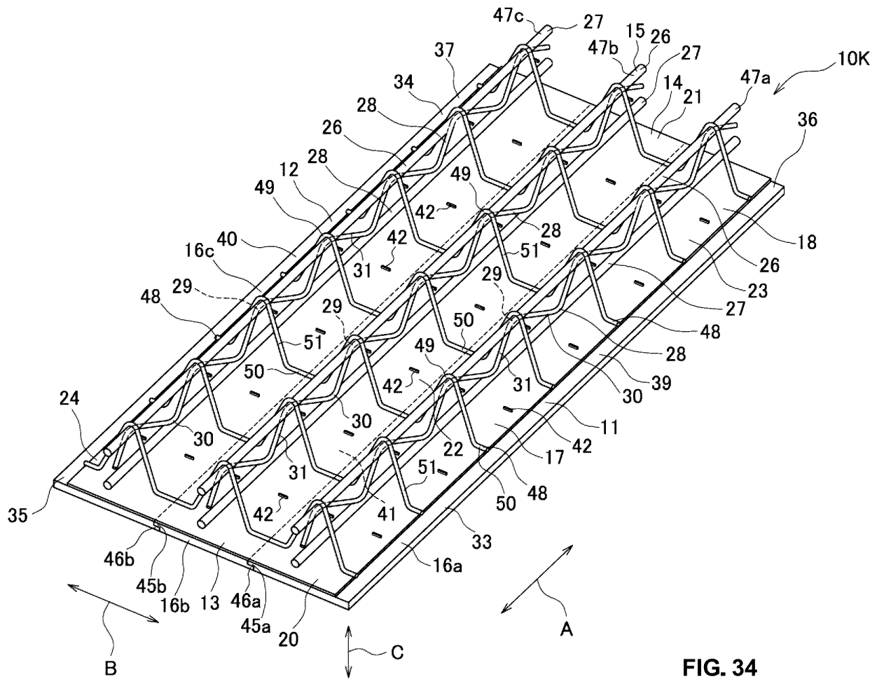

FIG. 30 is a perspective view of the composite deck plate 10J illustrated as an example, and FIG. 31 is a top view of the composite deck plate 10J in FIG. 30. FIG. 32 is a front view of the composite deck plate 10J of FIG. 30, and FIG. 33 is a side view of the composite deck plate 10J of FIG. 30. In FIG. 30, a length direction is indicated by an arrow A, a width direction is indicated by an arrow B, and a vertical direction (thickness direction) is indicated by an arrow C.

The composite deck plate 10J illustrated in FIGS. 30 to 33 is different from the composite deck plate 10G of FIGS. 23 to 25 in that the staples 42 are not used as fixing means, but fixing bolts 58 or fixing screws 58 are used as the fixing means. Since other configurations of the composite deck plate 10J are the same as those of the composite deck plate 10G of FIGS. 23 to 25, a description of the composite deck plate 10G of FIGS. 23 to 25 is cited, and the same reference signs as those in FIGS. 23 to 25 are given. Therefore, a detailed description of the composite deck plate 10J will be omitted.

The composite deck plate 10J has first and second side edge portions 11 and 12 (both side edge portions) that face each other while being separated from each other in the width direction and extend in the length direction, and first and second end edge portions 13 and 14 (both end edge portions) that face each other while being separated from each other in the length direction and extend in the width direction. The composite deck plate 10J includes first to third reinforced deck plates 15 having a predetermined area and extending in the length direction, and first to third wood-based plates 16a to 16c (first to n-th wood-based plates) having a predetermined area and extending in the length direction. The first to third wood-based plates 16a to 16c are the same as those of the composite deck plate 10F.

In the composite deck plate 10J, a first side edge portion 23 of a metal base 17 of the reinforced deck plate 15 and a first side edge portion 33 (first side area 39) of the first wood-based plate 16a overlap each other in the thickness direction in a state where a side edge of the first side edge portion 23 of the metal base 17 of the reinforced deck plate 15 and a side edge of the first side edge portion 33 (first side area 39) of the first wood-based plate 16a coincide with each other. Further, the second side edge portion 24 of the metal base 17 of the reinforced deck plate 15 and the second side edge portion 34 (second side area 40) of the third wood-based plate 16c overlap each other in the thickness direction in a state where a side edge of the second side edge portion 24 of the metal base 17 of the reinforced deck plate 15 and a side edge of the second side edge portion 34 (second side area 40) of the third wood-based plate 16c coincide with each other.

In the composite deck plate 10J, a substantially flat lower surface 25 (facing surface) of the metal base 17 of the reinforced deck plate 15 and substantially flat upper surfaces 37 (facing surfaces) of the first to third wood-based plates 16a to 16c (the wood, plywood, wood-based siding, CLT, oriented strand board (OSB plywood), wood cement board, particle board, or MDF board) overlap (are in contact with) each other, and as illustrated in FIGS. 30 to 33, the metal base 17 and the first to third wood-based plates 16a to 16c are connected and fixed by a plurality of fixing bolts 54 or fixing screws 54 (fixing means) arranged at equal intervals in the length direction, and are connected and fixed by the plurality of fixing bolts 54 or fixing screws 54 (fixing means) arranged at equal intervals in the width direction, and the lower surface 25 of the metal base 17 and the upper surfaces 37 of the first to third wood-based plates 16a to 16c are fixed to each other by an adhesive (not illustrated) applied to the entire lower surface 25 or partially (intermittently) applied to the lower surface 25 of the metal base 17. The fixing bolts 54 or fixing screws 54 may be spaced apart from each other at different intervals in the length direction. In addition, the adhesive may be applied to the entire upper surfaces 37 of the first to third wood-based plates 16a to 16c or partially (intermittently) applied to the upper surfaces 37 of the first to third wood-based plates 16a to 16c.

The fixing bolt 58 or fixing screw 58 has a head portion 59 and a screw portion 60 having a predetermined length, and an adhesive (not illustrated) is applied to the entire screw portion 60. The screw portions 59 of the fixing bolts 58 (pre-coated bolts) or fixing screws 58 (pre-coated screws) are screwed to the first to third wood-based plates 16a to 16c. When the fixing bolts 58 or fixing screws 58 are screwed to the first to third wood-based plates 16a to 16c, the screw portions 60 of the fixing bolts 58 or fixing screws 58 connect the metal base 17 and the first to third wood-based plates 16a to 16c, and the adhesive applied to the entire screw portions 60 firmly adhere the fixing bolts 58 or fixing screws 58 and the first to third wood-based plates 16a to 16c. A screwing depth of the screw portion 60 of the fixing bolt 58 or fixing screw 58 from the upper surface 37 of each of the first to third wood-based plates 16a to 16c into each of the first to third wood-based plates 16a to 16c is at least 50% or more and less than 98% of a thickness dimension of each of the first to third wood-based plates 16a to 16c. The metal base 17 and the first to third wood-based plates 16a to 16c may be connected and fixed by only the fixing bolts 58 or fixing screws 58 (without the adhesive).

In the composite deck plate 10J, similarly to the arrangement of the staples 42 illustrated in FIG. 5, the number of fixing bolts 58 or fixing screws 58 (the number of screwed bolts or screws) screwed in the periphery of the center of a central portion 22 of the metal base 17 may be larger than the number of fixing bolts 58 or fixing screws 58 screwed in the periphery of the remaining portion of the central portion 22 excluding the center of the metal base 17. In addition, the number of fixing bolts 58 or fixing screws 58 (the number of screwed bolts or screws) screwed in the peripheries of (near) end edges of first and second end edge portions 20 and 21 of the metal base 17 may be larger than the number of fixing bolts 58 or fixing screws 58 screwed in the remaining portions of the first and second end edge portions 20 and 21 excluding the periphery of (near) an end edge of the metal base 17. Similarly to the composite deck plate 10J illustrated in FIG. 30, the metal base 17 and the wood-based plate 16 of each of the composite deck plates 10A to 10F and the composite deck plates 10H and 10I may be connected and fixed by the fixing bolts 58 or fixing screws 58 and an adhesive (or without an adhesive in some cases).

The composite deck plate 10J has the following effects in addition to the effects of the composite deck plate 10F. The composite deck plate 10J can firmly connect the lower surface 25 of the metal base 17 and the upper surfaces 37 of the first to third wood-based plates 16a to 16c by fixing the metal base 17 and the first to third wood-based plates 16a to 16c using a large number of fixing bolts 58 or fixing screws 58 and the adhesive (or without an adhesive in some cases).

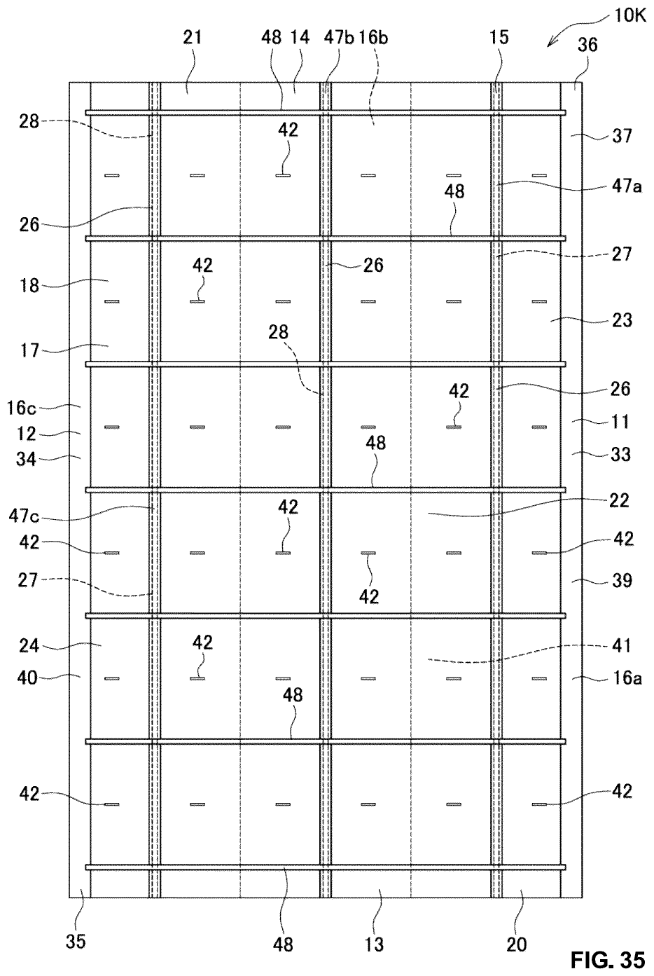

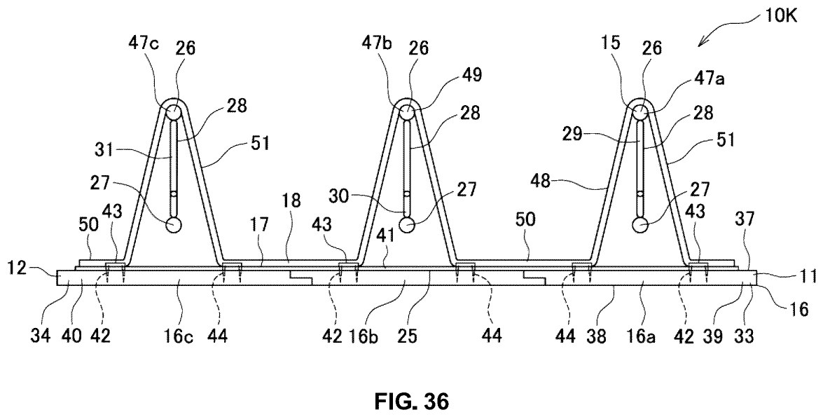

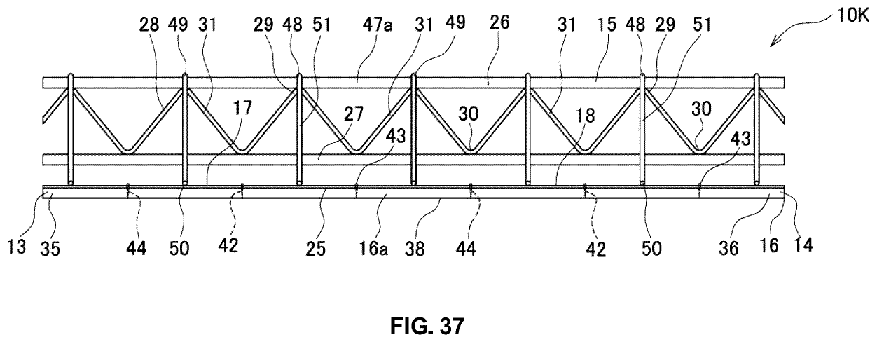

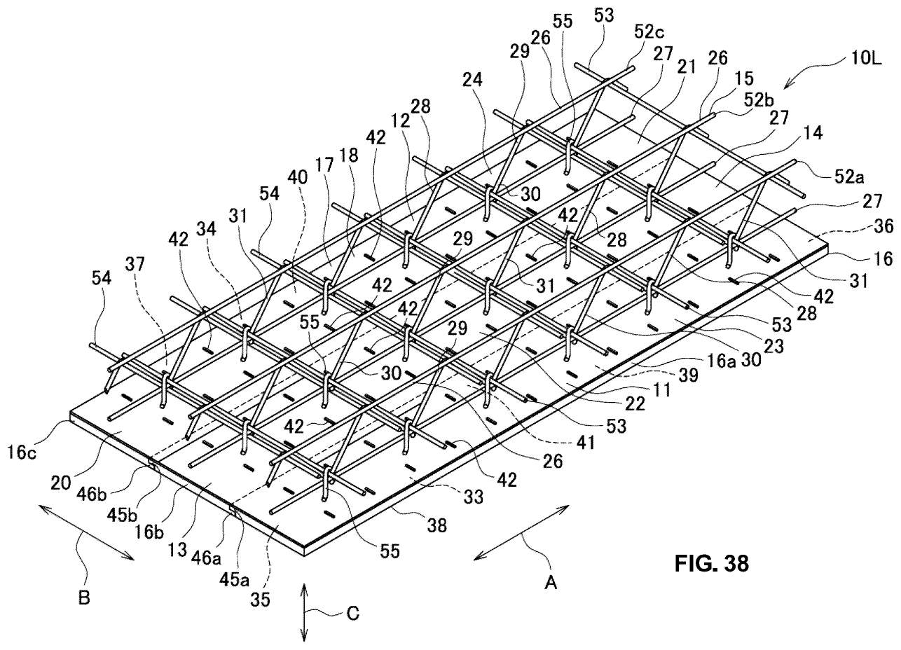

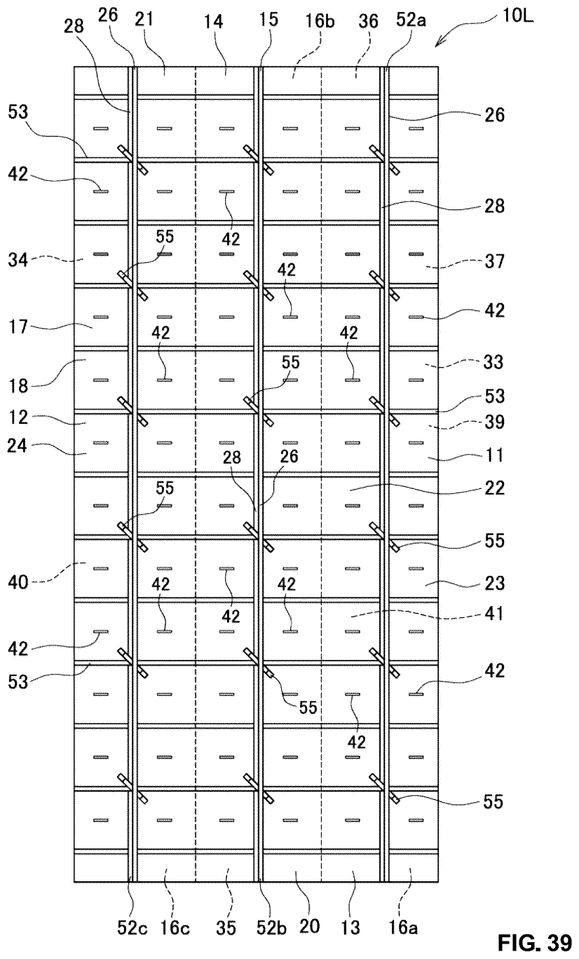

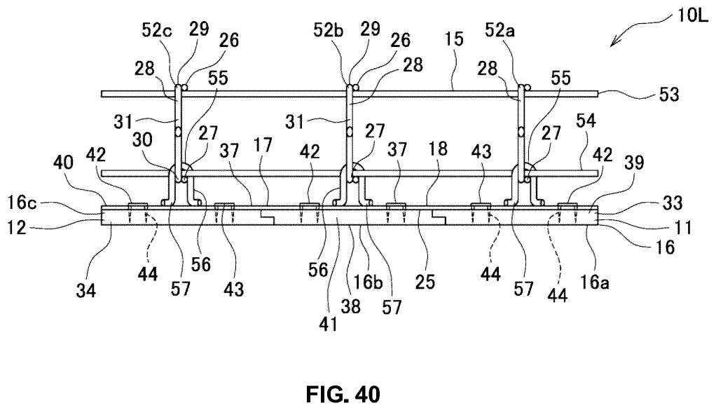

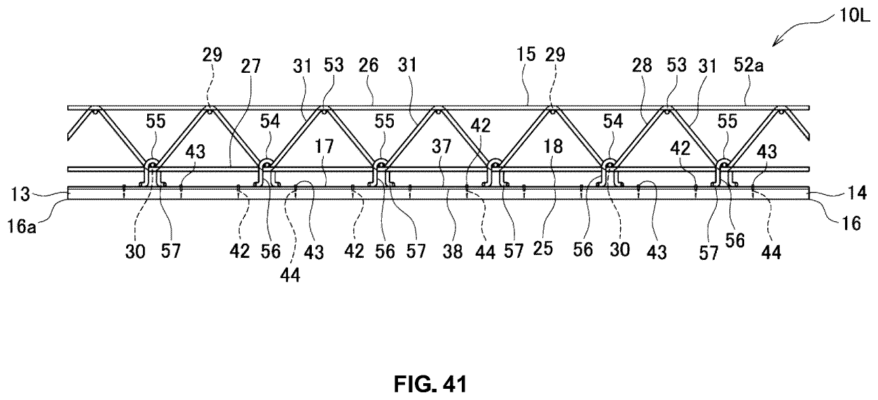

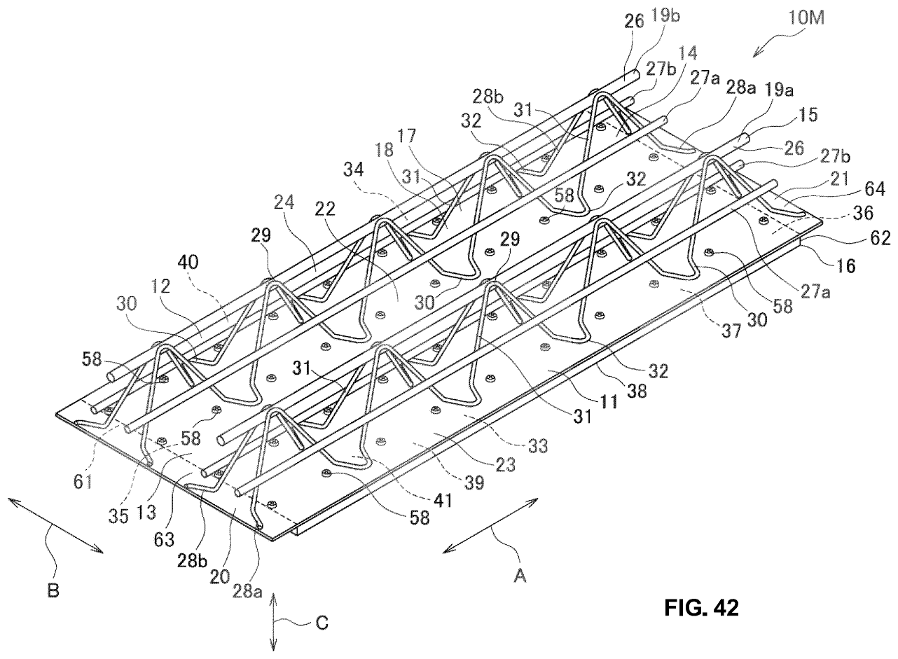

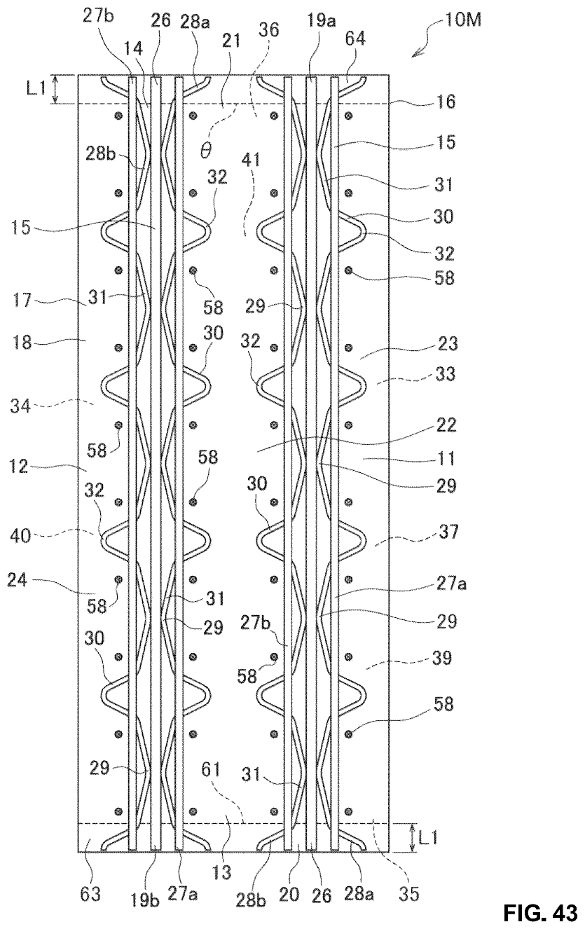

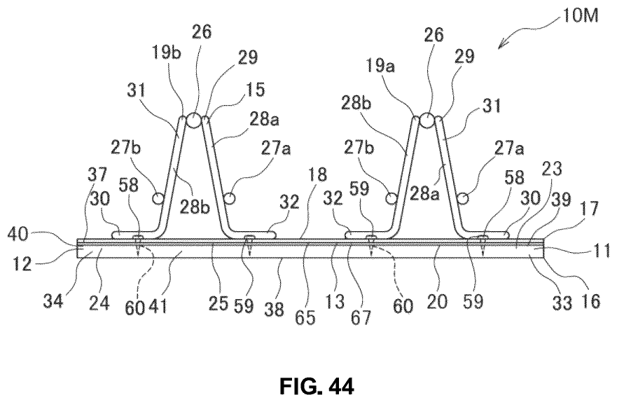

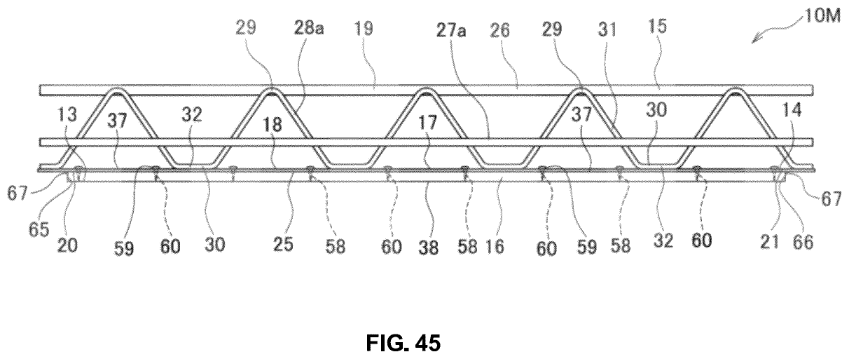

FIG. 34 is a perspective view of the composite deck plate 10K illustrated as an example, and FIG. 35 is a top view of the composite deck plate 10K of FIG. 34. FIG. 36 is a front view of the composite deck plate 10K of FIG. 34, and FIG. 37 is a side view of the composite deck plate 10K of FIG. 34. In FIG. 34, a length direction is indicated by an arrow A, a width direction is indicated by an arrow B, and a vertical direction (thickness direction) is indicated by an arrow C.

The composite deck plate 10K illustrated in FIGS. 34 to 37 has first and second side edge portions 11 and 12 (both side edge portions) that face each other while being separated from each other in the width direction and extend in the length direction, and first and second end edge portions 13 and 14 (both end edge portions) that face each other while being separated from each other in the length direction and extend in the width direction. The composite deck plate 10K includes a reinforced deck plate 15 having a predetermined area and extending in the length direction, and first to third wood-based plates 16a to 16c having a predetermined area extending in the length direction, arranged in the width direction.

The first to third wood-based plates 16a to 16c forming the composite deck plate 10K are the same as those of the composite deck plate 10F illustrated in FIG. 20. The number of wood-based plates 16 is not limited, and similarly to the composite deck plate 10A, one wood-based plate 16 may be used to form the composite deck plate 10K, or two wood-based plates 16 including the first and second wood-based plates 16a and 16b extending in the length direction or four or more wood-based plates 16 including first to n-th wood-based plates 16a to 16n may be used to form the composite deck plate 10K.

Similarly to the composite deck plates 10H and 101, the composite deck plate 10K may include the reinforced deck plate 15 and the first to fifth wood-based plates 16a to 16e having a predetermined area, extending in the width direction, and arranged in the length direction. Also in this case, the number of wood-based plates 16 is not limited, and two wood-based plates 16 including the first and second wood-based plates 16a and 16b extending in the width direction and arranged in the length direction, three wood-based plates 16 including the first to third wood-based plates 16a to 16c extending in the width direction and arranged in the length direction, or four wood-based plates 16 including the first to fourth wood-based plates 16a to 16d extending in the width direction and arranged in the length direction may be used to form the composite deck plate 10K, or six or more wood-based plates 16 including the first to n-th wood-based plates 16a to 16n extending in the width direction and arranged in the length direction may be used to form the composite deck plate 10K.

The reinforced deck plate 15 includes a metal base 17 having a large predetermined area in the length direction, and first to third reinforcing bar truss units 47a to 47c (first to third reinforcing structure) disposed and fixed (installed) on an upper surface 25 of the metal base 17, and is disposed on the first to third wood-based plates 16a to 16c. The first to third reinforcing bar truss units 47a to 47c are disposed between first and second side edge portions 23 and 24 of the metal base 17, are arranged at equal intervals (at predetermined intervals) in the width direction, and extend in the length direction from a first end edge portion 20 toward a second end edge portion 21.

In the composite deck plate 10K, the number of reinforcing bar truss units is not limited, and the number of reinforcing bar truss units to be installed on an upper surface 18 of the metal base 17 can be freely determined according to a size of a ceiling slab to be constructed, a strength required for the ceiling slab, an amount of reinforcing bars required for the ceiling slab, and the like. Two reinforcing bar truss units including the first and second reinforcing bar truss units 47a and 47b (first and second reinforcing structures) may be disposed and fixed (installed) on and to the upper surface 18 of the metal base 17, or four or more reinforcing bar truss units including the first to n-th reinforcing bar truss units 47a to 47n (first to n-th reinforcing structures) may be disposed and fixed (installed) on and to the upper surface 18 of the metal base 17.

Each of the first to third reinforcing bar truss units 47a to 47c (first to third reinforcing structures) includes (is assembled with) one upper end beam 26, one lower end beam 27, one lattice beam 28, and a plurality of connecting beams 48 connecting the upper end beams 26. The upper end beams 26 of the first to third reinforcing bar truss units 47a to 47c are made of iron bars obtained by extending iron. A deformed iron bar (deformed reinforcing bar) having a plurality of ribs on a peripheral surface thereof is used as the upper end beam 26. The upper end beam 26 is disposed between the first and second side edge portions 23 and 24 of the metal base 17, and linearly extends in the length direction while being spaced upward at a predetermined interval from the upper surface 18 of the metal base 17. In the first to third reinforcing bar truss units 47a to 47c, dimensions of the upper end beams 26 arranged in the width direction in the length direction are substantially the same, and the upper end beams 26 are arranged in parallel.

The lower end beams 27 of the first to third reinforcing bar truss units 47a to 47c are made of iron bars obtained by extending iron. Deformed metal bars (deformed reinforcing bars) having a plurality of ribs on peripheral surfaces thereof are used as the lower end beams 27. The lower end beam 27 is disposed between the first and second side edge portions 23 and 24 of the metal base 17 and below (immediately below) the upper end beam 26. The lower end beam 27 is spaced upward at a predetermined interval from the upper surface 18 of the metal base 17 and linearly extends in the length direction. In the first to third reinforcing bar truss units 47a to 47c, dimensions of the lower end beams 27 arranged in the width direction in the length direction are substantially the same, and the lower end beams 27 are arranged in parallel.

The lattice beams 28 of the first to third reinforcing bar truss units 47a to 47c are made of iron rods obtained by extending iron. The lattice beam 28 is disposed between the first and second side edge portions 23 and 24 of the metal base 17 and between the upper end beam 26 and the lower end beam 27. The lattice beam 28 is spaced upward at a predetermined interval from the upper surface 18 of the metal base 17, and extends in the length direction between the upper end beam 26 and the lower end beam 27 while being repeatedly bent (undulating) in a wave shape in the vertical direction. The lattice beam 28 includes an upper end protrusion 29 positioned adjacent to the upper end beam 26 and forming an arc in such a way as to protrude upward, a lower end recess 30 positioned adjacent to the lower end beam 27 and forming an arc in such a way as to be recessed downward, and a middle portion 31 extending obliquely in the length direction between the upper end protrusion 29 and the lower end recess 30.

An angle at which the lattice beam 28 is repeatedly bent in a wave shape in the vertical direction (the number of times that the lattice beam 28 is repeatedly bent in a wave shape in the vertical direction per unit length) can be freely changed. In a state where the upper end protrusion 29 of the lattice beam 28 is in contact with a circumferential surface of the upper end beam 26, a portion (intersecting portion) of the upper end protrusion 29 that intersects the upper end beam 26 is welded (fixed) to the upper end beam 26 by spot welding. In a state where the lower end recess 30 of the lattice beam 28 is in contact with a circumferential surface of the lower end beam 27, a portion (intersecting portion) of the lower end recess 30 that intersects the lower end beam 27 is welded (fixed) to the lower end beam 27 by spot welding.

The connecting beams 48 of the first to third reinforcing bar truss units 47a to 47c are arranged at equal intervals (predetermined intervals) in the length direction, and extend in the width direction while being repeatedly bent (undulating) in a wave shape in the vertical direction. The connecting beam 48 includes an upper end portion 49 that is spaced upward at a predetermined interval from the upper surface 18 of the metal base 17 and is in contact with the circumferential surface of the upper end beam 26 in such a way as to straddle the upper end beam 26, a lower end portion 50 that is bent outward in the width direction in such a way as to be parallel to the upper surface 18 of the metal base 17, and a middle portion 51 that extends obliquely in the vertical direction between the upper end portion 46 and the lower end portion 47. A portion (contact portion) of the upper end portion 49 of the connecting beam 48 that in contact with the circumferential surface of the upper end beam 26 is welded (fixed) to the upper end beam 26 by spot welding. A portion (contact portion) of the lower end portion 50 of the connecting beam 48 that is in contact with the metal base 17 is welded and fixed (bonded) to the metal base 17 by spot welding.

Thicknesses of the upper end beam 26, the lower end beam 27, the lattice beam 28, and the connecting beam 48 of each of the first to third reinforcing bar truss units 47a to 47c are not particularly limited, and the thicknesses of the upper end beam 26, the lower end beam 27, the lattice beam 28, and the connecting beam 48 can be freely changed according to the size of the ceiling slab to be constructed, the strength required for the ceiling slab, the amount of the reinforcing bars required for the ceiling slab, and the like. The upper end beam 26, the lower end beam 27, the lattice beam 28, and the connecting beam 48 are made of iron, but can also be made of metal other than iron. Further, in a case where the upper end beam 26, the lower end beam 27, the lattice beam 28, and the connecting beam 48 are made of iron, rust prevention treatment such as plating may be performed on the upper end beam 26, the lower end beam 27, the lattice beam 28, and the connecting beam 48.

In the composite deck plate 10K, the reinforced deck plate 15 extending in the length direction is disposed on the first to third wood-based plates 16a to 16c extending in the length direction. At the first side edge portion 11 (one side edge portion) of the composite deck plate 10K, the first side edge portion 33 (first side area 39) of the first wood-based plate 16a extends outward in the width direction from the first side edge portion 23 of the metal base 17 of the reinforced deck plate 15, and an upper surface 37 of the first side edge portion 33 (first side area 39) of the first wood-based plate 16a (the wood, plywood, wood-based siding, CLT, oriented strand board (OSB plywood), wood cement board, particle board, or MDF board) is exposed.

At the second side edge portion 12 (the other side edge portion) of the composite deck plate 10K, the second side edge portion 34 (second side area 40) of the third wood-based plate 16c extends outward in the width direction from the second side edge portion 21 of the metal base 17 of the reinforced deck plate 15, and an upper surface 37 of the second side edge portion 34 (second side area 40) of the third wood-based plate 16c (the wood, plywood, wood-based siding, CLT, oriented strand board (OSB plywood), wood cement board, particle board, or MDF board) is exposed. A center area 41 positioned between the first side edge portion 33 (first side area 39) of the first wood-based plate 16a and the second side edge portion 34 (second side area 40) of the third wood-based plate 16c is positioned on a lower surface 25 of the metal base 17 to conceal the metal base 17.

In the composite deck plate 10K, the substantially flat lower surface 25 (facing surface) of the metal base 17 of the reinforced deck plate 15 and the substantially flat upper surfaces 37 (facing surfaces) of the first to third wood-based plates 16a to 16c (the wood, plywood, wood-based siding, CLT, oriented strand board (OSB plywood), wood cement board, particle board, or MDF board) overlap (are in contact with) each other, and as illustrated in FIGS. 30 to 33, the metal base 17 and the first to third wood-based plates 16a to 16c are connected and fixed by a plurality of staples 42 (fixing means). Arrangement of the staples 42 in the metal base 17 is the same as the arrangement of the staples 42 in the metal base 17 of the composite deck plate 10D illustrated in FIGS. 14 to 16.

In the composite deck plate 10K, when the staples 42 are applied into the first to third wood-based plates 16a to 16c, the leg portions 41 of the staples 42 connect the metal base 17 and the first to third wood-based plates 16a to 16c, and an adhesive applied to the entire shoulder portions 43 and the entire leg portions 44 of the staples 42, the entire leg portions 44 of the staples 42, or the lower half of the leg portions 44 of the staples 42 firmly adheres the staples 42 and the first to third wood-based plates 16a to 16c. The staples 42 may be spaced apart from each other (randomly) at different intervals in the length direction.

In the composite deck plate 10K, similarly to the composite deck plate 10G of FIG. 23, the first side edge portion 23 of the metal base 17 of the reinforced deck plate 15 and the first side edge portion 33 (first side area 39) of the first wood-based plate 16a may overlap each other in the thickness direction in a state where a side edge of the first side edge portion 23 of the metal base 17 and a side edge of the first side edge portion 33 (first side area 39) of the first wood-based plate 16a coincide with each other, or the second side edge portion 24 of the metal base 17 and the second side edge portion 34 (second side area 40) of the third wood-based plate 16c may overlap each other in the thickness direction in a state where a side edge of the second side edge portion 24 of the metal base 17 of the reinforced deck plate 15 and a side edge of the second side edge portion 34 (second side area 40) of the third wood-based plate 16c coincide with each other.

In the composite deck plate 10K, the first to third wood-based plates 16a to 16c may be connected and fixed to lower surfaces of the first and second side edge portions 23 and 24 and the central portion 22 of the metal base 17 by the staples 42 (fixing means) arranged as illustrated in FIG. 5, or the first to third wood-based plates 16a to 16c may be connected and fixed to the lower surfaces of the first and second side edge portions 23 and 24 and the central portion 22 of the metal base 17 by the staples 42 (fixing means) arranged as illustrated in FIG. 6.

Alternatively, the first to third wood-based plates 16a to 16c may be connected and fixed to the lower surfaces of the first and second side edge portions 23 and 24 and the central portion 22 of the metal base 17 by the staples 42 (fixing means) arranged as illustrated in FIG. 7.

Similarly to the composite deck plate 10J illustrated in FIG. 30, the metal base 17 and the first to third wood-based plates 16a to 16c of the composite deck plate 10K may be connected and fixed by the fixing bolts 58 or fixing screws 58, or the metal base 17 and the first to third wood-based plates 16a to 16c of the composite deck plate 10K may be connected and fixed by the fixing bolts 58 or fixing screws 58 and the adhesive.

The composite deck plate 10K has the following effects in addition to the effects of the composite deck plate 10D illustrated in FIGS. 14 to 16. In the composite deck plate 10K, the first to third wood-based plates 16a to 16c (first to n-th wood-based plates) extending in the length direction are fixed to the lower surface 25 of the metal base 17 of the reinforced deck plate 15 by the plurality of staples 42 (predetermined fixing means), and the first to third wood-based plates 16a to 16c are exposed on a lower side of the composite deck plate 10K to form the ceiling surface of the building. Therefore, an appealing design of the first to third wood-based plates 16a to 16c extending in the length direction can be incorporated into the ceiling surface, so that a ceiling surface that provides a viewer with aesthetic appeal, comfort, warmth, and tranquility offered by the first to third wood-based plates 16a to 16c which are natural materials can be formed. For the composite deck plate 10K, the first to third wood-based plates 16a to 16c (first to n-th wood-based plates), which are sustainable circulation-type resources, are used, so that forest resources can be effectively utilized, and the environmental load can be reduced by contributing to reduction of CO².

FIG. 38 is a perspective view of the composite deck plate 10L illustrated as an example, and FIG. 39 is a top view of the composite deck plate 10L of FIG. 38. FIG. 40 is a front view of the composite deck plate 10L of FIG. 38, and FIG. 41 is a side view of the composite deck plate 10L of FIG. 38. In FIG. 38, a length direction is indicated by an arrow A, a width direction is indicated by an arrow B, and a vertical direction (thickness direction) is indicated by an arrow C.

The composite deck plate 10L illustrated in FIGS. 38 to 41 has first and second side edge portions 11 and 12 (both side edge portions) that face each other while being separated from each other in the width direction and extend in the length direction, and first and second end edge portions 13 and 14 (both end edge portions) that face each other while being separated from each other in the length direction and extend in the width direction. The composite deck plate 10L includes a reinforced deck plate 15 having a predetermined area and extending in the length direction, and first to third wood-based plates 16a to 16c having a predetermined area extending in the length direction, arranged in the width direction.

The first to third wood-based plates 16a to 16c forming the composite deck plate 10L are the same as those of the composite deck plate 10F illustrated in FIG. 20. The number of wood-based plates 16 is not limited, and similarly to the composite deck plate 10A, one wood-based plate 16 may be used to form the composite deck plate 10L, or two wood-based plates 16 including the first and second wood-based plates 16a and 16b extending in the length direction or four or more wood-based plates 16 including first to n-th wood-based plates 16a to 16n may be used to form the composite deck plate 10L.

Similarly to the composite deck plates 10H and 101, the composite deck plate 10L may include the reinforced deck plate 15 and the first to fifth wood-based plates 16a to 16e having a predetermined area, extending in the width direction, and arranged in the length direction. Also in this case, the number of wood-based plates 16 is not limited, and two wood-based plates 16 including the first and second wood-based plates 16a and 16b extending in the width direction and arranged in the length direction, three wood-based plates 16 including the first to third wood-based plates 16a to 16c extending in the width direction and arranged in the length direction, or four wood-based plates 16 including the first to fourth wood-based plates 16a to 16d extending in the width direction and arranged in the length direction may be used to form the composite deck plate 10L, or six or more wood-based plates 16 including the first to n-th wood-based plates 16a to 16d extending in the width direction and arranged in the length direction may be used to form the composite deck plate 10L.

The reinforced deck plate 15 includes a metal base 17 having a large predetermined area in the length direction, and first to third reinforcing bar truss units 52a to 52c (first to third reinforcing structure) disposed and fixed (installed) on an upper surface 25 of the metal base 17, and is disposed on the first to third wood-based plates 16a to 16c. The first to third reinforcing bar truss units 52a to 52c are disposed between first and second side edge portions 23 and 24 of the metal base 17, are arranged at equal intervals (at predetermined intervals) in the width direction, and extend in the length direction from a first end edge portion 20 toward a second end edge portion 21.

In the composite deck plate 10L, the number of reinforcing bar truss units is not limited, and the number of reinforcing bar truss units to be installed on an upper surface 18 of the metal base 17 can be freely determined according to a size of a ceiling slab to be constructed, a strength required for the ceiling slab, an amount of reinforcing bars required for the ceiling slab, and the like. Two reinforcing bar truss units including the first and second reinforcing bar truss units 52a and 52b (first and second reinforcing structures) may be disposed and fixed (installed) on and to the upper surface 18 of the metal base 17, or four or more reinforcing bar truss units including the first to n-th reinforcing bar truss units 52a to 52n (first to n-th reinforcing structures) may be disposed and fixed (installed) on and to the upper surface 18 of the metal base 17.

Each of the first to third reinforcing bar truss units 52a to 52c (first to third reinforcing structures) includes (is assembled with) one upper end beam 26, one lower end beam 27, one lattice beam 28, a plurality of upper lateral beams 53, a plurality of lower lateral beams 54, and a plurality of connecting members 55 (spacers). The upper end beams 26 of the first to third reinforcing bar truss units 52a to 52c are made of iron bars obtained by extending iron. A deformed iron bar (deformed reinforcing bar) having a plurality of ribs on a peripheral surface thereof is used as the upper end beam 26. The upper end beam 26 is disposed between the first and second side edge portions 23 and 24 of the metal base 17, and linearly extends in the length direction while being spaced upward at a predetermined interval from the upper surface 18 of the metal base 17. In the first to third reinforcing bar truss units 52a to 52c, dimensions of the upper end beams 26 arranged in the width direction in the length direction are substantially the same, and the upper end beams 26 are arranged in parallel.

The lower end beams 27 of the first to third reinforcing bar truss units 52a to 52c are made of iron bars obtained by extending iron. Deformed metal bars (deformed reinforcing bars) having a plurality of ribs on peripheral surfaces thereof are used as the lower end beams 27. The lower end beam 27 is disposed between the first and second side edge portions 23 and 24 of the metal base 17 and below (immediately below) the upper end beam 26. The lower end beam 27 is spaced upward at a predetermined interval from the upper surface 18 of the metal base 17 and linearly extends in the length direction. In the first to third reinforcing bar truss units 52a to 52c, dimensions of the lower end beams 27 arranged in the width direction in the length direction are substantially the same, and the lower end beams 27 are arranged in parallel.

The lattice beams 28 of the first to third reinforcing bar truss units 52a to 52c are made of iron rods obtained by extending iron. The lattice beam 28 is disposed between the first and second side edge portions 23 and 24 of the metal base 17 and between the upper end beam 26 and the lower end beam 27. The lattice beam 28 is spaced upward at a predetermined interval from the upper surface 18 of the metal base 17, and extends in the length direction between the upper end beam 26 and the lower end beam 27 while being repeatedly bent (undulating) in a wave shape in the vertical direction. The lattice beam 28 includes an upper end protrusion 29 positioned adjacent to the upper end beam 26 and forming an arc in such a way as to protrude upward, a lower end recess 30 positioned adjacent to the lower end beam 27 and forming an arc in such a way as to be recessed downward, and a middle portion 31 extending obliquely in the length direction between the upper end protrusion 29 and the lower end recess 30.

An angle at which the lattice beam 28 is repeatedly bent in a wave shape in the vertical direction (the number of times that the lattice beam 28 is repeatedly bent in a wave shape in the vertical direction per unit length) can be freely changed. In a state where the upper end protrusion 29 of the lattice beam 28 is in contact with a circumferential surface of the upper end beam 26, a portion (intersecting portion) of the upper end protrusion 29 that intersects the upper end beam 26 is welded (fixed) to the upper end beam 26 by spot welding. In a state where the lower end recess 30 of the lattice beam 28 is in contact with a circumferential surface of the lower end beam 27, a portion (intersecting portion) of the lower end recess 30 that intersects the lower end beam 27 is welded (fixed) to the lower end beam 27 by spot welding.

The upper lateral beams 53 of the first to third reinforcing bar truss units 52a to 52c are made of iron bars obtained by extending iron. Deformed metal bars (deformed reinforcing bars) having a plurality of ribs on peripheral surfaces thereof are used as the upper lateral beams 53. The upper lateral beams 53 are spaced upward at a predetermined interval from the upper surface 18 of the metal base 17, and extend in the width direction while being spaced apart from each other at equal intervals in the length direction and arranged in parallel. The upper lateral beam 53 is positioned immediately below the upper end beams 26 and the upper end protrusions 29 of the lattice beams 28, connects the upper end beams 26 arranged in the width direction, and connects the upper end protrusions 29 of the lattice beams 28 arranged in the width direction. A portion (intersecting portion) of the upper lateral beam 53 that intersects the upper end beam 26 and the upper end protrusion 29 of the lattice beam 28 is welded (fixed) to the upper end beam 26 and the lattice beam 28 by spot welding.

The lower lateral beams 50 of the first to third reinforcing bar truss units 52a to 52c are made of iron bars obtained by extending iron. Deformed metal bars (deformed reinforcing bars) having a plurality of ribs on peripheral surfaces thereof are used as the lower lateral beams 50. The lower lateral beams 50 are spaced upward at a predetermined interval from the upper surface 18 of the metal base 17, and extend in the width direction while being spaced apart from each other at equal intervals in the length direction and arranged in parallel. The lower lateral beam 50 is positioned immediately above the lower end beam 27 and the lower end recess 30 of the lattice beam 28, connects the lower end beams 27 arranged in the width direction, and connects the lower end recesses 30 of the lattice beams 28 arranged in the width direction. A portion (intersecting portion) of the lower lateral beam 50 that intersects the lower end beam 27 and the lower end recess 30 of the lattice beam 28 is welded (fixed) to the lower end beam 27 and the lattice beam 28 by spot welding.

Each of the connecting members 55 (spacers) of the first to third reinforcing bar truss units 52a to 52c is made of an iron bar, has a hook portion 56 that protrudes upward in the vertical direction and forms an arc, and leg portions 57 extending from both ends of the hook portion 56 in the width direction, and connects and fixes the reinforcing bar truss unit 19 to the metal base 17. The hook portion 56 of the connecting member 55 is disposed at a position where the lower end beam 27, the lower end recess 30 of the lattice beam 28, and the lower lateral beam 54 intersect one another, and straddles the lower end beam 27, the lower end recess 30 of the lattice beam 28, and the lower lateral beam 54. A portion (intersecting portion) of the hook portion 56 of the connecting member 55 that intersects the lower lateral beam 54 or a portion (intersecting portion) of the hook portion 56 that intersects the lower end recess 30 of the lattice beam 28 is welded (fixed) to the lower lateral beam 54 or the lattice beam 28 by spot welding. The leg portions 57 of the connecting member 55 are in contact with the upper surface 18 of the metal base 17 and are welded (fixed) to the upper surface 18 of the metal base 17 by spot welding.

The lower lateral beam 54 does not have to be attached in the first to third reinforcing bar truss units 52a to 52c. In this case, a portion (intersecting portion) of the hook portion 56 of the connecting member 55 that straddles the lower end beam 27 and the lower end recess 30 of the lattice beam 28 and intersects the lower end recess 30 of the lattice beam 28 is welded (fixed) to the lattice beam 28 by spot welding. Thicknesses of the upper end beam 26, the lower end beam 27, the lattice beam 28, the upper lateral beam 53, and the lower lateral beam 54 are not particularly limited, and the thicknesses of the upper end beam 26, the lower end beam 27, the lattice beam 28, the upper lateral beam 53, and the lower lateral beam 54 can be freely changed according to a size of a ceiling slab to be constructed, a strength required for the ceiling slab, an amount of reinforcing bars required for the ceiling slab, and the like. The upper end beam 26, the lower end beam 27, the lattice beam 28, the upper lateral beam 53, and the lower lateral beam 54 are made of iron, but can also be made of metal other than iron. In a case where the upper end beam 26, the lower end beam 27, the lattice beam 28, the upper lateral beam 53, and the lower lateral beam 54 are made of iron, rust prevention treatment such as plating may be performed on the upper end beam 26, the lower end beam 27, the lattice beam 28, the upper lateral beam 53, and the lower lateral beam 54.

In the composite deck plate 10L, similarly to the composite deck plate 10G of FIG. 23, the first side edge portion 23 of the metal base 17 and the first side edge portion 33 (first side area 39) of the first wood-based plate 16a overlap each other in the thickness direction in a state where a side edge of the first side edge portion 23 of the metal base 17 of the reinforced deck plate 15 and a side edge of the first side edge portion 33 (first side area 42) of the first wood-based plate 16a coincide with each other. Further, the second side edge portion 24 of the metal base 17 and the second side edge portion 34 (second side area 43) of the third wood-based plate 16c overlap each other in the thickness direction in a state where a side edge of the second side edge portion 24 of the metal base 17 of the reinforced deck plate 15 and a side edge of the second side edge portion 34 (second side area 43) of the third wood-based plate 16c coincide with each other.

In the composite deck plate 10L, the reinforced deck plate 15 extending in the length direction is disposed on the first to third wood-based plates 16a to 16c extending in the length direction. In the composite deck plate 10L, the substantially flat lower surface 25 (facing surface) of the metal base 17 of the reinforced deck plate 15 and the substantially flat upper surfaces 37 (facing surfaces) of the first to third wood-based plates 16a to 16c (the wood, plywood, wood-based siding, CLT, oriented strand board (OSB plywood), wood cement board, particle board, or MDF board) overlap (are in contact with) each other, and as illustrated in FIGS. 34 to 37, the metal base 17 and the first to third wood-based plates 16a to 16c are connected and fixed by a plurality of staples 42 (fixing means). Arrangement of the staples 42 in the metal base 17 is the same as the arrangement of the staples 42 in the metal base 17 of the composite deck plate 10D illustrated in FIGS. 14 to 16.

In the composite deck plate 10L, when the staples 42 are applied into the first to third wood-based plates 16a to 16c, the leg portions 44 of the staples 42 connect the metal base 17 and the first to third wood-based plates 16a to 16c, and an adhesive applied to the entire shoulder portions 43 and the entire leg portions 44 of the staples 42, the entire leg portions 44 of the staples 42, or the lower half of the leg portions 44 of the staples 42 firmly adheres the staples 42 and the first to third wood-based plates 16a to 16c. The staples 42 may be spaced apart from each other (randomly) at different intervals in the length direction.

At the first side edge portion 11 (one side edge portion) of the composite deck plate 10L, the first side edge portion 33 (first side area 39) of the first wood-based plate 16a may extend outward in the width direction from the first side edge portion 23 of the metal base 17 of the reinforced deck plate 15, and an upper surface 37 of the first side edge portion 33 (first side area 39) of the first wood-based plate 16a (the wood, plywood, wood-based siding, CLT, oriented strand board (OSB plywood), wood cement board, particle board, or MDF board) may be exposed.

At the second side edge portion 12 (the other side edge portion) of the composite deck plate 10L, the second side edge portion 34 (second side area 40) of the third wood-based plate 16c may extend outward in the width direction from the second side edge portion 21 of the metal base 17 of the reinforced deck plate 15, and an upper surface 37 of the second side edge portion 34 (second side area 40) of the third wood-based plate 16c (the wood, plywood, wood-based siding, CLT, oriented strand board (OSB plywood), wood cement board, particle board, or MDF board) may be exposed. Here, a center area 41 positioned between the first side edge portion 33 (first side area 39) of the first wood-based plate 16a and the second side edge portion 34 (second side area 40) of the third wood-based plate 16c is positioned on a lower surface 25 of the metal base 17 to conceal the metal base 17.

In the composite deck plate 10L, the first to third wood-based plates 16a to 16c may be connected and fixed to lower surfaces of the first and second side edge portions 23 and 24 and the central portion 22 of the metal base 17 by the staples 42 (fixing means) arranged as illustrated in FIG. 5, or the first to third wood-based plates 16a to 16c may be connected and fixed to the lower surfaces of the first and second side edge portions 23 and 24 and the central portion 22 of the metal base 17 by the staples 42 (fixing means) arranged as illustrated in FIG. 6.

Alternatively, the first to third wood-based plates 16a to 16c may be connected and fixed to the lower surfaces of the first and second side edge portions 23 and 24 and the central portion 22 of the metal base 17 by the staples 42 (fixing means) arranged as illustrated in FIG. 7.

Similarly to the composite deck plate 10J illustrated in FIG. 30, the metal base 17 and the first to third wood-based plates 16a to 16c of the composite deck plate 10L may be connected and fixed by the fixing bolts 58 or fixing screws 58, or the metal base 17 and the first to third wood-based plates 16a to 16c of the composite deck plate 10L may be connected and fixed by the fixing bolts 58 or fixing screws 58 and the adhesive.

The composite deck plate 10L has the following effects in addition to the effects of the composite deck plate 10D illustrated in FIGS. 14 to 16. In the composite deck plate 10L, the first to third wood-based plates 16a to 16c (first to n-th wood-based plates) extending in the length direction are fixed to the lower surface 25 of the metal base 17 of the reinforced deck plate 15 by the plurality of staples 42 (predetermined fixing means), and the first to third wood-based plates 16a to 16c are exposed on a lower side of the composite deck plate 10L to form the ceiling surface of the building. Therefore, an appealing design of the first to third wood-based plates 16a to 16c extending in the length direction can be incorporated into the ceiling surface, so that a ceiling surface that provides a viewer with aesthetic appeal, comfort, warmth, and tranquility offered by the first to third wood-based plates 16a to 16c which are natural materials can be formed. For the composite deck plate 10L, the first to third wood-based plates 16a to 16c (first to n-th wood-based plates), which are sustainable circulation-type resources, are used, so that forest resources can be effectively utilized, and the environmental load can be reduced by contributing to reduction of CO².

FIG. 42 is a perspective view of the composite deck plate 10M illustrated as an example, FIG. 43 is a top view of the composite deck plate 10M of FIG. 42, FIG. 44 is a front view of the composite deck plate 10M of FIG. 42, and FIG. 45 is a side view of the composite deck plate 10M of FIG. 42. In FIG. 42, a length direction is indicated by an arrow A, a width direction is indicated by an arrow B, and a vertical direction (thickness direction) is indicated by an arrow C.

The composite deck plate 10M illustrated in FIGS. 42 to 45 includes two reinforced deck plates 15 having a predetermined area (deck plates with reinforcing bar trusses) and one wood-based plate 16 having a predetermined area. The reinforced deck plates 15 are the same as that in FIG. 1, and each includes a metal base 17 having a large predetermined area in the length direction and disposed on the wood-based plate 16, and a reinforcing bar truss unit 19 (reinforcing structure) disposed and fixed (installed) on and to an upper surface 18 of the metal base 17.

The metal base 17 has a first end edge portion 20 and a second end edge portion 21 that face each other while being spaced apart from each other in the length direction and extend in the width direction, a central portion 22 positioned between the first end edge portion 20 and the second end edge portion 21, a first side edge portion 23 extending in the length direction, and a second side edge portion 24 positioned opposite to the first side edge portion 23 and extending in the length direction, and has the substantially flat upper surface 18 and a substantially flat lower surface 25. The reinforcing bar truss unit 19 (reinforcing structure) is disposed between the first and second side edge portions 23 and 24 of the metal base 17 and extends in the length direction from the first end edge portion 20 toward the second end edge portion 21. The reinforcing bar truss unit 19 includes (is assembled with) one upper end beam 26, two (a pair of) first and second lower end beams 27a and 27b, and two (a pair of) first and second lattice beams 28a and 28b. The upper end beam 26, the first and second lower end beams 27a and 27b, and the first and second lattice beams 28a and 28b are the same as those in FIG. 1.

In the composite deck plate 10M, the first side edge portion 23 of the metal base 17 of the reinforced deck plate 15 and the first side edge portion 33 (first side area 39) of the wood-based plate 16 overlap each other in the thickness direction in a state where a side edge of the first side edge portion 23 of the metal base 17 of the reinforced deck plate 15 and a side edge of the first side edge portion 33 (first side area 39) of the wood-based plate 16 coincide with each other. Further, the second side edge portion 24 of the metal base 17 of the reinforced deck plate 15 and the second side edge portion 34 (second side area 40) of the wood-based plate 16 overlap each other in the thickness direction in a state where a side edge of the second side edge portion 24 of the metal base 17 of the reinforced deck plate 15 and a side edge of the second side edge portion 34 (second side area 40) of the third wood-based plate 16 coincide with each other.

In the composite deck plate 10M, the first end edge portion 20 of the metal base 17 of the reinforced deck plate 15 extends by a predetermined dimension outward in the length direction from an end edge 61 (first end) of a first end edge portion 35 of the wood-based plate 16 to form a first extending portion 63, and the second end edge portion 21 of the metal base 17 of the reinforced deck plate 15 extends by a predetermined dimension outward in the length direction from an end edge 62 (second end) of a second end edge portion 36 of the wood-based plate 16 to form a second extending portion 64. Further, the upper end beams 26, the first and second lower end beams 27a and 27b, and the first and second lattice beams 28a and 28b of the reinforced deck plate 15 extend outward in the length direction by a predetermined dimension from the end edge 61 (first end) of the first end edge portion 35 of the wood-based plate 16, and the upper end beams 26, the first and second lower end beams 27a and 27b, and the first and second lattice beams 28a and 28b of the reinforced deck plate 15 extend outward in the length direction by a predetermined dimension from the end edge end edge 62 (second end) of the second end edge portion 36 of the wood-based plate 16. In the first extending portion 63 and the second extending portion 64, a lower side portion of a middle portion 31 of each of the first and second lattice beams 28a and 28b and a half of a bent portion 32 formed at a lower end recess 30 of each of the first and second lattice beams 28a and 28b are positioned.

An extension dimension L1 of the first extending portion 63 of the metal base 17 (the first end edge portion 20 of the metal base 17) extending outward in the length direction from the end edge 61 (first end) of the first end edge portion 35 of the wood-based plate 16 and an extension dimension L1 of the second extending portion 64 of the metal base 17 (the second end edge portion 21 of the metal base 17) extending outward in the length direction from the end edge 62 (second end) of the second end edge portion 36 of the wood-based plate 16 are in a range of 5 to 150 mm. Extension dimensions of the upper end beams 26, the first and second lower end beams 27a and 27b extending outward in the length direction from the end edge 61 (first end) of the first end edge portion 35 of the wood-based plate 16, and extension dimensions of the upper end beams 26, the first and second lower end beams 27a and 27b extending outward in the length direction from the end edge 62 (second end) of the second end edge portion 36 of the wood-based plate 16 are in a range of 5 to 150 mm.

A waterproofing material 67 is applied to an entire first point 65 in the width direction, the first point 65 being a point where the end edge 61 (first end) of the first end edge portion 35 of the wood-based plate 16 is in contact with the lower surface 25 of the first extending portion 63 (first end edge portion 20) of the metal base 17, and waterproofing is applied to close a gap between an upper surface 37 of the wood-based plate 16 and the lower surface 25 of the metal base 17. The waterproofing material 67 is applied to an entire second point 66 in the width direction, the second point 66 being a point where the end edge 62 (second end) of the second end edge portion 36 of the wood-based plate 16 and the lower surface 25 of the second extending portion 64 (second end edge portion 21) of the metal base 17 are in contact with each other, and waterproofing is applied to close a gap between the upper surface 37 of the wood-based plate 16 and the lower surface 25 of the metal base 17. The waterproofing material 67 does not have to be applied to the first point 63 and the second point 64.

In the composite deck plate 10M, the substantially flat lower surface 25 (facing surface) of the metal base 17 of the reinforced deck plate 15 and the substantially flat upper surface 37 (facing surface) of the wood-based plate 16a (the wood, plywood, wood-based siding, CLT, oriented strand board (OSB plywood), wood cement board, particle board, or MDF board) overlap (are in contact with) each other, and as illustrated in FIGS. 42 to 45, the metal base 17 and the wood-based plate 16a are connected and fixed by a plurality of fixing bolts 54 or fixing screws 54 (fixing means) arranged at equal intervals in the length direction, and are connected and fixed by the plurality of fixing bolts 54 or fixing screws 54 (fixing means) arranged at equal intervals in the width direction, and the lower surface 25 of the metal base 17 and the upper surfaces 37 of the wood-based plate 16 are fixed to each other by an adhesive (not illustrated) applied to the entire lower surface 25 or partially (intermittently) applied to the lower surface 25 of the metal base 17. The fixing bolts 54 or fixing screws 54 may be spaced apart from each other at different intervals in the length direction. In addition, the adhesive may be applied to the entire upper surface 37 of the wood-based plate 16 or partially (intermittently) applied to the upper surface 37 of the wood-based plate 16.

The fixing bolts 58 or fixing screws 58 are the same as those used for the composite deck plate 10J illustrated in FIGS. 30 to 33. A screw portion 59 of the fixing bolt 58 or fixing screw 58 is screwed into the wood-based plate 16. When the fixing bolts 58 or fixing screws 58 are screwed to the wood-based plate 16, the screw portions 60 of the fixing bolts 58 or fixing screws 58 connect the metal base 17 and the wood-based plate 16, and an adhesive applied to the entire screw portions 60 firmly adhere the fixing bolts 58 or fixing screws 58 and the wood-based plate 16. A screwing depth of the screw portion 60 of the fixing bolt 58 or fixing screw 58 from the upper surface 37 of the wood-based plate 16 into the wood-based plate 16 is at least 50% or more and less than 98% of a thickness dimension of the wood-based plate 16. The metal base 17 and the wood-based plate 16 may be connected and fixed by only the fixing bolts 58 or fixing screws 58 (without the adhesive).

In the composite deck plate 10M, the fixing bolts 58 or fixing screws 58 are screwed near the end edge 61 (first end) of the first end edge portion 35 of the wood-based plate 16, and are screwed near the end edge 62 (second end) of the second end edge portion 36 of the wood-based plate 16. In the composite deck plate 10M, the fixing bolts 58 or fixing screws 58 are screwed near the end edge 61 (first end) of the first end edge portion 35 or near the end edge 62 (second end) of the second end edge portion 36 of the wood-based plate 16, so that it is possible to prevent the metal base 17 from being turned up upward from the upper surface 37 of the wood-based plate 16 (separation between the upper surface 37 of the wood-based plate 16 and the lower surface 25 of the metal base 17) when the first and second extending portions 63 and 64 (first and second end edge portions 20 and 21) of the metal base 17 are gripped.

In the composite deck plate 10M, similarly to the arrangement of the staples 42 illustrated in FIG. 5, the number of fixing bolts 58 or fixing screws 58 (the number of screwed bolts or screws) screwed in the periphery of the center of a central portion 22 of the metal base 17 may be larger than the number of fixing bolts 58 or fixing screws 58 screwed in the periphery of the remaining portion of the central portion 22 excluding the center of the metal base 17. The number of fixing bolts 58 or fixing screws 58 screwed in the peripheries of (near) the end edges 61 and 62 of the first and second end edge portions 35 and 36 of the wood-based plate 16 may be larger than the number of fixing bolts 58 or fixing screws 58 screwed in the peripheries of (near) the remaining portions of the first and second end edge portions 35 and 36 of the wood-based plate 16 excluding the peripheries of (near) the end edges 61 and 62 of the first and second end edge portions 35 and 36.

The composite deck plate 10M has the following effects in addition to the effects of the composite deck plate 10J and the composite deck plate 10F. With the composite deck plate 10M, in a state where the lower surface 25 of the first extending portion 63 (first end edge portion 20) of the metal base 17 extending outward in the length direction from the end edge 61 (first end) of the first end edge portion 35 of the wood-based plate 16 is placed on one beam (a flange of an H beam), a first end edge portion 13 (first extending portion 63) of the composite deck plate 10M can be connected to the one beam (the flange of the H beam), and in a state where the lower surface 25 of the second extending portion 64 (second end edge portion 21) of the metal base 17 extending outward in the length direction from the end edge 62 (second end) of the second end edge portion 36 of the wood-based plate 16 is placed on the other beam (a flange of an H beam), a second end edge portion 14 (second extension portion 64) of the composite deck plate 10M can be connected to the other beam (the flange of the H beam), so that connection work for the first end edge portion 13 of the composite deck plate 10M and the one beam (the flange of the H beam) and connection work for the second end edge portion 14 of the composite deck plate 10M and the other beam (the flange of the H beam) can be easily performed.

In a case where the extension dimension L1 of the first extending portion 63 (first end edge portion 20) of the metal base extending outward in the length direction from the end edge 61 (first end) of the first end edge portion 35 of the wood-based plate 16 and the extension dimension L1 of the second extending portion 64 (second end edge portion 21) of the metal base extending outward in the length direction from the end edge 62 (second end) of the second end edge portion 36 of the wood-based plate 16 are as short as 5 to 10 mm, when concrete is cast on the upper surface 18 of the metal base 17, concrete slurry may intrude between the lower surface 25 of the metal base 17 and the upper surface 37 of the wood-based plate 16 from the first point 65 where the end edge 61 (first end) of the first end edge portion 35 of the wood-based plate 16 and the lower surface 25 of the first extending portion 63 (first end edge portion 20) of the metal base 17 are in contact with each other or from the second point 66 where the end edge 62 (second end) of the second end edge portion 36 of the wood-based plate 16 and the lower surface 25 of the second extending portion 64 (second end edge portion 21) of the metal base 17 are in contact with each other, as a result of which the metal base 17 may be corroded (rust) due to the concrete slurry.

However, in the composite deck plate 10M, the first point 65 where the end edge 61 (first end) of the first end edge portion 35 of the wood-based plate 16 and the lower surface 25 of the first extending portion 63 (first end edge portion 20) of the metal base 17 are in contact with each other is waterproofed by the waterproofing material 67, and the second point 66 where the end edge 62 (second end) of the second end edge portion 36 of the wood-based plate 16 and the lower surface 25 of the second extending portion 64 (second end edge portion 21) of the metal base 17 are in contact with each other is waterproofed by the waterproofing material 67. Therefore, when concrete is cast on the upper surface 18 of the metal base 17, it is possible to prevent concrete slurry from intruding between the lower surface 25 of the metal base 17 and the upper surface 37 of the wood-based plate 16 from the first point 65 where the end edge 61 (first end) of the first end edge portion 35 of the wood-based plate 16 and the lower surface 25 of the first extending portion 63 (first end edge portion 20) of the metal base 17 are in contact with each other and to prevent concrete slurry from intruding between the lower surface 25 of the metal base 17 and the upper surface 37 of the wood-based plate 16 from the second point 66 where the end edge 62 (second end) of the second end edge portion 36 of the wood-based plate 16 and the lower surface 25 of the second extending portion 64 (second end edge portion 21) of the metal base 17 are in contact with each other, so that it is possible to prevent corrosion (rust) of the metal base 17 due to the concrete slurry.

### REFERENCE SIGNS LIST

10A Composite deck plate
10B Composite deck plate
10C Composite deck plate
10D Composite deck plate
10E Composite deck plate
10F Composite deck plate
10G Composite deck plate
10H Composite deck plate
10I Composite deck plate
10J Composite deck plate
10K Composite deck plate
10L Composite deck plate
10M Composite deck plate
11 First side edge portion
12 Second side edge portion
13 First end edge portion
14 Second end edge portion
15 Reinforced deck plate
16 Wood-based plate
16a to 16d First to fifth wood-based plates
17 Metal base
18 Upper surface
19 Reinforcing bar truss unit (reinforcing structure)
19a to 19c First to third reinforcing bar truss units
20 First end edge portion
21 Second end edge portion
22 Central portion
23 First side edge portion
24 Second side edge portion
25 Lower surface
26 Upper end beam
27 Lower end beam
27a First lower end beam
27b Second lower end beam
28 Lattice beam
28a First lattice beam
28b Second lattice beam
29 Upper end protrusion
30 Lower end recess
31 Middle portion
32 Bent portion
33 First side edge portion
34 Second side edge portion
35 First end edge portion
36 Second end edge portion
37 Upper surface
38 Lower surface
39 First side area
Second side area
41 Center area
42 Staple
43 Shoulder portion
44 Leg portion
45a to 45d First to fourth upper joints
46a to 46d First to fourth lower joints
47a to 47c First to third reinforcing bar truss units
48 Connecting beam
49 Upper end portion
Lower end portion
51 Middle portion
52a to 52c First to third reinforcing bar truss units
53 Upper lateral beam
54 Lower lateral beam
55 Connecting member
56 Hook portion
57 Leg portion
58 Fixing bolt or fixing screw
59 Head portion
60 Screw portion
61 End edge (first end)
62 End edge (second end)
63 First extending portion
64 Second extending portion
65 First point
66 Second point
67 Waterproofing material
L1 Extension dimension

1. A composite deck plate having a predetermined area and having both side edge portions extending in a length direction and both end edge portions extending in a width direction intersecting the length direction, the composite deck plate comprising:
a reinforced deck plate; and at least one wood-based plate disposed under the reinforced deck plate and having a predetermined area, wherein the reinforced deck plate includes a metal base having a predetermined area and having a first end edge portion, a second end edge portion, and a central portion, the first end edge portion and the second end edge portion facing each other while being spaced apart from each other in the length direction and extending in the width direction, and the central portion being positioned between the first end edge portion and the second end edge portion, and at least one reinforcing structure disposed and fixed on and to an upper surface of the metal base and extending in the length direction between the first end edge portion and the second end edge portion of the metal base, and the wood-based plate is fixed to a lower surface of the metal base by predetermined fixing means.

2. The composite deck plate according to claim 1, wherein the wood-based plate is any one of first to n-th wood-based plates extending in the length direction parallel to the reinforcing structure and arranged in the width direction intersecting the reinforcing structure, and first to n-th wood-based plates extending in the width direction intersecting the reinforcing structure and arranged in the length direction parallel to the reinforcing structure, and the wood-based plates are fixed to the lower surface of the metal base by the predetermined fixing means.

3. The composite deck plate according to claim 1, wherein the metal base of the reinforced deck plate has a first side edge portion extending in the length direction and a second side edge portion positioned opposite to the first side edge portion and extending in the length direction, and the wood-based plate has a first side area extending outward in the width direction from the first side edge portion of the metal base and exposed outward in the width direction from the first side edge portion, a second side area positioned opposite to the first side area, extending outward in the width direction from the second side edge portion of the metal base, and exposed outward in the width direction from the second side edge portion, and a center area positioned between the first and second side areas and fixed to the lower surface of the metal base.

4. The composite deck plate according to claim 1, wherein the metal base of the reinforced deck plate has a first side edge portion extending in the length direction and a second side edge portion positioned opposite to the first side edge portion and extending in the length direction, and the wood-based plate has a first side area positioned on a lower surface of the first side edge portion of the metal base and fixed to the first side edge portion, a second side area positioned opposite to the first side area, positioned on a lower surface of the second side edge portion of the metal base, and fixed to the second side edge portion, and a center area positioned between the first and second side areas and fixed to the lower surface of the metal base.

5. The composite deck plate according to claim 1, wherein the wood-based plate is fixed to the lower surface of the metal base by a plurality of the fixing means intermittently arranged in the length direction of the metal base.

6. The composite deck plate according to claim 5, wherein the fixing means is a staple including a shoulder portion having a predetermined shoulder width and a pair of leg portions having a predetermined leg length, the staples are intermittently arranged at predetermined intervals in the length direction of the metal base in a state where the shoulder portions extend in the width direction, and the leg portions are applied into the wood-based plate while penetrating through the metal base.

7. The composite deck plate according to claim 5, wherein the fixing means is a staple including a shoulder portion having a predetermined shoulder width and a pair of leg portions having a predetermined leg length, the staples are intermittently arranged at predetermined intervals in the length direction of the metal base in a state where the shoulder portions extend in the length direction, and the leg portions are applied into the wood-based plate while penetrating through the metal base.

8. The composite deck plate according to claim 6, wherein the plurality of staples are intermittently arranged at predetermined intervals in the width direction of the metal base, and the leg portions are applied into the wood-based plate while penetrating through the metal base.

9. The composite deck plate according to claim 6, wherein the number of applied staples in a periphery of a center of the central portion of the metal base is larger than the number of applied staples in a remaining portion of the central portion excluding the periphery of the center of the metal base, a separation dimension between the staples in the length direction in the periphery of the center of the central portion of the metal base is smaller than a separation dimension between the staples in the length direction in the remaining portion of the central portion, and the staples are applied into the wood-based plate in a state of being densely arranged.

10. The composite deck plate according to claim 6, wherein the number of applied staples in peripheries of end edges of the first and second end edge portions of the metal base is larger than the number of applied staples in remaining portions of the first and second end edge portions excluding the peripheries of the end edges of the metal base, a separation dimension between the staples in the length direction in the peripheries of the end edges of the first and second end edge portions of the metal base is smaller than a separation dimension between the staples in the length direction in the remaining portions of the first and second end edge portions, and the staples are applied into the wood-based plate in a state of being densely arranged.

11. The composite deck plate according to claim 6, wherein an adhesive is applied to the staples.

12. The composite deck plate according to claim 5, wherein the fixing means is a plurality of fixing bolts or fixing screws each having a head portion and a screw portion having a predetermined length, the fixing bolts or fixing screws are intermittently arranged at predetermined intervals in the length direction of the metal base, and the screw portion is screwed into the wood-based plate while penetrating through the metal base.

13. The composite deck plate according to claim 12, wherein the plurality of fixing bolts or fixing screws are intermittently arranged at predetermined intervals in the width direction of the metal base, and the screw portion is screwed into the wood-based plate while penetrating through the metal base.

14. The composite deck plate according to claim 12, wherein the number of fixing bolts or fixing screws screwed in a periphery of a center of a central portion of the metal base is larger than the number of fixing bolts or fixing screws screwed in a remaining portion of the central portion excluding the periphery of the center of the metal base, a separation dimension between the fixing bolts or fixing screws in the length direction in the periphery of the center of the central portion of the metal base is smaller than a separation dimension between the fixing bolts or fixing screws in the length direction in the remaining portion of the central portion, and the fixing bolts or fixing screws are screwed into the wood-based plate in a state of being densely arranged.

15. The composite deck plate according to claim 12, wherein the number of fixing bolts or fixing screws screwed in peripheries of end edges of the first and second end edge portions of the metal base is larger than the number of fixing bolts or fixing screws screwed in remaining portions of the first and second end edge portions excluding the peripheries of the end edges of the metal base, a separation dimension between the fixing bolts or fixing screws in the length direction in the peripheries of the end edges of the first and second end edge portions of the metal base is smaller than a separation dimension between the fixing bolts or fixing screws in the length direction in the remaining portions of the first and second end edge portions, and the fixing bolts or fixing screws are screwed into the wood-based plate in a state of being densely arranged.

16. The composite deck plate according to claim 1, wherein the wood-based plate has a first end positioned at one end edge portion of the composite deck plate and a second end positioned at the other end edge portion of the composite deck plate, the first end edge portion of the metal base extends outward in the length direction from the first end of the wood-based plate by a predetermined dimension, and the second end edge portion of the metal base extends outward in the length direction from the second end of the wood-based plate by a predetermined dimension.

17. The composite deck plate according to claim 16, wherein a first point where the first end of the wood-based plate and a lower surface of the first end edge portion of the metal base are in contact with each other is waterproofed with a waterproofing material, and a second point where the second end of the wood-based plate and a lower surface of the second end edge portion of the metal base are in contact with each other is waterproofed with the waterproofing material.

18. The composite deck plate according to claim 1, wherein the metal base is an iron plate, and the wood-based plate is formed using any one of wood having a predetermined area, plywood having a predetermined area, a wood-based siding material having a predetermined area, a cross laminated timber (CLT) having a predetermined area, an oriented strand board (OSB plywood) having a predetermined area, a wood cement board having a predetermined area, a particle board having a predetermined area, and a medium density fiber (MDF) board having a predetermined area.
